(19) United States
(12) Patent Application Publication
(10) Pub. No.: US 2024/0280834 A1
(43) Pub. Date: Aug. 22, 2024

(54) WATER GRADIENT SILICONE HYDROGEL CONTACT LENSES

(71) Applicant: Alcon Inc., Fribourg (CH)

(72) Inventors: Feng Jing, Alpharetta, GA (US); Steve Yun Zhang, Sugar Hill, GA (US); Richard Charles Breitkopf, Dunwoody, GA (US); Claire Elizabeth Nason-Tomaszewski, Atlanta, GA (US); Shelby Claytor, Fleetwood, PA (US)

(21) Appl. No.: 18/429,551

(22) Filed: Feb. 1, 2024

Related U.S. Application Data
(60) Provisional application No. 63/482,907, filed on Feb. 2, 2023.

(51) Int. Cl. G02C 7/04; C08J 7/04

(52) U.S. Cl. CPC G02C 7/04; C08J 7/0427; C08J 2383/10; C08J 2433/14

(57) ABSTRACT

The invention provides an easy-to-remove water gradient contact lens. Such a water gradient contact lens comprises imperfections (ditches and/or gaps) in the anterior outer hydrogel layer and can be made according to a cost-effective method involving a step of partially or completely shielding reactive functional groups in selected zones on the anterior surface a to-be-coated contact lens before grafting a layer of a non-silicone hydrogel material. With the imperfections in the anterior outer hydrogel layer, the surface lubricity of the anterior surface is inferior to that of the posterior surface. By adjusting the shape, size, density, and rotational distribution of the imperfections, one also can selectively adjust and optimize the surface lubricity of the anterior surface of a water gradient contact lens so as to have improved lens handlability while maintaining other desirable properties.

This application claims the benefits under 35 USC § 119 (e) of U.S. provisional application No. 63/482,907, filed on 2 Feb. 2023, incorporated by reference in its entirety.

The present invention is related to an easy-to-remove water gradient silicone hydrogel contact lens and to a method for producing such a water gradient silicone hydrogel contact lens.

### BACKGROUND

A new class of soft contact lenses, water gradient silicone hydrogel contact lenses, e.g., DAILIES® TOTAL1® (Alcon), PRECISION1® (Alcon), and TOTAL30® (Alcon), have been developed and successfully introduced in the market. This new class of soft contact lenses is characterized by having a water-gradient structural configuration, an increase in water content from 33% to over 80% from core to surface (see, e.g., U.S. Pat. Nos. 8,480,227, 11,061,168, and 11256003). This unique design can deliver a highly-lubricious and extremely-soft, water-rich lens surface that in turn provide superior wearing comfort to patients.

The newly-developed water-gradient silicone hydrogel contact lenses can provide superior wearing comfort to patients due to their extremely-soft, water-rich, relatively-thick, and lubricious hydrogel coatings. However, one of the major challenges with water gradient contact lenses is lens removal. Because those contact lenses are highly lubricious, patients, especially new patients, may have a steep learning curve on removing lens from eye. Therefore, it would be desirable to have water gradient contact lenses having improved lens handlability (“easy to insert/remove”) while maintaining other desirable properties.

Therefore, there is still a need for easy-to-remove water gradient contact lenses.

### SUMMARY OF THE INVENTION

The present invention, in one aspect, provides a coated contact lens comprising: an anterior surface and an opposite posterior surface; and a layered structural configuration which comprises, in a direction from the anterior surface to the posterior surface, an anterior outer hydrogel layer, an inner layer, and a posterior outer hydrogel layer, wherein the inner layer is made of a lens bulk material, wherein the posterior outer hydrogel layer is a layer of a first non-silicone hydrogel material, wherein the anterior outer hydrogel layer is a layer of the first non-silicone hydrogel material with imperfections (e.g., ditches and/or gaps) distributed therein so that the posterior outer hydrogel layer has a surface lubricity higher than the surface lubricity of the anterior outer hydrogel layer, wherein the coated contact lens in fully-hydrated state has a water content of from about 10% to about 70% by weight or less, an oxygen permeability of at least about 50 barrers, and a water-break-up time of at least about 10 seconds as measured on the anterior and posterior surfaces of the coated contact lens.

The present invention, in another aspect, provide a method for producing coated contact lenses, comprising the steps of: (1) obtaining a preformed contact lens having a convex surface and an opposite concave surface, wherein the preformed contact lens is composed of a lens bulk material and comprises first reactive functional groups on and near the convex and concave surfaces of the preformed contact lens, wherein each of the first reactive functional groups is capable of reacting with a thermally-crosslinkable group at a temperature from about 60° C. to about 140° C. and are selected from the group consisting of carboxylic acid groups, primary amino groups, secondary amino groups, thiol groups, and combinations thereof; (2) covering multiple zones on the convex surface with a second non-silicone hydrogel material to prevent first reactive functional groups behind the multiple zones from reacting with thermally-crosslinkable groups, wherein the second non-silicone hydrogel material is free of any first reactive functional group and free of any thermally-crosslinkable group; (3) heating the preformed contact lens obtained in step (2) directly in an aqueous solution having a pH from about 6.5 to about 9.5 and including at least one water-soluble, thermally-crosslinkable hydrophilic polymeric material at a temperature from about 60° C. to about 140° C. to graft a first non-silicone hydrogel material onto each of the anterior and posterior surfaces of the preformed contact lens obtained in step (2) to form a coated contact lens that has an anterior surface, an opposite posterior surface, an anterior outer hydrogel layer, and a posterior outer hydrogel layer, wherein said at least one water-soluble, thermally-crosslinkable hydrophilic polymeric material comprises second reactive functional groups and third reactive functional groups, wherein the second reactive functional groups are thermally-crosslinkable groups selected from the group consisting of azetidinium groups, epoxy groups, and combinations thereof, wherein each of the second reactive functional group is capable of reacting with one first or third reactive functional group to form a crosslinkage, wherein the third reactive functional groups are selected from the group consisting of carboxylic acid groups, primary amino groups, secondary amino groups, thiol groups, and combinations thereof, wherein the second non-silicone hydrogel material is a crosslinked product of said at least one thermally-crosslinkable hydrophilic polymeric material, wherein the posterior outer hydrogel layer is a layer of the first non-silicone hydrogel material, wherein the anterior outer hydrogel layer is a layer of the first non-silicone hydrogel material with imperfections (e.g., ditches and/or gaps) distributed therein so that the posterior surface of the coated contact lens has a surface lubricity higher than the surface lubricity of the anterior surface, wherein the coated contact lens in fully-hydrated state has a water-break-up time of at least about 10 seconds as measured on the anterior and posterior surfaces of the coated contact lens.

The present invention, in a further aspect, provides a method for producing coated contact lenses, comprising the steps of: (1) obtaining a female mold half and a male mold half, wherein the female mold half has a first molding surface defining the anterior surface of a contact lens to be molded, wherein the male mold half has a second molding surface defining the posterior surface of the contact lens to be molded, wherein the male mold half and the female mold half are configured to receive each other such that a lens-molding cavity is formed between the first and second molding surfaces when the female mold half is closed with the male mold half; (2) applying a hydrogel-forming composition to multiple zones on the first molding surface, wherein the hydrogel-forming composition comprises at least one crosslinkable polymer having hydroxyl groups and/or ethylenically unsaturated groups and optionally at least one hydrophobic vinylic monomer selected from the group consisting of methoxyethyl (meth)acrylate, ethoxyethyl (meth)acrylate, methyl (meth)acrylate, and combination thereof, wherein if said at least one crosslinkable polymer is free of any ethylenical unsaturated group, the hydrogel-forming composition comprises additionally at least one hydroxyl-containing vinylic monomer and at least one compound having two or more isocyanato groups, wherein all polymerizable components in the hydrogel-forming composition are free of reactive functional groups selected from the group consisting of a carboxylic acid group, a primary amino group, a secondary amino group, an azetidinium group, an epoxy group, and combinations thereof; (3) optionally, curing partially the hydrogel-forming composition on the first molding surface; (4) introducing a polymerizable composition into the female mold half obtained in step (2) or (3), wherein the polymerizable composition comprises from about 1.0% to about 10% by weight of at least one reactive vinylic monomer having at least one first reactive functional group selected from the group consisting of a carboxylic acid group, a primary amino group, a secondary amino group, and combinations thereon, relative to the total amount of all polymerizable components; (5) closing the female mold half obtained in step (4) with the male mold half to form a molding assemble including the polymerizable composition within the lens-forming cavity; (6) curing thermally or actinically the polymerizable composition in the molding assembly to form a contact lens precursor having a convex surface and an opposite concave surface and comprising a lens bulk material having first reactive functional groups, wherein the convex surface of the contact lens precursor is partially covered with a second non-silicone hydrogel material formed from the hydrogel-forming composition in the multiple zones on the convex surface so as to prevent the first reactive functional groups behind the multiple zones from reacting with thermally-crosslinkable groups which are azetidinium groups and/or epoxy groups at a temperature from about 60° C. to about 140° C., wherein the second non-silicone hydrogel material is free of any first reactive functional groups and thermally-crosslinkable groups; (7) optionally hydrating the contact lens precursor obtained in step (6) in water or an aqueous solution to obtain a hydrated contact lens precursor; and (8) heating the contact lens precursor obtained in step (6) or the hydrated contact lens precursor obtained in step (7) directly in an aqueous solution having a pH from about 6.5 to about 9.5 and including at least one water-soluble, thermally-crosslinkable hydrophilic polymeric material at a temperature from about 60° C. to about 140° C. to graft a first non-silicone hydrogel material onto each of the convex and concave surfaces of the contact lens precursor obtained in step (6) or the hydrated contact lens precursor obtained in step (7) to form a coated contact lens that has an anterior surface, an opposite posterior surface, an anterior outer hydrogel layer, and a posterior outer hydrogel layer, wherein said at least one water-soluble, thermally-crosslinkable hydrophilic polymeric material comprises second reactive functional groups and third reactive functional groups, wherein the second reactive functional groups are thermally-crosslinkable groups selected from the group consisting of azetidinium groups, epoxy groups, and combinations thereof, wherein each of the second reactive functional group is capable of reacting with one first or third reactive functional group to form a crosslinkage, wherein the third reactive functional groups are selected from the group consisting of carboxylic acid groups, primary amino groups, secondary amino groups, thiol groups, and combinations thereof, wherein the posterior outer hydrogel layer is a layer of the first non-silicone hydrogel material, wherein the anterior outer hydrogel layer is a layer of the first non-silicone hydrogel material with imperfections (e.g., ditches and/or gaps) distributed therein so that the posterior surface of the coated contact lens has a surface lubricity higher than the surface lubricity of the anterior surface, wherein the coated contact lens has a water-break-up time of at least about 10 seconds as measured on the anterior and posterior surfaces of the coated contact lens.

### BRIEF DESCRIPTION OF DRAWINGS

FIG. 1 shows five printing patterns (A-E) which have been used to apply a hydrogel-forming composition onto the anterior surface of preformed silicone hydrogel contact lenses according to preferred embodiments of the invention.

### DETAILED DESCRIPTION OF EMBODIMENTS OF THE INVENTION

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well known and commonly employed in the art.

“About” as used herein in this application means that a number, which is referred to as “about”, comprises the recited number plus or minus 1-10% of that recited number.

“Contact Lens” refers to a structure that can be placed on or within a wearer's eye. A contact lens can correct, improve, or alter a user's eyesight, but that need not be the case. A contact lens can be of any appropriate material known in the art or later developed, and can be a hard lens, a rigid gas permeable lens, a soft lens, or a hybrid lens.

A The term “anterior surface”, “front surface”, “front curve surface” or “FC surface” in reference to a contact lens, as used in this application, interchangeably means a surface of the contact lens that faces away from the eye during wear. The anterior surface (FC surface) is typically substantially convex.

The “posterior surface”, “back surface”, “base curve surface” or “BC surface” in reference to a contact lens, as used in this application, interchangeably means a surface of the contact lens that faces towards the eye during wear. The posterior surface (BC surface) is typically substantially concave.

A “central axis” in reference to a contact lens, as used in this application, means an imaginary reference line passing through the geometrical centers of the anterior and posterior surfaces of a contact lens.

A “central axis” in reference to a mold half, as used in this application, means an imaginary reference line passing normally (i.e., normal to the molding surface at the geometrical center) through the geometrical centers of the molding surface of the mold half.

A “hard contact lens” refers a contact lens comprising a hard plastics (e.g., polymethylmethacrylate) as lens bulk (or so-called “core”) material.

A “rigid gas permeable contact lens” refers to a contact lens comprising a gas permeable material (e.g., a material made from fluorosilicone acrylates) as lens bulk material.

A hybrid contact lens comprises a lens bulk material consisting essentially of a central optical zone that is made of a gas permeable lens material and a peripheral zone that is made of silicone hydrogel or regular hydrogel lens material and extends outwardly from and surrounds the central optical zone.

An embedded contact lens comprises a lens bulk material consisting essentially of a 3-dimensional embedded article and a non-silicone hydrogel material or a silicone hydrogel material, wherein the 3-dimensional embedded article has a 3-dimensional size smaller than that of the contact lens so that it is partially or preferably completely embedded within a non-silicone hydrogel material or a silicone hydrogel material.

A “hydrogel contact lens” refers to a contact lens comprising a hydrogel bulk (core) material. A hydrogel bulk material can be a non-silicone hydrogel material or preferably a silicone hydrogel material.

A “hydrogel” or “hydrogel material” refers to a crosslinked polymeric material which has three-dimensional polymer networks (i.e., polymer matrix), is insoluble in water, but can hold at least 10% by weight of water in its polymer matrix when it is fully hydrated (or equilibrated).

A “silicone hydrogel” or “SiHy” refers to a silicone-containing hydrogel obtained by copolymerization of a polymerizable composition comprising at least one silicone-containing vinylic monomer or at least one silicone-containing vinylic macromer or at least one crosslinkable silicone-containing prepolymer having ethylenically unsaturated groups.

A siloxane, which often also described as a silicone, refers to a molecule having at least one moiety of —Si—O—Si— where each Si atom carries two organic groups as substituents.

As used in this application, the term “non-silicone hydrogel” or “non-silicone hydrogel material” interchangeably refers to a hydrogel that is theoretically free of silicon.

“Hydrophilic,” as used herein, describes a material or portion thereof that will more readily associate with water than with lipids.

The term “room temperature” refers to a temperature of about 17° C. to about 26° C.

The term “soluble”, in reference to a compound or material in a solvent, means that the compound or material can be dissolved in the solvent to give a solution with a concentration of at least about 0.5% by weight at room temperature (i.e., from about 17° C. to about 26° C.).

The term “insoluble”, in reference to a compound or material in a solvent, means that the compound or material can be dissolved in the solvent to give a solution with a concentration of less than 0.01% by weight at room temperature (as defined above).

A “vinylic monomer” refers to a compound that has one sole ethylenically unsaturated group, is soluble in a solvent, and can be polymerized actinically or thermally.

The term “olefinically unsaturated group” or “ethylenically unsaturated group” is employed herein in a broad sense and is intended to encompass any groups containing at least one >C═CH₂ group. Exemplary ethylenically unsaturated groups include without limitation (meth)acryloyl

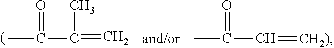

allyl, vinyl, styrenyl, or other C═CH₂ containing groups.

An “acrylic monomer” refers to a vinylic monomer having one sole (meth)acryloyl group. Examples of acrylic monomers includes (meth)acryloxy [or (meth)acryloyloxy]monomers and (meth)acrylamido monomers.

An “(meth)acryloxy monomer” or “(meth)acryloyloxy monomer” refers to a vinylic monomer having one sole group of

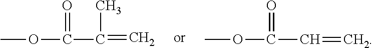

An “(meth)acrylamido monomer” refers to a vinylic monomer having one sole group of

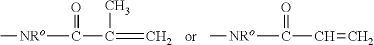

in which R^{o} is H or C₁-C₄ alkyl.

The term “(meth)acrylamide” refers to methacrylamide and/or acrylamide.

The term “(meth)acrylate” refers to methacrylate and/or acrylate.

An “N-vinyl amide monomer” refers to an amide compound having a vinyl group (—CH═CH₂) that is directly attached to the nitrogen atom of the amide group.

An “ene monomer” refers to a vinylic monomer having one sole ene group.

A “hydrophilic vinylic monomer”, a “hydrophilic acrylic monomer”, a “hydrophilic (meth)acryloxy monomer”, or a “hydrophilic (meth)acrylamido monomer”, as used herein, respectively refers to a vinylic monomer, an acrylic monomer, a (meth)acryloxy monomer, or a (meth)acrylamido monomer), which typically yields a homopolymer that is water-soluble or can absorb at least 10 percent by weight of water.

A “hydrophobic vinylic monomer”, a “hydrophobic acrylic monomer”, a “hydrophobic (meth)acryloxy monomer”, or a “hydrophobic (meth)acrylamido monomer”, as used herein, respectively refers to a vinylic monomer, an acrylic monomer, a (meth)acryloxy monomer, or a (meth)acrylamido monomer), which typically yields a homopolymer that is insoluble in water and can absorb less than 10% by weight of water.

A “blending vinylic monomer” refers to a vinylic monomer capable of dissolving both hydrophilic and hydrophobic polymerizable components of a polymerizable composition to form a solution.

As used in this application, the term “vinylic crosslinker” refers to an organic compound having at least two ethylenically unsaturated groups. A “vinylic crosslinking agent” refers to a vinylic crosslinker having a molecular weight of 700 Daltons or less.

An “acrylic crosslinker” refers to a vinylic crosslinker having at least two (meth)acryloyl groups.

The term “acrylic repeating units” refers to repeating units of a polymeric material, each of which is derived from an acrylic monomer or crosslinker in a free-radical polymerization to form the polymeric material.

The term “terminal (meth)acryloyl group” refers to one (meth)acryloyl group at one of the two ends of the main chain (or backbone) of an organic compound.

As used herein, “actinically” in reference to curing, crosslinking or polymerizing of a polymerizable composition, a prepolymer or a material means that the curing (e.g., crosslinked and/or polymerized) is performed by actinic irradiation, such as, for example, UV/visible irradiation, ionizing radiation (e.g. gamma ray or X-ray irradiation), microwave irradiation, and the like. Thermal curing or actinic curing methods are well-known to a person skilled in the art.

As used in this application, the term “polymer” means a material formed by polymerizing/crosslinking monomers, macromers, prepolymers, or combinations thereof.

A “macromer” or “prepolymer” refers to a compound or polymer that contains ethylenically unsaturated groups and has a number average molecular weight of greater than 700 Daltons.

As used in this application, the term “molecular weight” of a polymeric material (including monomeric or macromeric materials) refers to the number-average molecular weight unless otherwise specifically noted or unless testing conditions indicate otherwise. A skilled person knows how to determine the molecular weight of a polymer according to known methods, e.g., GPC (gel permeation chromatochraphy) with one or more of a refractive index detector, a low-angle laser light scattering detector, a multi-angle laser light scattering detector, a differential viscometry detector, a UV detector, and an infrared (IR) detector; MALDI-TOF MS (matrix-assisted desorption/ionization time-of-flight mass spectroscopy); 1H NMR (Proton nuclear magnetic resonance) spectroscopy, etc.

A “polysiloxane segment” or “polydiorganosiloxane segment” interchangeably refers to a polymer chain segment (i.e., a divalent radical) of

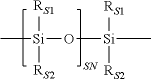

in which SN is an integer of 3 or larger and each of R_{S1} and R_{S2} independent of one another are selected from the group consisting of: C₁-C₁₀ alkyl; phenyl; C₁-C₄-alkyl-substituted phenyl; C₁-C₄-alkoxy-substituted phenyl; phenyl-C₁-C₆-alkyl; C₁-C₁₀ fluoroalkyl; C₁-C₁₀ fluoroether; aryl; aryl C₁-C₁₈ alkyl; -alk-(OC₂H₄)_{γ1}—OR^{o} (in which alk is C₁-C₆ alkylene diradical, R^{o} is H or C₁-C₄ alkyl and γ1 is an integer from 1 to 10); a C₂-C₄₀ organic radical having at least one functional group selected from the group consisting of hydroxyl group (—OH), carboxyl group (i.e., carboxylic acid group) (—COOH), amino group (—NR_{N1}R_{N1}′), amino linkages of —NR_{N1}—, amide linkages of —CONR_{N1}—, amide of —CONR_{N1}R_{N1}′, urethane linkages of —OCONH—, and C₁-C₄ alkoxy group, or a linear hydrophilic polymer chain, in which R_{N1} and R_{N1}′ independent of each other are hydrogen or a C₁-C₁₅ alkyl.

A “polysiloxane vinylic monomer” refers to a compound comprising at least one polysiloxane segment and one sole ethylenically-unsaturated group.

A “polydiorganosiloxane vinylic crosslinker” or “polysiloxane vinylic crosslinker” interchangeably refers to a compound comprising at least one polysiloxane segment and at least two ethylenically-unsaturated groups.

A “linear polydiorganosiloxane vinylic crosslinker” or “linear polysiloxane vinylic crosslinker” interchangeably refers to a compound comprising a main chain which includes at least one polysiloxane segment and is terminated with one ethylenically-unsaturated group at each of the two ends of the main chain.

A “chain-extended polydiorganosiloxane vinylic crosslinker” or “chain-extended polysiloxane vinylic crosslinker” interchangeably refers to a compound comprising at least two ethylenically-unsaturated groups and at least two polysiloxane segments each pair of which are linked by one divalent radical.

The term “fluid” as used herein indicates that a material is capable of flowing like a liquid.

As used in this application, the term “optically clear” in reference to a polymerizable composition means that the polymerizable composition is a transparent solution or liquid mixture (i.e., having a light transmissibility of 85% or greater, preferably 90% or greater in the range between 400 to 700 nm).

The term “monovalent radical” refers to an organic radical that is obtained by removing a hydrogen atom from an organic compound and that forms one bond with one other group in an organic compound. Examples include without limitation, alkyl (by removal of a hydrogen atom from an alkane), alkoxy (or alkoxyl) (by removal of one hydrogen atom from the hydroxyl group of an alkyl alcohol), thiyl (by removal of one hydrogen atom from the thiol group of an alkylthiol), cycloalkyl (by removal of a hydrogen atom from a cycloalkane), cycloheteroalkyl (by removal of a hydrogen atom from a cycloheteroalkane), aryl (by removal of a hydrogen atom from an aromatic ring of the aromatic hydrocarbon), heteroaryl (by removal of a hydrogen atom from any ring atom), amino (by removal of one hydrogen atom from an amine), etc.

The term “divalent radical” refers to an organic radical that is obtained by removing two hydrogen atoms from an organic compound and that forms two bonds with other two groups in an organic compound. For example, an alkylene divalent radical (i.e., alkylenyl) is obtained by removal of two hydrogen atoms from an alkane, a cycloalkylene divalent radical (i.e., cycloalkylenyl) is obtained by removal of two hydrogen atoms from the cyclic ring.

In this application, the term “substituted” in reference to an alkyl or an alkylenyl means that the alkyl or the alkylenyl comprises at least one substituent which replaces one hydrogen atom of the alkyl or the alkylenyl and is selected from the group consisting of hydroxyl (—OH), carboxyl (—COOH), —NH₂, sulfhydryl (—SH), C₁-C₄ alkyl, C₁-C₄ alkoxy, C₁-C₄ alkylthio(alkyl sulfide), C₁-C₄ acylamino, C₁-C₄ alkylamino, di-C₁-C₄ alkylamino, and combinations thereof.

In this application, an “oxazoline” refers to a compound of

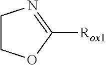

in which: Rₒₓ₁ is hydrogen, methyl, ethyl, N-pyrrolidonylmethyl, N-pyrrolidonylethyl, N-pyrrolidonylpropyl, or a monovalent radical of -alk-(OC₂H₄)ₘ₃—OR″ in which alk is C₁-C₆ alkyl diradical; R″ is C₁-C₄ alkyl (preferably methyl); and m3 is an integer from 1 to 10 (preferably 1 to 5).

In this application, the term “polyoxazoline” refers to a polymer or polymer segment of

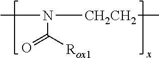

in which: Rₒₓ₁ is hydrogen, methyl, ethyl, N-pyrrolidonylmethyl, N-pyrrolidonylethyl, N-pyrrolidonylpropyl, or a monovalent radical of -alk-(OC₂H₄)ₘ₃—OR″ in which alk is C₁-C₆ alkyl diradical; R″ is C₁-C₄ alkyl (preferably methyl); m3 is an integer from 1 to 10 (preferably 1 to 5); x is an integer from 5 to 500.

In this application, the term “poly(2-oxazoline-co-ethyleneimine)” refers to a statistical copolymer or a polymer segment thereof having a formula of

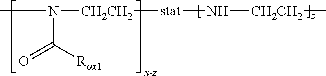

in which: Rₒₓ₁ is hydrogen, methyl, ethyl, N-pyrrolidonylmethyl, N-pyrrolidonylethyl, N-pyrrolidonylpropyl, or a monovalent radical of -alk-(OC₂H₄)ₘ₃—OR″ in which alk is C₁-C₆ alkyl diradical; R″ is C₁-C₄ alkyl (preferably methyl); m3 is an integer from 1 to 10 (preferably 1 to 5); x is an integer from 5 to 500; z is an integer equal to or less than x. A poly(2-oxazoline-co-ethyleneimine) is obtained by hydrolyzing a polyoxazoline.

In this application, the term “poly(2-oxazoline-co-ethyleneimine)-epichlorohydrin” refers to a polymer obtained by reacting a poly(2-oxazoline-co-ethyleneimine) with epichlorohydrin to convert all or substantial percentage (≥90%) of the secondary amine groups of the poly(2-oxazoline-co-ethyleneimine) into azetidinium groups. Examples of poly(2-oxazoline-co-ethyleneimine)-epichlorohydrin are disclosed in U.S. pat. Appl. Pub. No. 2016/0061995A1.

An “epichlorohydrin-functionalized polyamine” or “epichlorohydrin-functionalized polyamidoamine” refers to a polymer obtained by reacting a polyamine or polyamidoamine with epichlorohydrin to convert all or a substantial percentage of the secondary amine groups of the polyamine or polyamidoamine into azetidinium groups.

The term “polyamidoamine-epichlorohydrin” refers to an epichlorohydrin-functionalized adipic acid-diethylenetriamine copolymer.

In this application the term “azetidinium” or “3-hydroxyazetidinium” refers to a positively-charged (i.e., cationic), divalent radical (or group or moiety) of

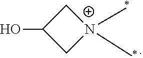 [SMILES: *[N+]1(*)CC(O)C1]

The term “thermally-crosslinkable” in reference to a polymeric material or a functional group means that the polymeric material or the functional group can undergo a crosslinking (or coupling) reaction with another material or functional group at a relatively-elevated temperature (from 40° C. to 140° C.), whereas the polymeric material or functional group cannot undergo the same crosslinking reaction (or coupling reaction) with another material or functional group at a temperature of from about 5° C. to about 20° C., to an extend detectable for about one hour.

The term “azlactone” refers to a mono-valent radical of formula

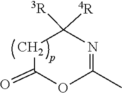

in which p is 0 or 1; ³R and ⁴R independently of each other is C₁-C₈ alkyl (preferably methyl).

The term “aziridine group” refers to a mono-valent radical of formula

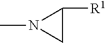

in which R¹ is hydrogen, methyl or ethyl.

As used in this application, the term “phosphorylcholine” refers to a zwitterionic group of

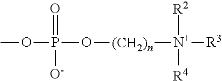

in which n is an integer of 1 to 5 and R², R³ and R⁴ independently of each other are C₁-C₈ alkyl or C₁-C₈ hydroxyalkyl.

As used in this application, the term “reactive vinylic monomer” refers to any vinylic monomer having at least one reactive functional group selected from the group consisting of carboxyl group, primary amino group, and secondary amino group.

As used in this application, the term “non-reactive vinylic monomer” refers to any vinylic monomer (either hydrophilic or hydrophobic vinylic monomer) free of carboxyl group, primary amino group, secondary amino group, epoxide group, isocyanate group, azlactone group, or aziridine group.

A free radical initiator can be either a photoinitiator or a thermal initiator. A “photoinitiator” refers to a chemical that initiates free radical crosslinking/polymerizing reaction by the use of light. A “thermal initiator” refers to a chemical that initiates free radical crosslinking/polymerizing reaction by the use of heat energy.

The intrinsic “oxygen permeability”, Dkᵢ, of a material is the rate at which oxygen will pass through a material. As used in this application, the term “oxygen permeability (Dk)” in reference to a hydrogel (silicone or non-silicone) or a contact lens means a corrected oxygen permeability (Dk_{c}) which is measured at about 34-35° C. and corrected for the surface resistance to oxygen flux caused by the boundary layer effect according to the procedures described in ISO 18369-4. Oxygen permeability is conventionally expressed in units of barrers, where “barrer” is defined as [(cm³ oxygen)(cm)/(cm²)(sec)(mm Hg)]×10^{-9.}

The “oxygen transmissibility”, Dk/t, of an insert or material is the rate at which oxygen will pass through a specific insert or material with an average thickness of t [in units of mm] over the area being measured. Oxygen transmissibility is conventionally expressed in units of barrers/mm, where “barrers/mm” is defined as [(cm³ oxygen)/(cm²)(sec)(mm Hg)]×10^{-9.}

The term “modulus” or “elastic modulus” in reference to a contact lens or a material means the tensile modulus or Young's modulus which is a measure of the stiffness of a contact lens or a material in tension. A person skilled in the art knows well how to determine the elastic modulus of a SiHy material or a contact lens. For example, all commercial contact lenses have reported values of elastic modulus.

A “coating” in reference to a contact lens means that the contact lens has, on its surfaces, a thin layer of a material that is different from the bulk material of the contact lens and obtained by subjecting the contact lens to a surface treatment.

An “average water contact angle” refers to a water contact angle (measured by Sessile Drop), which is obtained by averaging measurements of at least 3 individual contact lenses or samples of a silicone hydrogel material.

As used in this application, the term “water gradient” in reference to a contact lens means that there is an increase in water content observed in passing from the core to the surface of the contact lens, reaching the highest water content in the region near and including the surface of the contact lens. It is understood that the increase in water content from the core to the surface of the contact lens can be continuous and/or step-wise, so long as the water content is highest in the region near and including the surface of the contact lens.

As used in this application, the term “inner layer” or “lens bulk material” in reference to a contact lens of the invention interchangeably means a layer that has a 3-dimensional shape of a contact lens and includes a central curved plane (which divides the contact lens into two parts, one containing the convex surface and the other containing the concave surface) and has a variable thickness.

As used in this application, the term “outer surface hydrogel layer” in reference to a contact lens means an outmost hydrogel layer on the surface of the contact lens, which consists of an anterior outer hydrogel layer and a posterior outer hydrogel layer and which fully or partially covers the inner layer (or lens bulk material).

As used in this application, the term “anterior outer hydrogel layer” in reference to a contact lens means a hydrogel layer that includes the anterior surface of the contact lens, is made of one or more non-silicone hydrogel materials, and fully or partially covers the concave surface of an inner layer (or a lens bulk material).

As used in this application, the term “posterior outer hydrogel layer” in reference to a contact lens means a hydrogel layer that includes the posterior surface of the contact lens, is made of one or more non-silicone hydrogel materials, and fully or partially covers on the concave surface of an inner layer (or a lens bulk material).

As used in this application, the term “crosslinked coating” or “hydrogel coating” or “hydrogel layer” on a contact lens interchangeably is used to describe a crosslinked polymeric material having a three-dimensional network that can contain water when fully hydrated. The three-dimensional network of a crosslinked polymeric material can be formed by crosslinking of two or more linear or branched polymers through crosslinkages.

“Surface modification” or “surface treatment”, as used herein, means that an article has been treated in a surface treatment process (or a surface modification process) prior to or posterior to the formation of the article, in which (1) a coating is applied to the surface of the article, (2) chemical species are adsorbed onto the surface of the article, (3) the chemical nature (e.g., electrostatic charge) of chemical groups on the surface of the article are altered, or (4) the surface properties of the article are otherwise modified. Exemplary surface treatment processes include, but are not limited to, a surface treatment by energy (e.g., a plasma, a static electrical charge, irradiation, or other energy source), chemical treatments, the grafting of hydrophilic vinylic monomers or macromers onto the surface of an article, mold-transfer coating process disclosed in U.S. Pat. No. 6,719,929, the incorporation of wetting agents into a lens formulation for making contact lenses proposed in U.S. Pat. Nos. 6,367,929 and 6,822,016, reinforced mold-transfer coating disclosed in U.S. Pat. No. 7,858,000, and a hydrophilic coating composed of covalent attachment or physical deposition of one or more layers of one or more hydrophilic polymer onto the surface of a contact lens disclosed in U.S. Pat. Nos. 8,147,897 and 8,409,599 and US Patent Application Publication Nos. 2011/0134387, 2012/0026457 and 2013/0118127.

“Post-curing surface treatment”, in reference to a lens bulk material or a contact lens, means a surface treatment process that is performed after the lens bulk material or the contact lens is formed by curing (i.e., thermally or actinically polymerizing) a lens formulation. A “lens formulation” refers to a polymerizable composition that comprises all necessary polymerizable components for producing a contact lens or a lens bulk material as well known to a person skilled in the art.

The invention is generally related to a water gradient contact lens having improved lens handlability (“easy to insert/remove”) while maintaining other desirable properties offered by a water gradient contact lens. The invention is partly based on the discovery that the surface lubricity of the anterior surface of a water gradient contact lens can be controllably reduced by introducing imperfections (e.g., ditches and/or gaps) in the anterior outer hydrogel layer of a water gradient contact lens according to a cost-effective method of the invention. Typically, the production of water gradient contact lenses involves a step of grafting (covalently attaching) a non-silicone hydrogel onto a to-be-coated contact lens. Such a step of grafting requires the presence of reactive functional groups (e.g., carboxylic acid groups, primary/secondary amino groups, and thiol groups) on the surfaces of the to-be-coated contact lens as anchoring sites for grafting. It is discovered that reactive functional groups can be shielded either completely or substantially in zones on the anterior surface of a to-be-coated contact lens by applying a non-silicone hydrogel material free of reactive functional groups onto those zones. A resultant to-be-coated would have an uneven distribution of reactive functional groups on the anterior surface of a to-be-coated contact lens: no or minimal presence of reactive functional groups in those zones while sufficient presence of reactive functional groups in the remaining areas of the anterior surface. Consequently, no or minimal grafting of a non-silicone hydrogel material onto those zones on the anterior surface could occurs while grafting of the non-silicone hydrogel material onto the remaining zones occurs, creating, in situ, imperfections (e.g., ditches and/or gaps) in the anterior outer hydrogel layer of a resultant water gradient contact lens. With such imperfections (e.g., ditches and/or gaps) in the anterior outer hydrogel layer, the surface lubricity of the anterior surface of a water gradient contact lens can be reduced. By adjusting the shape, size, density, and rotational distribution of the imperfections on the anterior outer hydrogel layer, one also can adjust and optimize the surface lubricity of the anterior surface of a water gradient contact lens.

The present invention, in one aspect, provides a method for producing coated silicone hydrogel contact lenses, comprising the steps of: (1) obtaining a preformed contact lens having a convex surface and an opposite concave surface and comprising a lens bulk material, wherein the preformed contact lens is composed of a lens bulk material and comprises first reactive functional groups on and near the convex and concave surfaces of the preformed contact lens, wherein each of the first reactive functional groups is capable of reacting with a thermally-crosslinkable group at a temperature from about 60° C. to about 140° C. and are selected from the group consisting of carboxylic acid groups, primary amino groups, secondary amino groups, thiol groups, and combinations thereof; (2) covering multiple zones on the convex surface with a second non-silicone hydrogel material to prevent first reactive functional groups behind the multiple zones from reacting with thermally-crosslinkable groups, wherein the second non-silicone hydrogel material is free of any first reactive functional group and free of any thermally-crosslinkable group; and (3) heating the preformed contact lens obtained in step (2) directly in an aqueous solution having a pH from about 6.5 to about 9.5 and including at least one water-soluble, thermally-crosslinkable hydrophilic polymeric material at a temperature from about 60° C. to about 140° C. to graft a first non-silicone hydrogel material onto each of the anterior and posterior surfaces of the preformed contact lens obtained in step (2) to form a coated contact lens that has an anterior surface, an opposite posterior surface, an anterior outer hydrogel layer, and a posterior outer hydrogel layer, wherein said at least one water-soluble, thermally-crosslinkable hydrophilic polymeric material comprises second reactive functional groups and third reactive functional groups, wherein the second reactive functional groups are thermally-crosslinkable groups selected from the group consisting of azetidinium groups, epoxy groups, and combinations thereof, wherein each of the second reactive functional group is capable of reacting with one first or third reactive functional group to form a crosslinkage, wherein the third reactive functional groups are selected from the group consisting of carboxylic acid groups, primary amino groups, secondary amino groups, thiol groups, and combinations thereof, wherein the second non-silicone hydrogel material is a crosslinked product of said at least one thermally-crosslinkable hydrophilic polymeric material, wherein the posterior outer hydrogel layer is a layer of the first non-silicone hydrogel material, wherein the anterior outer hydrogel layer is a layer of the first non-silicone hydrogel material with imperfections (e.g., ditches and/or gaps) distributed therein so that the posterior surface of the coated contact lens has a surface lubricity higher than the surface lubricity of the anterior surface, wherein the coated contact lens has a water-break-up time of at least about 10 seconds as measured on the anterior and posterior surfaces of the coated contact lens.

A preformed contact lens can be any contact lens which has not been subjected to any surface treatment after being produced according to any lens manufacturing processes, any contact lens which has been plasma treated or treated with any chemical or physical surface modification, or any commercial contact lens, so long as it does not have a hydrogel coating on the surface of the preformed contact lens. A person skilled in the art knows very well how to make preformed contact lenses. A person skilled in the art knows very well how to make preformed contact lenses. For example, preformed contact lenses can be produced in a conventional “spin-casting mold,” as described for example in U.S. Pat. No. 3,408,429, or by the full cast-molding process in a static form, as described in U.S. Pat. Nos. 4,347,198; 5,508,317; 5,583,463; 5,789,464; and 5,849,810, or by lathe cutting of polymeric material buttons as used in making customized contact lenses. In cast-molding, a polymerizable composition (i.e., a lens formulation) typically is dispensed into molds and cured (i.e., polymerized and/or crosslinked) in molds for making contact lenses.

Lens molds for making contact lenses are well known to a person skilled in the art and, for example, are employed in cast molding or spin casting. For example, a mold (for cast molding) generally comprises at least two mold sections (or portions) or mold halves, i.e., first and second mold halves. The first mold half defines a first molding (or optical) surface, and the second mold half defines a second molding (or optical) surface. The first and second mold halves are configured to receive each other such that a lens forming cavity is formed between the first molding surface and the second molding surface. The molding surface of a mold half is the cavity-forming surface of the mold and in direct contact with the polymerizable composition.

Methods of manufacturing mold sections for cast-molding a contact lens are generally well known to those of ordinary skill in the art. The process of the present invention is not limited to any particular method of forming a mold. In fact, any method of forming a mold can be used in the present invention. The first and second mold halves can be formed through various techniques, such as injection molding or lathing. Examples of suitable processes for forming the mold halves are disclosed in U.S. Pat. Nos. 4,444,711; 4,460,534; 5,843,346; and 5,894,002.

Virtually all materials known in the art for making molds can be used to make molds for making contact lenses. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used. Other materials that allow UV light transmission could be used, such as quartz glass and sapphire.

In accordance with the invention, the polymerizable composition can be introduced (dispensed) into a cavity formed by a mold according to any known methods.

After the polymerizable composition is dispensed into the mold, it is polymerized to produce a contact lens. Crosslinking may be initiated thermally or actinically, preferably by exposing the polymerizable composition in the mold to a spatial limitation of actinic radiation to crosslink the polymerizable components in the polymerizable composition.

Opening of the mold so that the molded article can be removed from the mold may take place in a manner known per se.

The molded contact lens can be subject to lens extraction to remove unpolymerized polymerizable components. The extraction solvent can be any solvent known to a person skilled in the art. Examples of suitable extraction solvent are those described below.

In a preferred embodiment, a preformed contact lens is a hard contact lens comprising a hard plastic material as lens bulk material. Preferably, the hard plastic material is a crosslinked polymethylacrylate. A person skilled in the art knows well how to make a hard plastic material, including a crosslinked polymethylmethacrylate.

In another preferred embodiment, a preformed contact lens is a rigid gas permeable contact lens comprising a rigid gas permeable material as lens bulk material. A person skilled in the art knows how to make a rigid gas permeable contact lens.

In another preferred embodiment, a preformed contact lens is a hybrid contact lens comprises a lens bulk material consisting essentially of a central optical zone that is made of a gas permeable lens material and a peripheral zone that is made of silicone hydrogel or regular hydrogel lens material and extends outwardly from and surrounds the central optical zone.

In another preferred embodiment, a preformed contact lens is a non-silicone hydrogel contact lens (or so-called a conventional hydrogel contact lens) comprising a non-silicone hydrogel material as lens bulk material.

Preformed non-silicone hydrogel contact lenses can be any commercially-available non-silicone hydrogel contact lenses or can be produced according to any known methods. For example, for production of preformed non-silicone hydrogel contact lenses, a non-silicone hydrogel lens formulation (polymerizable composition) for cast-molding or spin-cast molding or for making rods used in lathe-cutting of contact lenses typically is: either (1) a monomer mixture comprising (a) at least one hydrophilic vinylic monomer (e.g., hydroxyethyl methacrylate, glycerol methacrylate, N-vinylpyrrolidone, or combinations thereof) and (b) at least one component selected from the group consisting of a crosslinking agent, a hydrophobic vinylic monomer, a lubricating agent (or so-called internal wetting agents incorporated in a lens formulation), a free-radical initiator (photoinitiator or thermal initiator), a UV-absorbing vinylic monomer, a high-energy-violet-light (“HEVL”) absorbing vinylic monomer, a visibility tinting agent (e.g., reactive dyes, polymerizable dyes, pigments, or mixtures thereof), antimicrobial agents (e.g., preferably silver nanoparticles), a bioactive agent, and combinations thereof; or (2) an aqueous solution comprising one or more water-soluble prepolymers and at least one component selected from the group consisting of hydrophilic vinylic monomer, a crosslinking agent, a hydrophobic vinylic monomer, a lubricating agent (or so-called internal wetting agents incorporated in a lens formulation), a free-radical initiator (photoinitiator or thermal initiator), a UV-absorbing vinylic monomer, a HEVL absorbing vinylic monomer, a visibility tinting agent (e.g., reactive dyes, polymerizable dyes, pigments, or mixtures thereof), antimicrobial agents (e.g., preferably silver nanoparticles), a bioactive agent, and combinations thereof. Resultant preformed hydrogel contact lenses then can be subjected to extraction with an extraction solvent to remove unpolymerized components from the resultant lenses and to hydration process, as known by a person skilled in the art. It is understood that a lubricating agent present in a hydrogel lens formulation can improve the lubricity of preformed hydrogel contact lenses compared to the lubricity of control preformed hydrogel contact lenses obtained from a control hydrogel lens formulation without the lubricating agent.

Preferred examples of water-soluble prepolymers include without limitation: a water-soluble crosslinkable poly(vinyl alcohol) prepolymer described in U.S. Pat. Nos. 5,583,163 and 6,303,687.

Numerous non-silicone hydrogel lens formulations have been described in numerous patents and patent applications published by the filing date of this application and have been used in producing commercial non-silicone hydrogel contact lenses. Examples of commercial non-silicone hydrogel contact lenses include, without limitation, alfafilcon A, acofilcon A, deltafilcon A, etafilcon A, focofilcon A, helfilcon A, helfilcon B, hilafilcon B, hioxifilcon A, hioxifilcon B, hioxifilcon D, methafilcon A, methafilcon B, nelfilcon A, nesofilcon A, ocufilcon A, ocufilcon B, ocufilcon C, ocufilcon D, omafilcon A, phemfilcon A, polymacon, samfilcon A, telfilcon A, tetrafilcon A, and vifilcon A.

In a preferred embodiment, the lens bulk material is composed of a non-silicone hydrogel material which comprises at least 50% by mole of repeating units of at least one hydroxyl-containing vinylic monomer, preferably selected from the group consisting of hydroxyethyl (meth)acrylate, glycerol(meth)acrylate, 3-hydroxypropyl (meth)acrylate, 2-hydroxypropyl (meth)acrylate, 3-amino-2-hydroxypropyl (meth)acrylate, N-2-hydroxyethyl (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, vinyl alcohol, allyl alcohol, and combinations thereof, more preferably selected from the group consisting of hydroxyethyl (meth)acrylate, glycerol(meth)acrylate, and vinyl alcohol. The mole percentages of repeating units can be calculated based on a non-silicone hydrogel lens formulation for making the non-silicone hydrogel contact lens.

In another preferred embodiment, a preformed contact lens is a silicone hydrogel contact lens comprising a silicone hydrogel material as lens bulk material.

Preformed silicone hydrogel contact lenses can be any commercially available silicone hydrogel contact lenses or can be produced according to any known methods. For example, for production of preformed silicone hydrogel (SiHy) contact lenses, a SiHy lens formulation for cast-molding or spin-cast molding or for making SiHy rods used in lathe-cutting of contact lenses generally comprises at least one components selected from the group consisting of a silicone-containing vinylic monomer, a polysiloxane vinylic crosslinker, a silicone-containing prepolymer, a hydrophilic vinylic monomer, a hydrophobic vinylic monomer, a non-silicone vinylic crosslinker, a free-radical initiator (photoinitiator or thermal initiator), a silicone-containing prepolymer, and combination thereof, as well known to a person skilled in the art. Resultant preformed SiHy contact lenses then can be subjected to extraction with an extraction solvent to remove unpolymerized components from the resultant lenses and to hydration process, as known by a person skilled in the art.

In accordance with the invention, a silicone-containing (or siloxane-containing) vinylic monomer can be any silicone-containing vinylic monomer known to a person skilled in the art. Examples of preferred silicone-containing vinylic monomers include without limitation vinylic monomers each having a bis(trialkylsilyloxy)alkylsilyl group (preferably a bis(trimethylsilyloxy)-alkylsilyl group) or a tris(trialkylsilyloxy)silyl group (preferably a tris(trimethylsilyloxy)silyl group), polysiloxane vinylic monomers, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, and combinations thereof.

Examples of preferred siloxane-containing vinylic monomers each having a bis(trialkylsilyloxy)alkylsilyl group or a tris(trialkylsilyloxy)silyl group include without limitation tris(trimethylsilyloxy)-silylpropyl (meth)acrylate, [3-(meth)acryloxy-2-hydroxypropyloxy]propyl-bis(trimethylsiloxy)-methylsilane, [3-(meth)acryloxy-2-hydroxypropyloxy]propyl-bis(trimethylsiloxy)butylsilane, 3-(meth)acryloxy-2-(2-hydroxyethoxy)-propyloxy)propyl-bis(trimethylsiloxy)methylsilane, 3-(meth)acryloxy-2-hydroxypropyloxy)propyltris(trimethylsiloxy) silane, N-[tris(trimethylsiloxy)-silylpropyl]-(meth)acrylamide, N-(2-hydroxy-3-(3-(bis(trimethylsilyloxy)methylsilyl)propyloxy)-propyl)-2-methyl (meth)acrylamide, N-(2-hydroxy-3-(3-(bis(trimethylsilyloxy)methylsilyl)-propyloxy)propyl)(meth)acrylamide, N-(2-hydroxy-3-(3-(tris(trimethylsilyloxy)silyl)propyloxy)-propyl)-2-methyl acrylamide, N-(2-hydroxy-3-(3-(tris(trimethylsilyloxy)silyl)propyloxy)propyl)(meth)acrylamide, N-[tris(dimethylpropylsiloxy)-silylpropyl]-(meth)acrylamide, N-[tris(dimethylphenylsiloxy)silylpropyl](meth)acrylamide, N-[tris(dimethylethylsiloxy)silylpropyl](meth)acrylamide, N,N-bis[2-hydroxy-3-(3-(bis(trimethylsilyloxy)methylsilyl)propyloxy)propyl]-2-methyl (meth)acrylamide, N,N-bis[2-hydroxy-3-(3-(bis(trimethylsilyloxy)methylsilyl)propyloxy)-propyl](meth)acrylamide, N,N-bis[2-hydroxy-3-(3-(tris(trimethylsilyloxy)silyl)propyloxy)propyl]-2-methyl (meth)acrylamide, N,N-bis[2-hydroxy-3-(3-(tris(trimethylsilyloxy)silyl)propyloxy)propyl](meth)acrylamide, N-[2-hydroxy-3-(3-(t-butyldimethylsilyl)propyloxy)propyl]-2-methyl (meth)acrylamide, N-[2-hydroxy-3-(3-(t-butyldimethylsilyl)propyloxy)propyl](meth)acrylamide, N,N-bis[2-hydroxy-3-(3-(t-butyldimethylsilyl)propyloxy)propyl]-2-methyl (meth)acrylamide, N-2-(meth)acryloxyethyl-O-(methyl-bis-trimethylsiloxy-3-propyl)silyl carbamate, 3-(trimethylsilyl)propylvinyl carbonate, 3-(vinyloxycarbonylthio)propyl-tris(trimethyl-siloxy)silane, 3-[tris(trimethylsiloxy)silyl]propylvinyl carbamate, 3-[tris(trimethylsiloxy)silyl]propyl allyl carbamate, 3-[tris(trimethylsiloxy)silyl]propyl vinyl carbonate, those disclosed in U.S. Pat. Nos. 9,097,840, 9,103,965 and 9,475,827, and mixtures thereof. The above preferred silicone-containing vinylic monomers can be obtained from commercial suppliers or can be prepared according to procedures described in U.S. Pat. Nos. 5,070,215, 6,166,236, 6,867,245, 7,214,809, 8,415,405, 8,475,529, 8,614,261, 8,658,748, 9,097,840, 9,103,965, 9,217,813, 9,315,669, and 9,475,827.

Examples of preferred polysiloxane vinylic monomers include without limitation mono-(meth)acryloyl-terminated, monoalkyl-terminated polysiloxanes of formula (I) include without limitation α-(meth)acryloxypropyl terminated ω-butyl (or ω-methyl) terminated polydimethylsiloxane, α-(meth)acryloxy-2-hydroxypropyloxypropyl terminated ω-butyl (or ω-methyl) terminated polydimethylsiloxane, α-(2-hydroxyl-methacryloxypropyloxypropyl)-ω-butyl-decamethylpentasiloxane, α-[3-(meth)acryloxyethoxy-2-hydroxypropyloxypropyl]-terminated ω-butyl (or ω-methyl) terminated polydimethylsiloxane, α-[3-(meth)acryloxy-propyloxy-2-hydroxypropyloxypropyl]-terminated ω-butyl (or ω-methyl) terminated polydimethylsiloxane, α-[3-(meth)acryloxyisopropyloxy-2-hydroxypropyloxypropyl]-terminated ω-butyl (or ω-methyl) terminated polydimethylsiloxane, α-[3-(meth)acryloxybutyloxy-2-hydroxypropyloxypropyl]-terminated ω-butyl (or ω-methyl) terminated polydimethylsiloxane, α-[3-(meth)acryloxy-ethylamino-2-hydroxypropyloxypropyl]-terminated ω-butyl (or ω-methyl) terminated polydimethylsiloxane, α-[3-(meth)acryloxypropylamino-2-hydroxypropyloxypropyl]-terminated ω-butyl (or ω-methyl) terminated polydimethylsiloxane, α-[3-(meth)acryloxy-butylamino-2-hydroxypropyloxypropyl]-terminated ω-butyl (or ω-methyl) terminated polydimethylsiloxane, α-(meth)acryloxy(polyethylenoxy)-2-hydroxypropyloxypropyl]-terminated ω-butyl (or ω-methyl) terminated polydimethylsiloxane, α-[(meth)acryloxy-2-hydroxypropyloxy-ethoxypropyl]-terminated ω-butyl (or ω-methyl) terminated polydimethylsiloxane, α-[(meth)acryloxy-2-hydroxypropyl-N-ethylaminopropyl]-terminated ω-butyl (or ω-methyl) terminated polydimethylsiloxane, α-[(meth)acryloxy-2-hydroxypropyl-aminopropyl]-terminated ω-butyl (or ω-methyl) terminated polydimethylsiloxane, α-[(meth)acryloxy-2-hydroxypropyloxy-(polyethylenoxy)propyl]-terminated ω-butyl (or ω-methyl) terminated polydimethylsiloxane, α-(meth)acryloylamidopropyloxypropyl terminated ω-butyl (or ω-methyl) terminated polydimethylsiloxane, α-N-methyl-(meth)acryloylamidopropyloxypropyl terminated ω-butyl (or ω-methyl) terminated polydimethylsiloxane, α-[3-(meth)acrylamidoethoxy-2-hydroxypropyloxy-propyl]-terminated ω-butyl (or ω-methyl) polydimethylsiloxane, α-[3-(meth)acrylamido-propyloxy-2-hydroxypropyloxypropyl]-terminated ω-butyl (or ω-methyl) terminated polydimethylsiloxane, α-[3-(meth)acrylamidoisopropyloxy-2-hydroxypropyloxypropyl]-terminated ω-butyl (or ω-methyl) terminated polydimethylsiloxane, α-[3-(meth)acrylamido-butyloxy-2-hydroxypropyloxypropyl]-terminated ω-butyl (or ω-methyl) terminated polydimethylsiloxane, α-[3-(meth)acryloylamido-2-hydroxypropyloxypropyl] terminated ω-butyl (or ω-methyl) polydimethylsiloxane, α-[3-[N-methyl-(meth)acryloylamido]-2-hydroxypropyloxy-propyl] terminated ω-butyl (or ω-methyl) terminated polydimethylsiloxane, N-methyl-N′-(propyltetra(dimethylsiloxy)dimethylbutylsilane)(meth)acrylamide, N-(2,3-dihydroxypropane)-N′-(propyltetra(dimethylsiloxy)dimethylbutylsilane)(meth)acrylamide, (meth)acryloylamido-propyltetra(dimethylsiloxy)dimethylbutylsilane, mono-vinyl carbonate-terminated mono-alkyl-terminated polydimethylsiloxanes, mono-vinyl carbamate-terminated mono-alkyl-terminated polydimethylsiloxane, those disclosed in U.S. Pat. Nos. 9,097,840 and 9,103,965, and mixtures thereof. The above preferred polysiloxanes vinylic monomers can be obtained from commercial suppliers (e.g., Shin-Etsu, Gelest, etc.) or prepared according to procedures described in patents, e.g., U.S. Pat. Nos. 6,166,236, 6,867,245, 8,415,405, 8,475,529, 8,614,261, 9,217,813, and 9,315,669, or by reacting a hydroxyalkyl (meth)acrylate or (meth)acrylamide or a (meth)acryloxypolyethylene glycol with a mono-epoxypropyloxypropyl-terminated polydimethylsiloxane, by reacting glycidyl (meth)acrylate with a mono-carbinol-terminated polydimethylsiloxane, a mono-aminopropyl-terminated polydimethylsiloxane, or a mono-ethylaminopropyl-terminated polydimethylsiloxane, or by reacting isocyanatoethyl(meth)acrylate with a mono-carbinol-terminated polydimethylsiloxane according to coupling reactions well known to a person skilled in the art.

In accordance with the invention, any polysiloxane vinylic crosslinkers can be used in this invention. Examples of preferred polysiloxane vinylic crosslinkers include without limitation α,ω-(meth)acryloxy-terminated polydimethylsiloxanes of various molecular weight; α,ω-(meth)acrylamido-terminated polydimethylsiloxanes of various molecular weight; α,ω-vinyl carbonate-terminated polydimethylsiloxanes of various molecular weight; α,ω-vinyl carbamate-terminated polydimethylsiloxane of various molecular weight; bis-3-methacryloxy-2-hydroxypropyloxypropyl polydimethylsiloxane of various molecular weight; N,N,N′,N′-tetrakis(3-methacryloxy-2-hydroxypropyl)-alpha, omega-bis-3-aminopropyl-polydimethylsiloxane of various molecular weight; the reaction products of glycidyl methacrylate with di-amino-terminated polydimethylsiloxanes; the reaction products of glycidyl methacrylate with di-hydroxyl-terminated polydimethylsiloxanes; the reaction products of an azlactone-containing vinylic monomer (any one of those described above) with di-hydroxyl-terminated polydimethylsiloxanes; the reaction products of isocyanatoethyl(meth)acrylate with di-hydroxyl-terminated polydimethylsiloxanes; the reaction products of isocyanatoethyl(meth)acrylate with di-amino-terminated polydimethylsiloxanes; polysiloxane-containing macromer selected from the group consisting of Macromer A, Macromer B, Macromer C, and Macromer D described in U.S. Pat. No. 5,760,100; polysiloxane vinylic crosslinkers disclosed in U.S. Pat. Nos. 4,136,250, 4,153,641, 4,182,822, 4,189,546, 4,259,467, 4,260,725, 4,261,875, 4,343,927, 4,254,248, 4,355,147, 4,276,402, 4,327,203, 4,341,889, 4,486,577, 4,543,398, 4,605,712, 4,661,575, 4,684,538, 4,703,097, 4,833,218, 4,837,289, 4,954,586, 4,954,587, 5,010,141, 5,034,461, 5,070,170, 5,079,319, 5,039,761, 5,346,946, 5,358,995, 5,387,632, 5,416,132, 5,449,729, 5,451,617, 5,486,579, 5,962,548, 5,981,675, 6,039,913, 6,762,264, 7,423,074, 8,163,206, 8,480,227, 8,529,057, 8,835,525, 8,993,651, 9,187,601, 10,081,697, 10,301,451, and 10,465,047.

One class of preferred polysiloxane vinylic crosslinkers are vinylic crosslinkers which are prepared by: reacting glycidyl (meth)acrylate or (meth)acryloyl chloride with a di-amino-terminated polydimethylsiloxane or a di-hydroxyl-terminated polydimethylsiloxane; reacting isocyanatoethyl(meth)acrylate with di-hydroxyl-terminated polydimethylsiloxanes; reacting an amino-containing acrylic monomer with di-carboxyl-terminated polydimethylsiloxane in the presence of a coupling agent (a carbodiimide); reacting a carboxyl-containing acrylic monomer with di-amino-terminated polydimethylsiloxane in the presence of a coupling agent (a carbodiimide); or reacting a hydroxyl-containing acrylic monomer with a di-hydroxy-terminated polydisiloxane in the presence of a diisocyanate or di-epoxy coupling agent.

Examples of such preferred polysiloxane vinylic crosslinkers are α,ω-bis[3-(meth)acryl-amidopropyl]-terminated polydimethylsiloxane, α,ω-bis[3-(meth)acryloxypropyl]-terminated polydimethylsiloxane, α,ω-bis[3-(meth)acryloxy-2-hydroxypropyloxypropyl]-terminated polydimethylsiloxane, α,ω-bis[3-(meth)acryloxyethoxy-2-hydroxypropyloxypropyl]-terminated polydimethylsiloxane, α,ω-bis[3-(meth)acryloxypropyloxy-2-hydroxypropyloxypropyl]-terminated polydimethylsiloxane, a, ω-bis[3-(meth)acryloxy-isopropyloxy-2-hydroxypropyloxypropyl]-terminated polydimethylsiloxane, a, ω-bis[3-(meth)acryloxybutyloxy-2-hydroxypropyloxypropyl]-terminated polydimethylsiloxane, a, ω-bis[3-(meth)acrylamidoethoxy-2-hydroxypropyloxypropyl]-terminated polydimethylsiloxane, α,ω-bis[3-(meth)acrylamidopropyloxy-2-hydroxypropyloxy-propyl]-terminated polydimethylsiloxane, α,ω-bis[3-(meth)acrylamidoisopropyloxy-2-hydroxypropyloxypropyl]-terminated polydimethylsiloxane, α,ω-bis[3-(meth)acrylamidobutyloxy-2-hydroxypropyloxypropyl]-terminated polydimethylsiloxane, α,ω-bis[3-(meth)acryloxy-ethylamino-2-hydroxypropyloxypropyl]-terminated polydimethylsiloxane, α,ω-bis[3-(meth)acryloxypropylamino-2-hydroxypropyloxypropyl]-terminated polydimethylsiloxane, α,ω-bis[3-(meth)acryloxybutylamino-2-hydroxypropyloxypropyl]-terminated polydimethylsiloxane, α,ω-bis[(meth)acrylamidoethylamino-2-hydroxypropyloxy-propyl]-terminated polydimethylsiloxane, α,ω-bis[3-(meth)acrylamidopropylamino-2-hydroxypropyloxypropyl]-terminated polydimethylsiloxane, a, ω-bis[3-(meth)acrylamide-butylamino-2-hydroxypropyloxy-propyl]-terminated polydimethylsiloxane, α,ω-bis[(meth)acryloxy-2-hydroxypropyloxy-ethoxypropyl]-terminated polydimethylsiloxane, α,ω-bis[(meth)acryloxy-2-hydroxypropyl-N-ethylaminopropyl]-terminated polydimethylsiloxane, α,ω-bis[(meth)acryloxy-2-hydroxypropyl-aminopropyl]-polydimethylsiloxane, α,ω-bis[(meth)acryloxy-2-hydroxypropyloxy-(polyethylenoxy)propyl]-terminated polydimethylsiloxane, α,ω-bis[(meth)acryloxyethylamino-carbonyloxy-ethoxypropyl]-terminated polydimethylsiloxane, α,ω-bis[(meth)acryloxyethylamino-carbonyloxy-(polyethylenoxy)propyl]-terminated polydimethylsiloxane, and mixtures thereof.

Another class of preferred polysiloxane vinylic crosslinkers are chain-extended polysiloxane vinylic crosslinkers each of which comprises at least two polysiloxane segments and can be prepared according to the procedures described in U.S. Pat. Nos. 5,034,461, 5,416,132, 5,449,729, 5,760,100, 7,423,074, 8,529,057, 8,835,525, 8,993,651, and 10,301,451 and in U.S. Pat. App. Pub. No. 2018-0100038 A1.

A further class of preferred polysiloxane vinylic crosslinkers are hydrophilized polysiloxane vinylic crosslinkers that each comprise at least about 1.50 (preferably at least about 2.0, more preferably at least about 2.5, even more preferably at least about 3.0) milliequivalent/gram (“meq/g”) of hydrophilic moieties, which preferably are hydroxyl groups (—OH), carboxyl groups (—COOH), amino groups (—NHR_{N1} in which R_{N1} is H or C₁-C₂ alkyl), amide moieties (—CO—NR_{N1}R_{N2} in which R_{N1} is H or C₁-C₂ alkyl and R_{N2} is a covalent bond, H, or C₁-C₂ alkyl), N—C₁-C₃ acylamino groups, urethane moieties (—NH—CO—O—), urea moieties (—NH—CO—NH—), a polyethylene glycol chain of

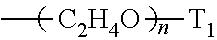

in which n is an integer of 2 to 20 and T1 is H, methyl or acetyl or a phosphorylcholine group, or combinations thereof.

Examples of such preferred hydrophilized polysiloxane vinylic crosslinkers are those compounds of formula (1)

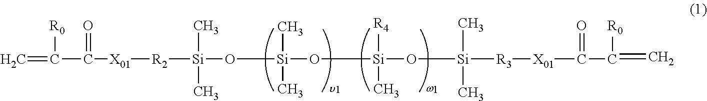

in which:
υ1 is an integer of from 30 to 500 and ω1 is an integer of from 1 to 75, provided that ω1/υ1 is from about 0.035 to about 0.15 (preferably from about 0.040 to about 0.12, even more preferably from about 0.045 to about 0.10);
X₀₁ is O or NRₙ in which Rₙ is hydrogen or C₁-C₁₀-alkyl;
Rₒ is hydrogen or methyl;
R₂ and R₃ independently of each other are a substituted or unsubstituted C₁-C₁₀ alkylene divalent radical or a divalent radical of —R₅—O—R₆— in which R₅ and R₆ independently of each other are a substituted or unsubstituted C₁-C₁₀ alkylene divalent radical;
R₄ is a monovalent radical of any one of formula (2) to (7)

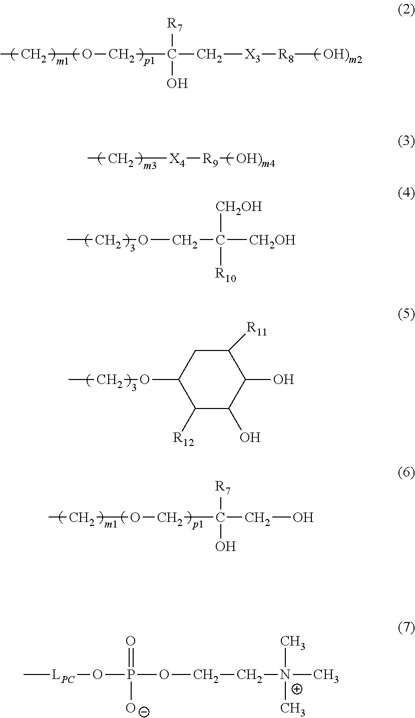

p1 is zero or 1; m1 is an integer of 2 to 4; m2 is an integer of 1 to 5; m3 is an integer of 3 to 6; m4 is an integer of 2 to 5;
R₇ is hydrogen or methyl;
R₈ is a C₂-C₆ hydrocarbon radical having (m2+1) valencies;
R₉ is a C₂-C₆ hydrocarbon radical having (m4+1) valencies;
R₁₀ is ethyl or hydroxymethyl;
R₁₁ is methyl or hydromethyl;
R₁₂ is hydroxyl or methoxy;
X₃ is a sulfur linkage of —S— or a tertiary amino linkage of —NR₁₃— in which R₁₃ is C₁-C₁ alkyl, hydroxyethyl, hydroxypropyl, or 2,3-dihydroxypropyl;

X₄ is an amide linkage of

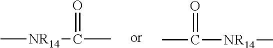

in which R₁₄ is hydrogen or C₁-C₁₀ alkyl;

L_{PC} is a divalent radical of —CH₂—CHR₀—R₁₅—, —C₃H₆—O—R₁₆—

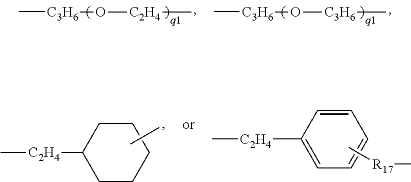

in which q1 is an integer of 1 to 20, R₁₅ is a linear or branched C₁-C₁₀ alkylene divalent radical, R₁₆ is a linear or branched C₃-C₁₀ alkylene divalent radical, and R₁₇ is a direct bond or a linear or branched C₁-C₄ alkylene divalent radical.

Hydrophilized polysiloxane vinylic crosslinker of formula (1) can be prepared according to the procedures disclosed in U.S. patent Ser. No. 10/081,697 and U.S. Pat. Appl. Pub. No. 2022/0251302 A1.

Any hydrophilic vinylic monomers can be used in the invention. Examples of preferred hydrophilic vinylic monomers are alkyl (meth)acrylamides (as described later in this application), hydroxyl-containing acrylic monomers (as described below), amino-containing acrylic monomers (as described later in this application), carboxyl-containing acrylic monomers (as described later in this application), N-vinyl amide monomers (as described later in this application), methylene-containing pyrrolidone monomers (i.e., pyrrolidone derivatives each having a methylene group connected to the pyrrolidone ring at 3- or 5-position) (as described later in this application), acrylic monomers having a C₁-C₄ alkoxyethoxy group (as described later in this application), vinyl ether monomers (as described later in this application), allyl ether monomers (as described later in this application), phosphorylcholine-containing vinylic monomers (as described later in this application), N-2-hydroxyethyl vinyl carbamate, N-carboxyvinyl-ß-alanine (VINAL), N-carboxyvinyl-α-alanine, and combinations thereof.

In accordance with the invention, any hydrophobic vinylic monomers can be in this invention. Examples of preferred hydrophobic vinylic monomers include methyl (meth)acrylate, ethyl (meth)acrylate, propyl (meth)acrylate, isopropyl (meth)acrylate, cyclohexyl (meth)acrylate, 2-ethylhexyl (meth)acrylate, vinyl acetate, vinyl propionate, vinyl butyrate, vinyl valerate, styrene, chloroprene, vinyl chloride, vinylidene chloride, (meth)acrylonitrile, 1-butene, butadiene, vinyl toluene, vinyl ethyl ether, perfluorohexylethyl-thio-carbonyl-aminoethyl-methacrylate, isobornyl (meth)acrylate, trifluoroethyl(meth)acrylate, hexafluoro-isopropyl (meth)acrylate, hexafluorobutyl(meth)acrylate, and combinations thereof.

In accordance with the invention, any non-silicone vinylic crosslinkers can be in this invention. Examples of preferred non-silicone vinylic cross-linking agents are described later in this application.

Any thermal polymerization initiators can be used in the invention. Suitable thermal polymerization initiators are known to the skilled artisan and comprise, for example peroxides, hydroperoxides, azo-bis(alkyl- or cycloalkylnitriles), persulfates, percarbonates, or mixtures thereof. Examples of preferred thermal polymerization initiators include without limitation benzoyl peroxide, t-butyl peroxide, t-amyl peroxybenzoate, 2,2-bis(tert-butylperoxy)butane, 1,1-bis(tert-butylperoxy)cyclohexane, 2,5-Bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, di-t-butyl-diperoxyphthalate, t-butyl hydro-peroxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl)peroxy dicarbonate (Perkadox 16S), di(2-ethylhexyl)peroxy dicarbonate, t-butylperoxy pivalate (Lupersol 11); t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-Azobis[2-(2-imidazolin-2-yl)propane]dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof. Preferably, the thermal initiator is 2,2′-azobis(isobutyronitrile) (AIBN or VAZO 64).

Suitable photoinitiators are benzoin methyl ether, diethoxyacetophenone, a benzoylphosphine oxide, 1-hydroxycyclohexyl phenyl ketone and Darocur and Irgacur types, preferably Darocur 1173® and Darocur 2959®, Germanium-based Norrish Type I photoinitiators (e.g., those described in U.S. Pat. No. 7,605,190). Examples of benzoylphosphine initiators include 2,4,6-trimethylbenzoyldiphenylphosphine oxide; bis-(2,6-dichlorobenzoyl)-4-N-propylphenyl-phosphine oxide; and bis-(2,6-dichlorobenzoyl)-4-N-butylphenylphosphine oxide.

A SiHy contact lens formulation can also comprise other necessary components known to a person skilled in the art, such as, for example, a UV-absorbing vinylic monomer, a HEVL-absorbing vinylic monomer, a visibility tinting agent (e.g., reactive dyes, polymerizable dyes, pigments, or mixtures thereof, as well known to a person skilled in the art), antimicrobial agents (e.g., preferably silver nanoparticles), a bioactive agent, leachable lubricants (e.g., non-polymerizable hydrophilic polymers, etc.), leachable tear-stabilizing agents (e.g., phospholipids, monoglycerides, diglycerides, triglycerides, glycolipids, glyceroglycolipids, sphingolipids, sphingo-glycolipids, etc.), and mixtures thereof, as known to a person skilled in the art.

A polymerizable composition (SiHy lens formulation) can be a solventless clear liquid prepared by mixing all polymerizable components and other necessary component or a solution prepared by dissolving all of the desirable components in any suitable solvent, such as, a mixture of water and one or more organic solvents miscible with water, an organic solvent, or a mixture of one or more organic solvents, as known to a person skilled in the art. The term “solvent” refers to a chemical that cannot participate in free-radical polymerization reaction.

A solventless lens SiHy lens formulation typically comprises at least one blending vinylic monomer as a reactive solvent for dissolving all other polymerizable components of the solventless SiHy lens formulation. Examples of preferred blending vinylic monomers are described later in this application. Preferably, methyl methacrylate is used as a blending vinylic monomer in preparing a solventless SiHy lens formulation.

Any solvents can be used in the invention. Example of preferred organic solvents includes without limitation, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimethyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-pyrrolidone, N,N-dimethylpropionamide, dimethyl formamide, dimethyl acetamide, dimethyl propionamide, N-methyl pyrrolidinone, and mixtures thereof.

Numerous SiHy lens formulations have been described in numerous patents and patent applications published by the filing date of this application and have been used in producing commercial SiHy contact lenses. Examples of commercial SiHy contact lenses include, without limitation, asmofilcon A, balafilcon A, comfilcon A, delefilcon A, efrofilcon A, enfilcon A, fanfilcon A, galyfilcon A, lotrafilcon A, lotrafilcon B, narafilcon A, narafilcon B, senofilcon A, senofilcon B, senofilcon C, smafilcon A, somofilcon A, and stenfilcon A.

A SiHy lens formulation (i.e., polymerizable composition) can be cured (polymerized) thermally or actinically as known to a person skilled in the art, preferably in molds for cast molding of contact lenses.

The thermal polymerization is carried out conveniently, for example at a temperature of from 25 to 120° C. and preferably 40 to 100° C. The reaction time may vary within wide limits, but is conveniently, for example, from 1 to 24 hours or preferably from 2 to 12 hours. It is advantageous to previously degas the components and solvents used in the polymerization reaction and to carry out said copolymerization reaction under an inert atmosphere, for example under a nitrogen or argon atmosphere.

The actinic polymerization can then be triggered off by actinic radiation, for example light, in particular UV light or visible light of a suitable wavelength. The spectral requirements can be controlled accordingly, if appropriate, by addition of suitable photosensitizers.

In accordance with the invention, a lens formulation can be introduced (dispensed) into a cavity formed by a mold according to any known methods.

After the lens formulation is dispensed into the mold, it is polymerized to produce a contact lens. Polymerization may be initiated thermally or actinically, preferably by exposing the lens formulation in the mold to a spatial limitation of actinic radiation to crosslink the polymerizable components in the lens formulation.

Opening of the mold so that the molded article can be removed from the mold may take place in a manner known per se.

The molded contact lens can be subject to lens extraction to remove unpolymerized polymerizable components. The extraction solvent can be any solvent known to a person skilled in the art. Examples of suitable extraction solvent are those described above.

A preformed contact lens of the invention can be obtained according to any method known to a person skilled in the art or to be developed.

In accordance with the invention, a preformed contact lens either inherently comprises or has been modified to comprise first reactive functional groups on and near its surface.

Where a preformed contact lens inherently comprises first reactive functional groups on and near its surfaces, it is obtained by polymerizing a polymerizable composition (i.e., a non-silicone hydrogel lens formulation or a silicone hydrogel lens formulation) comprising a reactive vinylic monomer which further comprises at least one first reactive functional group, e.g., selected from the group consisting of carboxyl group, primary amino group, secondary amino group, and combinations thereof. Examples of carboxyl-containing vinylic monomers and amino-containing vinylic monomers are known in the art and can be obtained from commercial sources or prepared according to known procedures. The lens formulation comprises preferably from about 1.0% to about 10%, more preferably from about 2.0% to about 7%, even more preferably from about 2.0% to about 5%, by weight of such a vinylic monomer having at least one first reactive functional group.

In accordance with the invention, any carboxyl-containing vinylic monomer can be added in a polymerizable composition. Examples of preferred carboxyl-containing vinylic monomers are carboxyl-containing (meth)acryloxy monomers which preferably include without limitation acrylic acid, methacrylic acid, ethylacrylic acid, propylacrylic acid, (meth)acryloxyacetic acid, mono-2-[(meth)acryloyloxy]ethyl succinate, (meth)acryloxypropionic acid, (meth)acryloxybutanoic acid, and combinations thereof.

In accordance with the invention, any amino-containing vinylic monomers can be added in a polymerizable composition. Examples of preferred amino-containing vinylic monomers are amino-containing (meth)acryloxy monomers which preferably include without limitation N-2-aminoethyl (meth)acrylamide, N-2-methylaminoethyl (meth)acrylamide, N-2-ethylaminoethyl (meth)acrylamide, N-3-aminopropyl (meth)acrylamide, N-3-methylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-ethylaminopropyl (meth)acrylate, 3-amino-2-hydroxypropyl (meth)acrylate, and combinations thereof.

Where a preformed contact lens inherently comprises amino groups on and near its surfaces, it can be modified chemically by reacting it with a thiolactone to covalently attach thiol groups through the amino groups.

Examples of preferred commercially-available thiolactone include without limitation 4-butyrothiolactone (or dihydro-2(3H)-thiophenone), 3-methyldihydro-2(3H)-thiophenone, 3-ethyldihydro-2(3H)-thiophenone, 3-(1-methylethyl)dihydro-2(3H)-thiophenone, 3,3-dimethyldihydro-2(3H)-thiophenone, 3-ethyl-3-methyldihydro-2(3H)-thiophenone, 3-acetyldihydro-2(3H)-thiophenone, N-acetyl homocysteine thiolactone, N-propionyl homocysteine thiolactone, N-butyryl homocysteine thiolactone, and N-carboxybutyryl homocysteine thiolactone (or 4-oxo-4-[(tetrahydro-2-oxo-3-thienyl)amino]-butanoic acid).

A preformed contact lens can also be subjected either to a surface treatment to have first reactive functional groups on and near its surfaces. Any suitable surface treatments can be used in the invention. Examples of surface treatments include without limitation: plasma treatments; chemical treatments; chemical vapor depositions; the grafting (covalently attaching) of compounds having at least one reactive functional groups onto the surface (modified or unmodified) of an article; the graft-polymerization of vinylic monomers having at least one first reactive functional group onto the surface (modified or unmodified) of an article; or combinations thereof.

A plasma treatment refers to a process in which a contact lens is exposed to a plasma to chemically modify the surface of the contact lens. The term “plasma” denotes an ionized gas (e.g., created by electric glow discharge which may be composed of electrons, ions of either polarity, gas atoms and molecules in the ground or any higher state of any form of excitation, as well as of photons). The excited species interact with solid surfaces of an article placed in the plasma, resulting in the chemical and physical modification of the material surface. Where a plasma is generated by subjecting a gas in a vacuum chamber to an electric charge typically at radio frequency (rf) (or at a microwave or other frequency), it is often called “low temperature plasma”. Where a plasma is generated by an atmospheric discharge (e.g., arc discharge) and sustained at a surrounding atmospheric pressure, it is a “high temperature plasma” or “atmospheric plasma”. An atmospheric plasma can be produced by atmospheric pressure discharges.

For a review of plasma treatment and its uses reference is made to R. Hartmann “Plasma polymerisation: Grundlagen, Technik und Anwendung, Jahrb. Oberflächentechnik (1993) 49, pp. 283-296, Battelle-Inst. e.V. Frankfurt/Main Germany; H. Yasuda, “Glow Discharge Polymerization”, Journal of Polymer Science: Macromolecular Reviews, vol. 16 (1981), pp. 199-293; H. Yasuda, “Plasma Polymerization”, Academic Press, Inc. (1985); Frank Jansen, “Plasma Deposition Processes”, in “Plasma Deposited Thin Films”, ed. by T. Mort and F. Jansen, CRC Press Boca Raton (19); O. Auciello et al. (ed.) “Plasma-Surface Interactions and Processing of Materials” publ. by Kluwer Academic Publishers in NATO ASI Series; Series E: Applied Sciences, vol. 176 (1990), pp. 377-399; and N. Dilsiz and G. Akovali “Plasma Polymerization of Selected Organic Compounds”, Polymer, vol. 37 (1996) pp. 333-341.

The known plasma treatment under low pressure includes plasma deposition, plasma-induced polymerization, plasma grafting, plasma oxidation, and the likes. Plasma treatment under low pressure haven been used in commercial products, for example, such as, Focus NIGHT & DAY® and AIR OPTIX® (Alcon), and PUREVISION® (Bausch & Lomb). Advantages of a plasma coating, such as, e.g., those may be found with Focus NIGHT & DAY®, are its durability, relatively high hydrophilicity/wettability), and low susceptibility to lipid and protein deposition and adsorption. Examples of plasma treatment are those disclosed in U.S. Pat. Nos. 4,143,949; 4,312,575; 5,464,667, 6,881,269; and 7,078,074. It is understood that a preformed contact lenses must typically be dried before a plasma treatment under low pressure.

A person skilled in the art understand well that a plasma (i.e., electrical glow discharge plasma) is a partially ionized gas which consists of large concentrations of excited atomic, molecular, ionic, and free-radical species and which is generated subjecting a gas in a vacuum chamber to an electric field, typically at radio frequency (rf) (or at a microwave or other frequency).

As an illustrated example of plasma treatment under low pressure of silicone hydrogel contact lenses, one or more preformed silicone hydrogel contact lenses are placed in a reactor chamber between opposing electrodes. The chamber is then sealed and depressurized by a vacuum system. Significant time is required to pump the system to the operative pressure. When a suitable pressure is achieved in the chamber, a process gas is introduced into the chamber interior, and the electrodes are energized. The resulting plasma cloud may apply a thin layer of polymer (or a polymer coating) to the lens and/or change the chemical composition of a top layer of the lens surface depending upon the process gas used. After an appropriate time, the electrodes are de-energized, and the reactor chamber is brought back to atmospheric pressure so that the lenses may be removed.

Low pressure plasma treatment systems are known to a person skilled in the art and have been disclosed in patents and articles. For example, Peng Ho and Yasuda describe, in their paper (“Ultrathin Coating Of Plasma Polymer Of Methane Applied On The Surface Of Silicone Contact Lenses,” Journal of Biomedical Materials Research, Vol. 22, 919-937 (1988)), a batch low-pressure-plasma treatment system (or a rotary plasma system) including a bell-shaped vacuum chamber in which opposing aluminum electrodes are disposed and a rotatable aluminum plate sits between the electrodes and is driven by an induction motor within the system. Matsuzawa and Winterton disclose in U.S. Pat. No. 6,881,269 a linear low-pressure-plasma system.

In accordance with the invention, the preformed contact lens in a dried state is treated with a low-pressure plasma generated in a plasma gas (i.e., an atmosphere) compose of air, N₂, O₂, CO₂, or a mixture of a C₁-C₆ hydrocarbon and a secondary gas selected from the group consisting of air, N₂, O₂, CO₂, and combinations thereof (preferably CO₂ or a mixture of a C₁-C₄ hydrocarbon and a secondary gas selected from the group consisting of air, CO₂, N₂, and combinations thereof, more preferably CO₂ or a mixture of methane and a secondary gas selected from the group consisting of air, CO₂, N₂, and combinations thereof, even more preferably CO₂ or a mixture of methane and CO₂).

Atmospheric plasma surface treatment disclosed in U.S. Pat. No. 9,156,213 is preferably used in the invention. For the atmospheric plasma surface treatment, contact lenses can be in a fully hydrated state.

A person skilled in the art knows well how to graft (covalently attach) a compound having at least one first reactive functional group (carboxyl group, amino group, azetidinium group, epoxide group, aziridine group, vinylsulfone group, thiol group, and combinations thereof) onto a surface of a contact lens according to known coupling reactions.

Graft-polymerization of one more vinylic monomers having at least one first reactive functional group (e.g., carboxyl, amino, azetidinium group, epoxide group, aziridine group, and combinations thereof) in the presence or absence of a vinylic crosslinking agent to form a hydrophilic polymer coating are described in numerous patents, for example, in U.S. Pat. Nos. 6,099,122, 6,436,481, 6,440,571, 6,447,920, 6,465,056, 6,521,352, 6,586,038, 6,730,366, 6,734,321, 6,835,410, and 6,878,399 and in JP2001075060. For example, a preformed contact lens in dry state is first subjected to a plasma treatment in a plasma atmosphere of a compound having at least one reactive functional group (e.g., a vinylic monomer having a primary or secondary amino group, a carboxyl group, an epoxy group, an azlactone group, an aziridine group, or an isocyanate group) to form a plasma coating having reactive functional groups. The plasma-treated contact lens is reacted with a compound having a free-radical initiator moiety (e.g., a thermal initiator or a photoinitiator) or preferably a living polymerization initiator moiety (e.g., an atom transfer radical polymerization (ATRP) initiator or a reversible addition fragmentation chain transfer polymerization (RAFT) initiator) and a functional group co-reactive with the functional groups of the plasma coating on the contact lens in the presence or absence of a coupling agent under coupling reaction conditions known to a person skilled in the art. The obtained contact lens with free-radical initiator moieties thereon is immersed in a solution of one or more vinylic monomers having at least one first functional group and subject to conditions to initiate free radical polymerization of those vinylic monomers so as to form a layer of a graft-from polymer comprising first reactive functional groups.

Any non-silicone hydrogel materials can be used in covering zones on the convex surface of a preformed contact lens, so long as they are free of first reactive functional groups (any of those described above) and thermally-crosslinkable groups (e.g., azetidinium groups and/or epoxy groups). A person skilled in the art know well to cover those zones on the convex surface of a preformed contact lens.

In a preferred embodiment, a hydrogel-forming composition can be applying onto multiple zones on the convex surface of a preformed contact lens according to pad-transfer printing and/or inkjet printing techniques, and then the hydrogel-forming composition applied onto the zones on the convex surface of a preformed contact lens is cured thermally or actinically to form a non-silicone hydrogel material to cover those zones.

Any hydrogel-forming compositions for forming non-silicone hydrogel materials can be used so long as the resultant non-silicone hydrogel materials are free of first reactive functional groups (those described above) and thermally-crosslinkable groups (azetidinium groups and/or epoxy groups).

Preferably, a hydrogel-forming composition comprises at least one crosslinkable polymer having hydroxyl groups and/or ethylenically unsaturated groups and optionally at least one hydrophobic vinylic monomer selected from the group consisting of methoxyethyl (meth)acrylate, ethoxyethyl (meth)acrylate, methyl (meth)acrylate, and combination thereof, wherein if said at least one crosslinkable polymer is free of any ethylenical unsaturated group, the hydrogel-forming composition comprises additionally at least one hydroxyl-containing vinylic monomer and at least one compound having two or more isocyanato groups, wherein all polymerizable components in the hydrogel-forming composition are free of first reactive functional groups (those described above) and thermally-crosslinkable groups (azetidinium groups and/or epoxy groups).

One class of crosslinkable polymers having hydroxyl groups and ethylenically unsaturated groups includes without limitation water-soluble crosslinkable poly(vinyl alcohol) prepolymers that comprises repeating units of —CH₂—CHOH— and repeating units each having one ethylenically unsaturated group, as described in U.S. Pat. Nos. 5,583,163 and 6,303,687.

Preferred crosslinkable polymer having hydroxyl groups but free of ethylenically unsaturated groups can be prepared by polymerizing a polymerizable composition comprising: at least one hydroxyl-containing vinylic monomer, at least one vinylic monomer selected from the group consisting of vinylpyrrolidone, vinylchloride, (meth)acrylamide, N,N-dimethyl (meth)acrylamide, methoxyethyl ethoxyethyl (meth)acrylate, methyl methacrylate, ethyl methacrylate, and combinations thereof; a chain transfer agent (e.g., 2-mercaptoethanol); a free-radical thinitiator.

Examples of preferred hydroxyl-containing vinylic monomers include without limitation hydroxyethyl (meth)acrylate, glycerol(meth)acrylate, 3-hydroxypropyl (meth)acrylate, 2-hydroxypropyl (meth)acrylate, 3-amino-2-hydroxypropyl (meth)acrylate, N-2-hydroxyethyl (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, vinyl alcohol, allyl alcohol, and combinations thereof. More preferably, hydroxyethyl (meth)acrylate, glycerol(meth)acrylate, and vinyl alcohol are used.

Pad transfer printing is well known in the art (see, for example, U.S. Pat. Nos. 3,536,386; 4,582,402; 4,704,017; 5,034,166). A typical example of this printing follows. An image is etched into metal to form a cliché. The cliché is placed in a printer. Once in the printer, the cliché is inked by either an open inkwell doctoring system or by a closed ink cup sliding across the image. Then, a silicone pad picks up the inked image from the cliché and transfers the image to the contact lens. The silicone pads are made of a material comprising silicone that can vary in elasticity. The properties of the silicone material permit the inks (here a hydrogel-forming composition) to stick to the pad temporarily and fully release from the pad when it contacts a contact lens or a mold. Appropriate pad-transfer printing structures include, but are not limited to, Tampo-type printing structures (Tampo vario 90/130), rubber stamps, thimbles, doctor's blade, direct printing, or transfer printing as they are known in the art.

Any known suitable silicone pad can be used in the present invention. Silicone pads are commercially available. However, different pads could give different print qualities. A person skilled in the art will know how to select a pad for a given hydrogel-forming composition.

Clichés can be made of ceramics, polymer, or metals (e.g., steel). Where a cliché is made of a steel, it would be desirable to neutralize the pH of a water-based ink (e.g., adjusted pH to 6.8˜7.8) by adding a buffer (such as, for example, phosphate salts). Images can be etched into a cliché according to any methods known to a person skilled in the art, for example, by chemical etching or laser ablation or the like. It is also desirable to clean clichés after use using standard cleaning techniques known to a person skilled in the art, such as, for example, immersion in a solvent, sonication, or mechanical abrasion.

Printing the lens using an inkjet printing process is described in U.S. Pat. Appl. Nos. 2001/0050753, 2001/0085934, 2003/0119943, and 2003/0184710.

In accordance with the invention, the multiple zones can have any shapes. Examples of preferred shapes include without limitation circular shape, triangular shape, square shape, rectangular shape, hexagonal shape, polygonal shape, stars, annular ring, a curved line, a straight line, and combinations thereof. The multiple zones can have any 2-dimensional size. Preferably, one of the two dimensions of the multiple zones is about 0.40 mm or less (preferably about 0.30 mm or less, more preferably about 0.25 mm or less, even more preferably from about 0.05 mm to about 0.20 mm).

In accordance with one embodiment of the invention, the multiple zones are arranged in any pattern, preferably in rotationally symmetric pattern with respect to the central axis of the preformed contact lens or the female mold half, on the convex surface of the preformed contact lens or the molding surface of the female mold half. Preferably, the multiple zones are located in an annular zone having an inner diameter of from about 6.0 mm to about 9.0 mm and an outer diameter of from about 11.5 mm to about 14.5 mm and being concentric with respect to the central axis of the preformed contact lens or the female mold half.

In one embodiment, the multiple zones comprise at least three annular rings.

In another embodiment, the multiple zones comprise at least eight curved or straight lines radiating outward from a circle having a diameter of from about 6.0 mm to about 9.0 mm and being concentric with respect to the central axis of the preformed contact lens or the female mold half.

In another embodiment, the multiple zones comprise circular dots (preferably having a diameter of about 0.25 mm or less, more preferably having a diameter of from about 0.05 mm to about 0.20 mm) which are arranged in a rotationally symmetric pattern on the convex surface of the preformed contact lens or the molding surface of the female mold half with respect to the central axis of the preformed contact lens or the female mold half. Preferably, circular dots are arranged in annular ring concentric with the central axis of the preformed contact lens or the female mold half.

It is understood that the shapes of the multiple zones determine the shape of the imperfections in the anterior outer hydrogel layer of a coated contact lens of the invention. Zones with annular rings, curved lines, and/or straight lines will result in formation of ditches in the anterior outer hydrogel layer of a coated contact lens, whereas zones with a circular shape, a triangular shape, a square shape, a rectangular shape, a hexagonal shape, a polygonal shape, and/or a star shape will result in formation of gaps the anterior outer hydrogel layer of a coated contact lens.

In accordance with the invention, a water-soluble and thermally-crosslinkable hydrophilic polymeric material preferably comprises azetidinium groups or epoxy groups or combinations thereof. Preferably, the water-soluble and crosslinkable hydrophilic polymeric material is a partially-crosslinked polymeric material that comprises a three-dimensional network and thermally-crosslinkable groups, preferably azetidinium groups, within the network or being attached to the network. The term “partially-crosslinked” in reference to a polymeric material means that the crosslinkable groups of starting materials for making the polymeric material in crosslinking reaction have not been fully consumed. For example, such a thermally-crosslinkable hydrophilic polymeric material comprises azetidinium groups and is a partial reaction product of at least one azetidinium-containing polymer with at least one hydrophilicity-enhancing agent (i.e., a wetting agent) having at least one carboxyl, primary amine, secondary amine, or thiol group, according to the crosslinking reactions shown in Scheme I

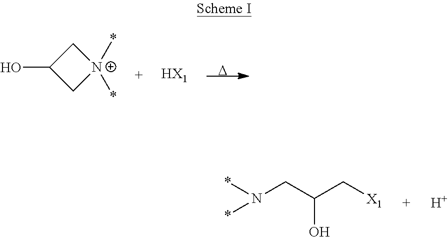

in which X₁ is —S—*, —OC(═O)—*, or —NR′—* in which R′ is hydrogen or a C₁-C₂₀ unsubstituted or substituted alkyl group, and * represents an organic radical.

Examples of preferred water-soluble and thermally-crosslinkable hydrophilic polymeric materials comprising epoxy groups include without limitation: one or more multi-armed polyethylene glycols each having terminal epoxy groups; a mixture of a multi-armed polyethylene glycol having terminal epoxy group and one or more polyethylene glycol each having terminal functional groups selected from the group consisting of primary amine groups, secondary amine groups, carboxyl groups, thiol groups, and combinations thereof; a partial reaction product of a multi-armed polyethylene having terminal epoxy groups and a hydrophilicity-enhancing agent having at least one reactive functional group selected from the group consisting of amino group, carboxyl group, thiol group, and combination thereof (as disclosed in U.S. Pat. No. 9,505,184, hydrophilic polymers disclosed in U.S. Pat. No. 6,440,571), or combinations thereof.

Examples of preferred water-soluble and thermally-crosslinkable hydrophilic polymeric materials comprising azetidinium groups include without limitation poly(2-oxazoline-co-ethyleneimine)-epichlorohydrin copolymers which are disclosed in U.S. Pat. No. 9,720,138, chemically-modified poly(2-oxazoline-co-ethyleneimine)-epichlorohydrin copolymers which are disclosed in U.S. Pat. No. 9,720,138, chemically-modified polyamidoamine-epichlorohydrins as disclosed in U.S. Pat. No. 8,529,057, copolymers of an azetidinium-containing vinylic monomer with one or more hydrophilic vinylic monomers disclosed in U.S. Pat. No. 9,422,447, chemically-modified copolymers of an azetidinium-containing vinylic monomer with one or more hydrophilic vinylic monomers disclosed in U.S. Pat. No. 9,422,447, or combinations thereof.

In accordance with the invention, the term “chemically-modified” in reference with a water-soluble and thermally crosslinkable hydrophilic polymeric material having azetidinium groups means that a poly(2-oxazoline-co-ethyleneimine)-epichlorohydrin copolymer, a polyamidoamine-epichlorohydrin or a copolymer of an azetidinium-containing vinylic monomer is reacted partially (i.e., not consuming all of the azetidinium groups) with a hydrophilicity-enhancing agent having at least one reactive functional group selected from the group consisting of amino group, carboxyl group, thiol group, and combination thereof. A chemically-modified poly(2-oxazoline-co-ethyleneimine)-epichlorohydrin copolymer or polyamidoamine-epichlorohydrin or copolymer of an azetidinium-containing vinylic monomer can be especially useful for forming relatively-thick and soft non-silicone hydrogel coatings on silicone hydrogel contact lenses.

Any suitable hydrophilicity-enhancing agents can be used in the invention so long as they contain at least one amino group, at least one carboxyl group, and/or at least one thiol group.

A preferred class of hydrophilicity-enhancing agents include without limitation: primary amino-, secondary amino-, carboxyl- or thiol-containing monosaccharides (e.g., 3-amino-1,2-propanediol, 1-thiolglycerol, 5-keto-D-gluconic acid, galactosamine, glucosamine, galacturonic acid, gluconic acid, glucosaminic acid, mannosamine, saccharic acid 1,4-lactone, saccharide acid, Ketodeoxynonulosonic acid, N-methyl-D-glucamine, 1-amino-1-deoxy-ß-D-galactose, 1-amino-1-deoxysorbitol, 1-methylamino-1-deoxysorbitol, N-aminoethyl gluconamide); primary amino-, secondary amino-, carboxyl- or thiol-containing disaccharides (e.g., chondroitin disaccharide sodium salt, di(ß-D-xylopyranosyl)amine, digalacturonic acid, heparin disaccharide, hyaluronic acid disaccharide, Lactobionic acid); and primary amino-, secondary amino-, carboxyl- or thiol-containing oligosaccharides (e.g., carboxymethyl-ß-cyclodextrin sodium salt, trigalacturonic acid); and combinations thereof.

Another preferred class of hydrophilicity-enhancing agents is hydrophilic polymers having one or more (primary or secondary) amino, carboxyl and/or thiol groups. More preferably, the content of the amino (—NHR′ with R′ as defined above), carboxyl (—COOH) and/or thiol (—SH) groups in a hydrophilic polymer as a hydrophilicity-enhancing agent is less than about 40%, preferably less than about 30%, more preferably less than about 20%, even more preferably less than about 10%, by weight based on the total weight of the hydrophilic polymer.

One preferred class of hydrophilic polymers as hydrophilicity-enhancing agents are (primary or secondary) amino- or carboxyl-containing polysaccharides, for example, such as, carboxymethylcellulose (having a carboxyl content of about 40% or less, which is estimated based on the composition of repeating units, —[C₆H₁₀₋ₘO₅(CH₂CO₂H)ₘ]— in which m is 1 to 3), carboxyethylcellulose (having a carboxyl content of about 36% or less, which is estimated based on the composition of repeating units, —[C₆H₁₀₋ₘO₅(C₂H₄CO₂H)ₘ]— in which m is 1 to 3) carboxypropylcellulose (having a carboxyl content of about 32% or less, which is estimated based on the composition of repeating units, —[C₆H₁₀₋ₘO₅(C₃H₆CO₂H)ₘ], in which m is 1 to 3), hyaluronic acid (having a carboxyl content of about 11%, which is estimated based on the composition of repeating units, —(C₁₃H₂₀O₉NCO₂H)—), chondroitin sulfate (having a carboxyl content of about 9.8%, which is estimated based on the composition of repeating units, —(C₁₂H₁₈O₁₃NS CO₂H)—), or combinations thereof.

Another preferred class of hydrophilic polymers as hydrophilicity-enhancing agents include without limitation: poly(ethylene glycol) (PEG) with mono-amino (primary or secondary amino), carboxyl or thiol group (e.g., PEG-NH₂, PEG-SH, PEG-COOH); H₂N-PEG-NH₂; HOOC-PEG-COOH; HS-PEG-SH; H₂N-PEG-COOH; HOOC-PEG-SH; H₂N-PEG-SH; multi-arm PEG with one or more amino (primary or secondary), carboxyl or thiol groups; PEG dendrimers with one or more amino (primary or secondary), carboxyl or thiol groups; a diamino-(primary or secondary) or dicarboxyl-terminated homo- or co-polymer of a non-reactive hydrophilic vinylic monomer; a monoamino-(primary or secondary) or monocarboxyl-terminated homo- or co-polymer of a non-reactive hydrophilic vinylic monomer; a copolymer which is a polymerization product of a composition comprising (1) about 60% by weight or less, preferably from about 0.1% to about 30%, more preferably from about 0.5% to about 20%, even more preferably from about 1% to about 15%, by weight of one or more reactive vinylic monomers and (2) at least one non-reactive hydrophilic vinylic monomer; and combinations thereof. Reactive vinylic monomer(s) and non-reactive hydrophilic vinylic monomer(s) are those described previously.

In accordance with the invention, reactive vinylic monomers for making hydrophilicity-enhancing agents can be carboxyl-containing vinylic monomers, primary amino-containing vinylic monomers, or secondary amino-containing vinylic monomers. Examples of preferred carboxyl-containing vinylic monomers include without limitation acrylic acid, methacrylic ethylacrylic acid, N-2-(meth)acrylamidoglycolic acid, and combinations thereof. Examples of preferred primary and secondary amino-containing vinylic monomers include without limitation N-2-aminoethyl (meth)acrylamide, N-2-methylaminoethyl (meth)acrylamide, N-2-ethylaminoethyl (meth)acrylamide, N-3-aminopropyl (meth)acrylamide, N-3-methylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-ethylaminopropyl (meth)acrylate, 3-amino-2-hydroxypropyl (meth)acrylate, and combinations thereof.

In accordance with the invention, a non-reactive vinylic monomer for making hydrophilicity-enhancing agents is a vinylic monomer free of any carboxyl group, primary amino group, secondary amino group, epoxide group, isocyanate group, azlactone group, or aziridine group. Non-reactive vinylic monomers preferably are non-charged hydrophilic vinylic monomers which are free of carboxyl or amino group (any those described above can be used here), phosphorylcholine-containing vinylic monomers (any those described above can be used here), or combinations thereof.

More preferably, a hydrophilic polymer as a hydrophilicity-enhancing agent is:
a poly(ethylene glycol) having one sole functional group of —NH₂, —SH or —COOH;
a poly(ethylene glycol) having two terminal functional groups selected from the group consisting of —NH₂, —COOH, —SH, and combinations thereof;
a multi-arm poly(ethylene glycol) having one or more functional groups selected from the group consisting of —NH₂, —COOH, —SH, and combinations thereof;
a monoamino-, monocarboxyl-, diamino- or dicarboxyl-terminated homo- or copolymer of a non-reactive hydrophilic vinylic monomer;
a copolymer which is a polymerization product of a composition comprising (1) from about 0.1% to about 30%, preferably from about 0.5% to about 20%, more preferably from about 1% to about 15%, by weight of a reactive vinylic monomer and (2) at least one non-reactive vinylic monomer,
Examples of preferred reactive vinylic monomers include without limitation acrylic acid, methacrylic acid, ethylacrylic acid, 2-(meth)acrylamidoglycolic acid, N-2-aminoethyl (meth)acrylamide, N-2-methylaminoethyl (meth)acrylamide, N-2-ethylaminoethyl (meth)acrylamide, N-3-aminopropyl (meth)acrylamide, N-3-methylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-amino-2-hydroxypropyl (meth)acrylate, and combinations thereof.

Example of preferred non-reactive hydrophilic vinylic monomers include without limitation alkyl (meth)acrylamides (any one described above), N-2-dimethylaminoethyl (meth)acrylamide, dimethylaminoethyl (meth)acrylate, hydroxyl-containing acrylic monomers (any one described above), N-vinyl amide monomers (any one described above), methylene-containing pyrrolidone monomers (i.e., pyrrolidone derivatives each having a methylene group connected to the pyrrolidone ring at 3- or 5-position) (any one described above), acrylic monomers having a C₁-C₄ alkoxyethoxy group (any one described above), vinyl ether monomers (any one described above), allyl ether monomers (any one described above), a phosphorylcholine-containing vinylic monomer (any one described above), and combinations thereof.

Preferably, the non-reactive hydrophilic vinylic monomer is selected from the group consisting of (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)ethylphosphate, 3-[(meth)acryloylamino]-propyl-2′-(trimethylammonio)ethylphosphate. 4-[(meth)acryloylamino]butyl-2′-(trimethylammonio)ethylphosphate, (meth)acrylamide, dimethyl (meth)acrylamide, N-2-hydroxylethyl (meth)acrylamide, N,N-bis(hydroxyethyl)(meth)acrylamide, N-2,3-dihydroxypropyl (meth)acrylamide, N-tris(hydroxymethyl)methyl (meth)acrylamide, 2-hydroxyethyl (meth)acrylate, glycerol methacrylate (GMA), tetra(ethylene glycol)(meth)acrylate, poly(ethylene glycol)ethyl (meth)acrylamide having a number average molecular weight of up to 1500, poly(ethylene glycol)(meth)acrylate having a number average molecular weight of up to 1500, N-vinylpyrrolidone, N-vinyl-N-methyl acetamide, N-vinyl formamide, N-vinyl acetamide, 1-methyl-3-methylene-2-pyrrolidone, 1-methyl-5-methylene-2-pyrrolidone, 5-methyl-3-methylene-2-pyrrolidone, tetra(ethylene glycol)methyl ether(meth)acrylate, methoxypoly(ethylene glycol)ethyl (meth)acrylamide having a number average molecular weight of up to 1500, C₁-C₄-alkoxy polyethylene glycol (meth)acrylate having a weight average molecular weight of up to 1500, tetra(ethylene glycol) monovinyl ether, poly(ethylene glycol) monovinyl ether, tetra(ethylene glycol)methyl vinyl ether, poly(ethylene glycol)methyl vinyl ether, tetra(ethylene glycol) monoallyl ether, poly(ethylene glycol) monoallyl ether, tetra(ethylene glycol)methyl allyl ether, poly(ethylene glycol)methyl allyl ether, vinyl alcohol, allyl alcohol, and combinations thereof, more preferably selected from the group consisting of (meth)acryloyloxyethyl phosphorylcholine, (meth)acryloyloxypropyl phosphorylcholine, 4 ((meth)acryloyloxy)butyl-2′-(trimethylammonio)ethylphosphate. 2-[(meth)acryloylamino]ethyl-2′-(trimethylammonio)-ethylphosphate. 3-[(meth)acryloylamino]-propyl-2′-(trimethylammonio)ethylphosphate, 4-[(meth)acryloylamino]butyl-2′-(trimethylammonio)ethylphosphate. (meth)acrylamide, dimethyl (meth)acrylamide, N-2-hydroxylethyl (meth)acrylamide, N,N-bis(hydroxyethyl)(meth)acrylamide, N-2,3-dihydroxypropyl (meth)acrylamide, N-tris(hydroxymethyl)methyl (meth)acrylamide, 2-hydroxyethyl (meth)acrylate, glycerol methacrylate (GMA), poly(ethylene glycol)ethyl (meth)acrylamide having a number average molecular weight of up to 1500, poly(ethylene glycol)(meth)acrylate having a number average molecular weight of up to 1500, N-vinylpyrrolidone, N-vinyl-N-methyl acetamide, methoxypoly(ethylene glycol)ethyl (meth)acrylamide having a number average molecular weight of up to 1500, methoxy polyethylene glycol (meth)acrylate having a weight average molecular weight of up to 1500, poly(ethylene glycol) monovinyl ether, poly(ethylene glycol)methyl vinyl ether, poly(ethylene glycol) monoallyl ether, poly(ethylene glycol)methyl allyl ether, vinyl alcohol, allyl alcohol, and combinations thereof, even more preferably selected from the group consisting of (meth)acryloyloxyethyl phosphorylcholine, (meth)acryloyloxypropyl phosphorylcholine, 2-[(meth)acryloylamino]ethyl-2′-(trimethylammonio)ethylphosphate, 3-[(meth)acryloylamino]-propyl-2′ (trimethylammonio)ethylphosphate, (meth)acrylamide, dimethyl (meth)acrylamide, N-2-hydroxylethyl (meth)acrylamide, N,N-bis(hydroxyethyl)(meth)acrylamide, N-2,3-dihydroxypropyl (meth)acrylamide, N-tris(hydroxymethyl)methyl (meth)acrylamide, poly(ethylene glycol)ethyl (meth)acrylamide having a number average molecular weight of up to 1500, poly(ethylene glycol)(meth)acrylate having a number average molecular weight of up to 1500, N-vinylpyrrolidone, N-vinyl-N-methyl acetamide, methoxypoly(ethylene glycol)ethyl (meth)acrylamide having a number average molecular weight of up to 1500, methoxy polyethylene glycol (meth)acrylate having a weight average molecular weight of up to 1500, and combinations thereof.

PEGs with functional groups and multi-arm PEGs with functional groups can be obtained from various commercial suppliers, e.g., Polyscience, and Shearwater Polymers, inc., etc.

Monoamino-, monocarboxyl-, diamino- or dicarboxyl-terminated homo- or copolymers of one or more non-reactive hydrophilic vinylic monomers or of a phosphorylcholine-containing vinylic monomer can be prepared according to procedures described in U.S. Pat. No. 6,218,508. For example, to prepare a diamino- or dicarboxyl-terminated homo- or co-polymer of a non-reactive hydrophilic vinylic monomer, the non-reactive vinylic monomer, a chain transfer agent with an amino or carboxyl group (e.g., 2-aminoethanethiol, 2-mercaptopropionic acid, thioglycolic acid, thiolactic acid, or other hydroxymercaptanes, aminomercaptans, or carboxyl-containing mercaptanes) and optionally other vinylic monomer are copolymerized (thermally or actinically) with a reactive vinylic monomer (having an amino or carboxyl group), in the presence of an free-radical initiator. Generally, the molar ratio of chain transfer agent to that of all of vinylic monomers other than the reactive vinylic monomer is from about 1:5 to about 1:100, whereas the molar ratio of chain transfer agent to the reactive vinylic monomer is 1:1. In such preparation, the chain transfer agent with amino or carboxyl group is used to control the molecular weight of the resultant hydrophilic polymer and forms a terminal end of the resultant hydrophilic polymer so as to provide the resultant hydrophilic polymer with one terminal amino or carboxyl group, while the reactive vinylic monomer provides the other terminal carboxyl or amino group to the resultant hydrophilic polymer. Similarly, to prepare a monoamino- or monocarboxyl-terminated homo- or co-polymer of a non-reactive hydrophilic vinylic monomer, the non-reactive vinylic monomer, a chain transfer agent with an amino or carboxyl group (e.g., 2-aminoethanethiol, 2-mercaptopropionic acid, thioglycolic acid, thiolactic acid, or other hydroxymercaptanes, aminomercaptans, or carboxyl-containing mercaptanes) and optionally other vinylic monomers are copolymerized (thermally or actinically) in the absence of any reactive vinylic monomer.

Copolymers comprising a non-reactive hydrophilic vinylic monomer and a reactive vinylic monomer (e.g., a carboxyl-containing vinylic monomer, a primary amino group-containing vinylic monomer or a secondary amino group-containing vinylic monomer) can be prepared according to any well-known radical polymerization methods or obtained from commercial suppliers. Copolymers containing methacryloyloxyethyl phosphorylcholine and carboxyl-containing vinylic monomer (or amino-containing vinylic monomer) can be obtained from NOP Corporation (e.g., LIPIDURE®-AC01, and AE).

The weight average molecular weight Mw of the hydrophilic polymer having at least one amino, carboxyl or thiol group (as a hydrophilicity-enhancing agent) is preferably from about 500 to about 2,000,000, more preferably from about 1,000 to about 500,000, even more preferably from about 5,000 to about 250,000 Daltons.

Water-soluble and thermally-crosslinkable hydrophilic polymeric materials can be prepared according to the processes disclosed in U.S. Pat. Nos. 8,529,057, 9,422,447, 9,720,138, and 11256003.

In a preferred embodiment, a water-soluble thermally-crosslinkable polymeric material can be obtained by heating an aqueous reactive solution, which comprises at least one azetidinium-containing polymer and at least one hydrophilicity-enhancing agent (i.e., a wetting agent) having at least one reactive functional group selected from the group consisting of amino group, carboxyl group, thiol group, and a combination thereof, to a temperature of from about 35° C. to about 85° C. and maintaining the temperature for a period of time sufficient (about 8 hours or less, preferably about 5 hours, more preferably from about 2 hour to about 4 hours). The aqueous reactive solution preferably comprises from about 70 mM to about 170 mM (preferably about 90 mM to about 150 mM, more preferably from about 100 mM to about 130 mM) of one or more ionic compounds and a pH of at least 8.0 (preferably at least 8.5, more preferably at least 9.0, even more preferably at least 9.5). It should be understood that the reaction time should be long enough to covalently attach the hydrophilicity-enhancing agent onto the polymer chain of the azetidinium-containing polymer, but should be short enough not to consume all the azetidinium groups of the azetidinium-containing polymer and not to form a gel (i.e., not water-soluble) due to the too many crosslinkages formed between the azetidinium-containing polymer and the hydrophilicity-enhancing agent. A resultant polymeric material is a lightly-crosslinked polymeric material which has a highly-branched structure and still comprises thermally-crosslinkable azetidinium groups.

A person skilled in the art understands well how to adjust the pH of the reactive mixture, e.g., by adding a base (e.g., NaOH, KOH, NH₄OH, or mixture thereof) or an acid (e.g., HCl, H₂SO₄, H₃PO₄, citric acid, acetic acid, boric acid, or mixture thereof).

In accordance with the invention, any ionic compounds can be used in the reactive mixture. Preferably, ionic compounds are those used as ionic tonicity-adjusting agents and ionic buffering agents used in an ophthalmic solutions. Examples of preferred ionic tonicity-adjusting agents includes without limitation sodium chloride, potassium chloride, and combinations thereof. Examples of preferred ionic buffering agents includes various salts of phosphoric acid (e.g. NaH₂PO₄, Na₂HPO₄, Na₃PO₄, KH₂PO₄, K₂HPO₄, K₃PO₄, or mixtures thereof), various salts of boric acid (e.g., sodium borate, potassium borate, or mixture thereof), various salts of citric acid (e.g., monosodium citrate, disodium citrate, trisodium citrate, monopotassium citrate, dipotassium citrate, tripotassium citrate, or mixtures thereof), various salts of carbonic acid (e.g., Na₂CO₃, NaHCO₃, K₂CO₃, KHCO₃, or mixture thereof).

The aqueous reactive solution for preparing a water-soluble thermally-crosslinkable polymeric material can be prepared by dissolving a desired amount of an azetidinium-containing polymer, a desired amount of a hydrophilicity-enhancing agent with at least one reactive functional group, and desired amounts of other components (e.g., ionic buffering agents, ionic tonicity-adjusting agents, etc.) in water (or a mixture of water and a minority amount of a water-soluble organic solvent) to form an aqueous solution and then adjusting the pH of the aqueous solution if necessary.

In accordance with the invention, the concentration ratio of a hydrophilicity-enhancing agent relative to an azetidinium-containing polymer in the aqueous reactive solution must be selected not to render a resultant water-soluble thermally-crosslinkable polymeric material water-insoluble (i.e., a solubility of less than 0.005 g per 100 ml of water at room temperature) and not to consume more than about 99%, preferably about 98%, more preferably about 97%, even more preferably about 96% of the azetidinium groups of the azetidinium-containing polymer.

In a preferred embodiment, the aqueous reactive solution comprises from 0.01% to about 10% by weight (preferably from 0.05% to about 5% by weight, more preferably from 0.08% to about 1% by weight, even more preferably from 0.1% to about 0.4% by weight) of an azetidinium-containing polymer and from about 0.01% to about 10% by weight (preferably from 0.02% to about 5% by weight, more preferably from 0.05% to about 2% by weight, even more preferably from 0.08% to about 1.0% by weight) of a hydrophilicity-enhancing agent having at least one reactive function group (carboxyl, primary amino, secondary amino group), the concentration ratio of the azetidinium-containing polymer to the hydrophilicity-enhancing agent is from about 1000:1 to 1:1000 (preferably from about 500:1 to about 1:500, more preferably from about 250:1 to about 1:250, even more preferably from about 100:1 to about 1:100).

In a preferred embodiment, the water-soluble thermally-crosslinkable polymeric material comprises (i) from about 20% to about 95% by weight of first polymer chains derived from a polyamidoamine-epichlorohydrin or a poly(2-oxazoline-co-ethyleneimine)-epichlorohydrin, (ii) from about 5% to about 80% by weight of hydrophilic moieties or second polymer chains derived from at least one hydrophilicity-enhancing agent having at least one reactive functional group selected from the group consisting of amino group, carboxyl group, thiol group, and combination thereof (preferably carboxyl or thiol groups), wherein the hydrophilic moieties or second polymer chains are covalently attached to the first polymer chains through one or more covalent linkages each formed between one azetidinium group of the polyamidoamine-epichlorohydrin or the poly(2-oxazoline-co-ethyleneimine)-epichlorohydrin and one amino, carboxyl or thiol group of the hydrophilicity-enhancing agent, and (iii) azetidinium groups which are parts of the first polymer chains or pendant or terminal groups covalently attached to the first polymer chains. The composition of a chemically-modified poly(2-oxazoline-co-ethyleneimine)-epichlorohydrin or a chemically-modified polyamidoamine-epichlorohydrin is determined by the composition (based on the total weight of the reactants) of a reactant mixture used for such a polymer according to the crosslinking reactions shown in Scheme I above. For example, if a reactant mixture comprises about 75% by weight of a polyamidoamine-epichlorohydrin and about 25% by weight of at least one hydrophilicity-enhancing agent based on the total weight of the reactants, then the resultant chemically-modified polyamidoamine-epichlorohydrin comprises about 75% by weight of first polymer chains derived from the polyamidoamine-epichlorohydrin and about 25% by weight of hydrophilic moieties or second polymer chains derived from said at least one hydrophilicity-enhancing agent.

In accordance with the invention, the step of heating is performed preferably by autoclaving the preformed contact lens (obtained in step (2)) immersed in a packaging solution (i.e., a buffered aqueous solution) in a sealed lens package at a temperature of from about 115° C. to about 125° C. for approximately 20-90 minutes. In accordance with this embodiment of the invention, the packaging solution is a buffered aqueous solution which is ophthalmically safe after autoclave.

Lens packages (or containers) are well known to a person skilled in the art for autoclaving and storing a soft contact lens. Any lens packages can be used in the invention. Preferably, a lens package is a blister package which comprises a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes under pressure) prior to dispensing to users. A person skilled in the art will understand well how to seal and sterilize lens packages.

In accordance with the invention, a packaging solution contains at least one buffering agent and one or more other ingredients known to a person skilled in the art. Examples of other ingredients include without limitation, tonicity agents, surfactants, antibacterial agents, preservatives, and lubricants (e.g., cellulose derivatives, polyvinyl alcohol, polyvinyl pyrrolidone).

The packaging solution contains a buffering agent in an amount sufficient to maintain a pH of the packaging solution in the desired range, for example, preferably from about 6.8 to about 8.5, more preferably from about 7.0 to 8.2, even more preferably from about 7.2 to about 8.0. It is found that a higher pH is desirable for ensuring that all or a significant portion of the carboxyl groups of the lens bulk material are ionized. As a result, the resultant coated contact lenses become dimensionally stable in the packaging solution during autoclave and storage and can have improved lubricity.

Any known, physiologically compatible buffering agents can be used. Suitable buffering agents as a constituent of the contact lens care composition according to the invention are known to a person skilled in the art. Preferably, a phosphate buffer (consisting essentially of a mixture of a monobasic dihydrogen phosphate (e.g., NaH₂PO₄, KH₂PO₄, or mixtures thereof) and dibasic monohydrogen phosphate (e.g., Na₂HPO₄, K₂HPO₄, or mixtures thereof) are used for maintaining the pH of the packaging solution. In various preferred embodiments, the total concentration of the monobasic dihydrogen phosphate and the dibasic monohydrogen phosphate is at least 30 mM (preferably at least 35 mM, more preferably at least 40 mM, even more preferably at least 45 mM).

The solutions according to the invention are preferably formulated in such a way that they are isotonic with the lachrymal fluid. A solution which is isotonic with the lachrymal fluid is generally understood to be a solution whose concentration corresponds to the concentration of a 0.9% sodium chloride solution (308 mOsm/kg). Deviations from this concentration are possible throughout.

The isotonicity with the lachrymal fluid, or even another desired tonicity, may be adjusted by adding organic or inorganic substances that affect the tonicity. Suitable occularly acceptable tonicity agents include, but are not limited to sodium chloride, potassium chloride, glycerol, propylene glycol, polyols, mannitols, sorbitol, xylitol and mixtures thereof. The tonicity of the packaging solution is typically adjusted to be from about 200 to about 450 milliosmol (mOsm), preferably from about 250 to 350 mOsm.

In a preferred embodiment, one or more organic tonicity agents (e.g., glycerol, propylene glycol, polyethylene glycol having a number average molecular weigh of from 200 to 800 daltons), mannitols, sorbitol, xylitol, and mixtures thereof) are is present in an amount of at least 70 mM (preferably at least 90 mM, more preferably at least 110 mM, even more preferably at least 130 mM) for adjusting the tonicity of the packaging solution. It is found that the resultant coated contact lenses can have improved lubricity when the ionic strength of the packaging solution is lowered (e.g., by replacing a portion of NaCl with an organic tonicity agent, e.g., propylene glycol).

In a preferred embodiment, the packaging solution comprises preferably from about 0.01% to about 2%, more preferably from about 0.05% to about 1.5%, even more preferably from about 0.1% to about 1%, most preferably from about 0.2% to about 0.5%, by weight of a water-soluble thermally-crosslinkable hydrophilic polymeric material having azetidinium groups.

In another aspect, the present invention provides a method for producing coated contact lenses, comprising the steps of: (1) obtaining a female mold half and a male mold half, wherein the female mold half has a first molding surface defining the anterior surface of a contact lens to be molded, wherein the male mold half has a second molding surface defining the posterior surface of the contact lens to be molded, wherein the male mold half and the female mold half are configured to receive each other such that a lens-molding cavity is formed between the first and second molding surfaces when the female mold half is closed with the male mold half; (2) applying a hydrogel-forming composition to multiple zones on the first molding surface, wherein the hydrogel-forming composition comprises at least one crosslinkable polymer having hydroxyl groups and/or ethylenically unsaturated groups and optionally at least one hydrophobic vinylic monomer selected from the group consisting of methoxyethyl (meth)acrylate, ethoxyethyl (meth)acrylate, methyl (meth)acrylate, and combination thereof, wherein if said at least one crosslinkable polymer is free of any ethylenical unsaturated group, the hydrogel-forming composition comprises additionally at least one hydroxyl-containing vinylic monomer and at least one compound having two or more isocyanato groups, wherein all polymerizable components in the hydrogel-forming composition are free of reactive functional groups selected from the group consisting of a carboxylic acid group, a primary amino group, a secondary amino group, an azetidinium group, an epoxy group, and combinations thereof; (3) optionally but preferably, curing partially the hydrogel-forming composition on the first molding surface; (4) introducing a polymerizable composition into the female mold half obtained in step (2) or (3), wherein the polymerizable composition comprises from about 1.0% to about 10% by weight of at least one reactive vinylic monomer having at least one first reactive functional group selected from the group consisting of a carboxylic acid group, a primary amino group, a secondary amino group, and combinations thereon, relative to the total amount of all polymerizable components; (5) closing the female mold half obtained in step (4) with the male mold half to form a molding assemble including the polymerizable composition within the lens-forming cavity; (6) curing thermally or actinically the polymerizable composition in the molding assembly to form a contact lens precursor having a convex surface and an opposite concave surface and comprising a lens bulk material having first reactive functional groups, wherein the convex surface of the contact lens precursor is partially covered with a second hydrogel material formed from the hydrogel-forming composition in the multiple zones on the convex surface so as to prevent the first reactive functional groups behind the multiple zones from reacting with thermally-crosslinkable groups which are azetidinium groups and/or epoxy groups at a temperature from about 60° C. to about 140° C., wherein the second non-silicone hydrogel material is free of any first reactive functional groups and thermally-crosslinkable groups; (7) optionally hydrating the contact lens precursor obtained in step (6) in water or an aqueous solution to obtain a hydrated contact lens precursor; and (8) heating the contact lens precursor obtained in step (6) or the hydrated contact lens precursor obtained in step (7) directly in an aqueous solution having a pH from about 6.5 to about 9.5 and including at least one water-soluble, thermally-crosslinkable hydrophilic polymeric material at a temperature from about 60° C. to about 140° C. to graft a first non-silicone hydrogel material onto each of the convex and concave surfaces of the contact lens precursor obtained in step (6) or the hydrated contact lens precursor obtained in step (7) to form a coated contact lens that has an anterior surface, an opposite posterior surface, an anterior outer hydrogel layer, and a posterior outer hydrogel layer, wherein said at least one water-soluble, thermally-crosslinkable hydrophilic polymeric material comprises second reactive functional groups and third reactive functional groups, wherein the second reactive functional groups are thermally-crosslinkable groups selected from the group consisting of azetidinium groups, epoxy groups, and combinations thereof, wherein each of the second reactive functional group is capable of reacting with one first or third reactive functional group to form a crosslinkage, wherein the third reactive functional groups are selected from the group consisting of carboxylic acid groups, primary amino groups, secondary amino groups, thiol groups, and combinations thereof, wherein the posterior outer hydrogel layer is a layer of the first non-silicone hydrogel material, wherein the anterior outer hydrogel layer is a layer of the first non-silicone hydrogel material with imperfections (e.g., ditches and/or gaps) distributed therein so that the posterior surface of the coated contact lens has a surface lubricity higher than the surface lubricity of the anterior surface, wherein the coated contact lens has a water-break-up time of at least about 10 seconds as measured on the anterior and posterior surfaces of the coated contact lens.

The various embodiments including preferred embodiments of mold halves, hydrogel-forming compositions, the techniques for applying a hydrogel-forming composition onto a molding surface of a female mold half, the shapes, sizes, and distributions thereof of the multiple zone on the molding surface of a female mold half (instead of on the convex surface of a preformed contact lens as described above), curing a hydrogel-forming composition or a polymerizable composition, polymerizable compositions, water-soluble, thermally-crosslinkable hydrophilic polymeric materials, step of heating for forming a coated contact lens have been described above and can be used in this aspect of the invention.

In a further aspect, the present invention provides a coated contact lens comprising: an anterior surface and an opposite posterior surface; and a layered structural configuration which comprises, in a direction from the anterior surface to the posterior surface, an anterior outer hydrogel layer, an inner layer, and a posterior outer hydrogel layer, wherein the inner layer is made of a lens bulk material, wherein the posterior outer hydrogel layer is a layer of a first non-silicone hydrogel material, wherein the anterior outer hydrogel layer is a layer of the first non-silicone hydrogel material with imperfections (e.g., ditches and/or gaps) distributed therein so that the posterior outer hydrogel layer has a surface lubricity higher than the surface lubricity of the anterior outer hydrogel layer, wherein the coated contact lens in fully-hydrated state has a water content of from about 10% to about 70% by weight or less, an oxygen permeability of at least about 50 barrers, and a water-break-up time of at least about 10 seconds as measured on the anterior and posterior surfaces of the coated contact lens.

The various embodiments including preferred embodiments of lens bulk materials have been described above and can be incorporated in this aspect of the invention.

In various preferred embodiments, the first non-silicone hydrogel material (making up the anterior and posterior outer hydrogel layers) is:

(1) a crosslinked polymeric material which comprises at least 25% by mole (preferably at least 35% by mole, more preferably at least 45% by mole, even more preferably at least 55% by mole) of repeating monomeric units of at least one hydrophilic vinylic monomer selected from the group consisting of (meth)acrylamide, N,N-dimethyl (meth)acrylamide, N-ethyl (meth)acrylamide, N,N-diethyl(meth)acrylamide, N-propyl (meth)acrylamide, N-isopropyl (meth)acrylamide, N-3-methoxypropyl (meth)acrylamide), N-2-dimethylaminoethyl (meth)acrylamide, dimethylaminoethyl (meth)acrylate, N-2-hydroxylethyl (meth)acrylamide, N,N-bis(hydroxyethyl)(meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol)(meth)acrylate, tri(ethylene glycol)(meth)acrylate, tetra(ethylene glycol)(meth)acrylate, poly(ethylene glycol)(meth)acrylate having a number average molecular weight of up to 1500, poly(ethylene glycol)ethyl (meth)acrylamide having a number average molecular weight of up to 1500, N-vinyl pyrrolidone, N-vinyl-N-methyl acetamide, N-vinyl formamide, N-vinyl acetamide, N-vinyl isopropylamide, N-vinyl-N-ethyl acetamide, N-vinyl-N-ethyl formamide, 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, ethylene glycol methyl ether(meth)acrylate, di(ethylene glycol)methyl ether(meth)acrylate, tri(ethylene glycol)methyl ether(meth)acrylate, tetra(ethylene glycol)methyl ether(meth)acrylate, C₁-C₄-alkoxy poly(ethylene glycol)(meth)acrylate having a weight average molecular weight of up to 1500, methoxy-poly(ethylene glycol)ethyl (meth)acrylamide having a number average molecular weight of up to 1500, allyl alcohol, ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol)methyl allyl ether, tri(ethylene glycol)methyl allyl ether, tetra(ethylene glycol)methyl allyl ether, poly(ethylene glycol)methyl allyl ether, ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol)methyl vinyl ether, tri(ethylene glycol)methyl vinyl ether, tetra(ethylene glycol)methyl vinyl ether, poly(ethylene glycol)methyl vinyl ether, and combinations thereof (preferably selected from the group consisting of (meth)acrylamide, dimethyl (meth)acrylamide, N-2-hydroxylethyl (meth)acrylamide, N,N-bis(hydroxyethyl)(meth)acrylamide, N-2,3-dihydroxypropyl (meth)acrylamide, N-tris(hydroxymethyl)methyl (meth)acrylamide, N-2-dimethylaminoethyl (meth)acrylamide, dimethylaminoethyl (meth)acrylate, 2-hydroxyethyl (meth)acrylate, glycerol methacrylate (GMA), tetra(ethylene glycol)(meth)acrylate, poly(ethylene glycol)ethyl (meth)acrylamide having a number average molecular weight of up to 1500, poly(ethylene glycol)(meth)acrylate having a number average molecular weight of up to 1500, N-vinylpyrrolidone, N-vinyl-N-methyl acetamide, N-vinyl formamide, N-vinyl acetamide, 1-methyl-3-methylene-2-pyrrolidone, 1-methyl-5-methylene-2-pyrrolidone, 5-methyl-3-methylene-2-pyrrolidone, tetra(ethylene glycol)methyl ether(meth)acrylate, methoxypoly(ethylene glycol)ethyl (meth)acrylamide having a number average molecular weight of up to 1500, C₁-C₄-alkoxy polyethylene glycol (meth)acrylate having a weight average molecular weight of up to 1500, tetra(ethylene glycol) monovinyl ether, poly(ethylene glycol) monovinyl ether, tetra(ethylene glycol)methyl vinyl ether, poly(ethylene glycol)methyl vinyl ether, tetra(ethylene glycol) monoallyl ether, poly(ethylene glycol) monoallyl ether, tetra(ethylene glycol)methyl allyl ether, poly(ethylene glycol)methyl allyl ether, vinyl alcohol, allyl alcohol, and combinations thereof, more preferably selected from the group consisting of (meth)acrylamide, dimethyl (meth)acrylamide, N-2-hydroxylethyl (meth)acrylamide, N,N-bis(hydroxyethyl)(meth)acrylamide, N-2,3-dihydroxypropyl (meth)acrylamide, N-tris(hydroxymethyl)methyl (meth)acrylamide, 2-hydroxyethyl (meth)acrylate, glycerol methacrylate (GMA), poly(ethylene glycol)ethyl (meth)acrylamide having a number average molecular weight of up to 1500, poly(ethylene glycol)(meth)acrylate having a number average molecular weight of up to 1500, N-vinylpyrrolidone, N-vinyl-N-methyl acetamide, methoxypoly(ethylene glycol)ethyl (meth)acrylamide having a number average molecular weight of up to 1500, methoxy polyethylene glycol (meth)acrylate having a weight average molecular weight of up to 1500, poly(ethylene glycol) monovinyl ether, poly(ethylene glycol)methyl vinyl ether, poly(ethylene glycol) monoallyl ether, poly(ethylene glycol)methyl allyl ether, vinyl alcohol, allyl alcohol, and combinations thereof, even more preferably selected from the group consisting of (meth)acrylamide, dimethyl (meth)acrylamide, N-2-hydroxylethyl (meth)acrylamide, N,N-bis(hydroxyethyl)(meth)acrylamide, N-2,3-dihydroxypropyl (meth)acrylamide, N-tris(hydroxymethyl)methyl (meth)acrylamide, poly(ethylene glycol)ethyl (meth)acrylamide having a number average molecular weight of up to 1500, poly(ethylene glycol)(meth)acrylate having a number average molecular weight of up to 1500, N-vinylpyrrolidone, N-vinyl-N-methyl acetamide, methoxypoly(ethylene glycol)ethyl (meth)acrylamide having a number average molecular weight of up to 1500, methoxy polyethylene glycol (meth)acrylate having a weight average molecular weight of up to 1500, and combinations thereof;

(2) a crosslinked polymeric material which comprises at least 25% by mole (preferably at least 35% by mole, more preferably at least 45% by mole, even more preferably at least 55% by mole) of repeating monomeric units of at least one phosphorylcholine-containing vinylic monomer (any one described below), preferably selected from the group consisting of (meth)acryloyloxyethyl phosphorylcholine, (meth)acryloyloxypropyl phosphorylcholine, 4-((meth)acryloyloxy)butyl-2′. (trimethylammonio)ethylphosphate, 2-[(meth)acryloylamino]ethyl-2′-(trimethylammonio)ethylphosphate, 3-[(meth)acryloylamino]propyl-2′-(trimethylammonio)-ethylphosphate, 4-[(meth)acryloylamino]butyl-2′-(trimethylammonio)ethylphosphate, and combinations thereof;

(3) a crosslinked polymeric material which comprises poly(ethylene glycol) chains, preferably derived directly from (a) a pol(ethylene glycol) having one sole functional group of —NH₂, —SH or —COOH, (b) a pol(ethylene glycol) having two terminal functional groups selected from the group consisting of —NH₂, —COOH, —SH, and combinations thereof, (c) a multi-arm poly(ethylene glycol) having one or more functional groups selected from the group consisting of —NH₂, —COOH, —SH, and combinations thereof, and (d) combinations thereof.

Examples of preferred phosphorylcholine-containing vinylic monomers include without limitation (meth)acryloyloxyethyl phosphorylcholine (aka, MPC, or 2-((meth)acryloyloxy)ethyl-2′-(trimethylammonio)ethylphosphate), (meth)acryloyloxypropyl phosphorylcholine (aka, 3-((meth)acryloyloxy)propyl-2′-(trimethylammonio)ethylphosphate), 4-((meth)acryloyloxy)butyl-2′-(trimethylammonio)ethylphosphate, 2-[(meth)acryloylamino]ethyl-2′-(trimethylammonio)-ethylphosphate, 3-[(meth)acryloylamino]propyl-2′-(trimethylammonio)ethylphosphate, 4-[(meth)acryloylamino]butyl-2′-(trimethylammonio)ethylphosphate, 5-((meth)acryloyloxy)pentyl-2′-(trimethylammonio)ethyl phosphate, 6-((meth)acryloyloxy)hexyl-2′ (trimethylammonio)-ethylphosphate, 2-((meth)acryloyloxy)ethyl-2′-(triethylammonio)ethylphosphate, 2-((meth)acryloyloxy)ethyl-2′-(tripropylammonio)ethylphosphate, 2-((meth)acryloyloxy)ethyl-2′-(tributylammonio)ethyl phosphate, 2-((meth)acryloyloxy)propyl-2′-(trimethylammonio)-ethylphosphate, 2-((meth)acryloyloxy)butyl-2′-(trimethylammonio)ethylphosphate, 2-((meth)acryloyloxy)pentyl-2′-(trimethylammonio)ethylphosphate, 2-((meth)acryloyloxy)hexyl-2′-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)-ethylphosphate. 2-(vinylcarbonylamino)ethyl-2′-(trimethylammonio)ethylphosphate, 2-(allyloxycarbonylamino)ethyl-2′-(trimethylammonio)ethyl phosphate, 2-(butenoyloxy)ethyl-2′-(trimethylammonio)ethylphosphate, and combinations thereof.

In various preferred embodiments, the imperfections in the anterior outer hydrogel layer comprise: (1) ditches in a ring shape, a curved line shape, and/or a straight line shape; (2) gaps in a circular shape, a triangular shape, a square shape, a rectangular shape, a hexagonal shape, a polygonal shape, and/or a star shape; or (3) combinations thereof. It is understood that the shapes of the imperfections appear in top view.

The imperfections can have any 2-dimensional size in top view. Preferably, one of the two dimensions of the imperfections is about 0.40 mm or less (preferably about 0.30 mm or less, more preferably about 0.25 mm or less, even more preferably from about 0.05 mm to about 0.20 mm).

In accordance with one embodiment of the invention, the imperfections are arranged in any pattern, preferably in rotationally symmetric pattern with respect to the central axis of the coated contact lens, on the anterior surface of the coated contact lens. Preferably, the imperfections are located in an annular zone having an inner diameter of from about 6.0 mm to about 9.0 mm and an outer diameter of from about 11.5 mm to about 14.5 mm and being concentric with respect to the central axis of the coated contact lens.

In one embodiment, the imperfections comprise at least three ditches in ring-shape. In another embodiment, the imperfections comprise at least eight ditches in curved-line shape or shape of straight lines radiating outward from a circle having a diameter of from about 6.0 mm to about 9.0 mm and being concentric with respect to the central axis of the coated contact lens.

In another embodiment, the imperfections comprise gaps in circular shape (preferably having a diameter of about 0.25 mm or less, more preferably having a diameter of from about 0.05 mm to about 0.20 mm) which are arranged in a rotationally symmetric pattern on the anterior surface of the coated contact lens. Preferably, the gaps in circular shape are arranged in a pattern of annular rings concentric with the central axis of the coated contact lens.

In accordance with the invention, the surface lubricities of the anterior and posterior outer hydrogel layers can be preferably evaluated by using a finger-felt lubricity test which characterizes qualitatively the slipperiness of a lens surface on a friction rating scale of from 0 to 4. The higher the friction rating is, the lower the slipperiness (or surface lubricity). The procedures for performing finger-felt lubricity test are described in Example 1.

In various preferred embodiments, the anterior surface of the coated contact lens has a friction rating which is at least 0.25 (preferably at least 0.50, more preferably at least 0.75) larger than the friction rating of the posterior surface.

Preferably, a coated contact lens of the invention in fully-hydrated state has a water-break-up time of at least about 15 seconds (preferably at least about 20 seconds, more preferably at least about 25 seconds, even more preferably at least about 30 seconds) as measured on the anterior and posterior surfaces of the coated contact lens.

It is understood that a water-break-up time of a coated contact lens of the invention is measured on the anterior surface and/or the posterior surface according to the procedures described in Example 1.

In various preferred embodiments, a coated contact lens of the invention in fully-hydrated state further has: a water content of from about 20% to about 70% (preferably from about 25% to about 65%, more preferably from about 30% to about 60%) by weight, an elastic modulus of from about 0.2 MPa to about 2.0 MPa (preferably from about 0.25 MPa to about 1.5 MPa, more preferably from about 0.3 MPa to about 1.2 MPa, even more preferably from about 0.35 MPa to about 1.0 MPa), an oxygen transmissibility of at least 60 barrers/mm (preferably at least 70 barrers/mm, more preferably at least 80 barrers/mm, even more preferably at least 100 barrers/mm), an averaged water contact angle of less than 90 degrees (preferably less than 80 degrees, more preferably less than 70 degrees, even more preferably less than 60 degrees), or combinations thereof.

Although various embodiments of the invention have been described using specific terms, devices, and methods, such description is for illustrative purposes only. The words used are words of description rather than of limitation. As would be obvious to one skilled in the art, many variations and modifications of the invention may be made by those skilled in the art without departing from the spirit and scope of the novel concepts of the disclosure. In addition, it should be understood that aspects of the various embodiments of the invention may be interchanged either in whole or in part or can be combined in any manner and/or used together, as illustrated below:
1. A coated contact lens comprising:
   an anterior surface and an opposite posterior surface; and
   a layered structural configuration which comprises, in a direction from the anterior surface to the posterior surface, an anterior outer hydrogel layer, an inner layer, and a posterior outer hydrogel layer,
   wherein the inner layer is made of a lens bulk material, wherein the posterior outer hydrogel layer is a layer of a first non-silicone hydrogel material, wherein the anterior outer hydrogel layer is a layer of the first non-silicone hydrogel material with imperfections (e.g., ditches, gaps, etc.) distributed therein so that the posterior outer hydrogel layer has a surface lubricity higher than the surface lubricity of the anterior outer hydrogel layer, wherein the coated contact lens in fully-hydrated state has a water-break-up time of at least about 10 seconds as measured on the anterior and posterior surfaces of the coated contact lens.
2. A method for producing coated contact lenses, comprising the steps of:
   (1) obtaining a preformed contact lens having a convex surface and an opposite concave surface, wherein the preformed contact lens is composed of a lens bulk material and comprises first reactive functional groups on and near the convex and concave surfaces of the preformed contact lens, wherein each of the first reactive functional groups is capable of reacting with a thermally-crosslinkable group at a temperature from about 60° C. to about 140° C. and are selected from the group consisting of carboxylic acid groups, primary amino groups, secondary amino groups, thiol groups, and combinations thereof;
   (2) covering multiple zones on the convex surface with a second non-silicone hydrogel material to prevent first reactive functional groups behind the multiple zones from reacting with thermally-crosslinkable groups, wherein the second non-silicone hydrogel material is free of any first reactive functional group and free of any thermally-crosslinkable group;
   (3) heating the preformed contact lens obtained in step (2) directly in an aqueous solution having a pH from about 6.5 to about 9.5 and including at least one water-soluble, thermally-crosslinkable hydrophilic polymeric material at a temperature from about 60° C. to about 140° C. to graft a first non-silicone hydrogel material onto each of the anterior and posterior surfaces of the preformed contact lens obtained in step (2) to form a coated contact lens that has an anterior surface, an opposite posterior surface, an anterior outer hydrogel layer, and a posterior outer hydrogel layer, wherein said at least one water-soluble, thermally-crosslinkable hydrophilic polymeric material comprises second reactive functional groups and third reactive functional groups, wherein the second reactive functional groups are thermally-crosslinkable groups selected from the group consisting of azetidinium groups, epoxy groups, and combinations thereof, wherein each of the second reactive functional group is capable of reacting with one first or third reactive functional group to form a crosslinkage, wherein the third reactive functional groups are selected from the group consisting of carboxylic acid groups, primary amino groups, secondary amino groups, thiol groups, and combinations thereof, wherein the first non-silicone hydrogel material is a crosslinked product of said at least one thermally-crosslinkable hydrophilic polymeric material, wherein the posterior outer hydrogel layer is a layer of the first non-silicone hydrogel material, wherein the anterior outer hydrogel layer is a layer of the first non-silicone hydrogel material with imperfections (ditches and/or gaps) distributed therein so that the posterior surface of the coated contact lens has a surface lubricity higher than the surface lubricity of the anterior surface,
wherein the coated contact lens in fully-hydrated state has a water-break-up time of at least about 10 seconds as measured on the anterior and posterior surfaces of the coated contact lens.
3. The method of embodiment 2, wherein the step (2) is performed by applying a hydrogel-forming composition onto multiple zones on the convex surface of the preformed contact lens (preferably according to pad-transfer printing and/or inkjet printing techniques), and then curing thermally or actinically the hydrogel-forming composition to form the second non-silicone hydrogel material to cover the multiple zones.

4. A method for producing coated contact lenses, comprising the steps of:
(1) obtaining a female mold half and a male mold half, wherein the female mold half has a first molding surface defining the anterior surface of a contact lens to be molded, wherein the male mold half has a second molding surface defining the posterior surface of the contact lens to be molded, wherein the male mold half and the female mold half are configured to receive each other such that a lens-molding cavity is formed between the first and second molding surfaces when the female mold half is closed with the male mold half;
(2) applying a hydrogel-forming composition to multiple zones on the first molding surface, wherein the hydrogel-forming composition comprises at least one crosslinkable polymer having hydroxyl groups and/or ethylenically unsaturated groups and optionally at least one hydrophobic vinylic monomer selected from the group consisting of methoxyethyl (meth)acrylate, ethoxyethyl (meth)acrylate, methyl (meth)acrylate, and combination thereof, wherein if said at least one crosslinkable polymer is free of any ethylenical unsaturated group, the hydrogel-forming composition comprises additionally at least one hydroxyl-containing vinylic monomer and at least one compound having two or more isocyanato groups, wherein all polymerizable components in the hydrogel-forming composition are free of reactive functional groups selected from the group consisting of a carboxylic acid group, a primary amino group, a secondary amino group, an azetidinium group, an epoxy group, and combinations thereof;
(3) optionally but preferably, curing partially the hydrogel-forming composition on the first molding surface;
(4) introducing a polymerizable composition into the female mold half obtained in step (2) or (3), wherein the polymerizable composition comprises from about 1.0% to about 10% by weight of at least one reactive vinylic monomer having at least one first reactive functional group selected from the group consisting of a carboxylic acid group, a primary amino group, a secondary amino group, and combinations thereon, relative to the total amount of all polymerizable components;
(5) closing the female mold half obtained in step (4) with the male mold half to form a molding assemble including the polymerizable composition within the lens-forming cavity;
(6) curing thermally or actinically the polymerizable composition in the molding assembly to form a contact lens precursor having a convex surface and an opposite concave surface and comprising a lens bulk material having first reactive functional groups, wherein the convex surface of the contact lens precursor is partially covered with a second non-silicone hydrogel material formed from the hydrogel-forming composition in the multiple zones on the convex surface so as to prevent the first reactive functional groups behind the multiple zones from reacting with thermally-crosslinkable groups which are azetidinium groups and/or epoxy groups at a temperature from about 60° C. to about 140° C., wherein the second non-silicone hydrogel material is free of any first reactive functional groups and thermally-crosslinkable groups;
(7) optionally hydrating the contact lens precursor obtained in step (6) in water or an aqueous solution; and
(8) heating the contact lens precursor obtained in step (6) or step (7) directly in an aqueous solution having a pH from about 6.5 to about 9.5 and including at least one water-soluble, thermally-crosslinkable hydrophilic polymeric material at a temperature from about 60° C. to about 140° C. to graft a first non-silicone hydrogel material onto each of the convex and concave surfaces of the contact lens precursor obtained in step (6) or the hydrated contact lens precursor obtained in step (7) to form a coated contact lens that has an anterior surface, an opposite posterior surface, an anterior outer hydrogel layer, and a posterior outer hydrogel layer, wherein said at least one water-soluble, thermally-crosslinkable hydrophilic polymeric material comprises second reactive functional groups and third reactive functional groups, wherein the second reactive functional groups are thermally-crosslinkable groups selected from the group consisting of azetidinium groups, epoxy groups, and combinations thereof, wherein each of the second reactive functional group is capable of reacting with one first or third reactive functional group to form a crosslinkage, wherein the third reactive functional groups are selected from the group consisting of carboxylic acid groups, primary amino groups, secondary amino groups, thiol groups, and combinations thereof, wherein the first non-silicone hydrogel material is a crosslinked product of said at least one thermally-crosslinkable hydrophilic polymeric material, wherein the posterior outer hydrogel layer is a layer of the first non-silicone hydrogel material, wherein the anterior outer hydrogel layer is a layer of the first non-silicone hydrogel material with imperfections (ditches and/or gaps) distributed therein so that the posterior surface of the coated contact lens has a surface lubricity higher than the surface lubricity of the anterior surface,
wherein the coated contact lens has a water-break-up time of at least about 10 seconds as measured on the anterior and posterior surfaces of the coated contact lens.
5. The method of embodiment 4, wherein the polymerizable composition is a non-silicone hydrogel lens formulation that comprises from about 1.0% to about 10% (preferably from about 2.0% to about 7%, more preferably from about 2.0% to about 5%) by weight of at least one carboxyl-containing vinylic monomer and/or at least one amino-containing vinylic monomer.
6. The method of embodiment 5, wherein said at least one carboxyl-containing vinylic monomer is selected from the group consisting of acrylic acid, methacrylic acid, ethylacrylic acid, propylacrylic acid, (meth)acryloyloxyacetic acid, mono-2-[(meth)acryloyloxy]ethyl succinate, (meth)acryloyloxypropanoic acid, (meth)acryloyloxybutanoic acid, and combinations thereof, wherein said at least one amino-containing vinylic monomer is selected from the group consisting of N-2-aminoethyl (meth)acrylamide, N-2-methylaminoethyl (meth)acrylamide, N-2-ethylaminoethyl (meth)acrylamide, N-3-aminopropyl (meth)acrylamide, N-3-methylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-ethylaminopropyl (meth)acrylate, 3-amino-2-hydroxypropyl (meth)acrylate, and combinations thereof.
7. The method of any one of embodiments 3 to 6, wherein the hydrogel-forming composition comprises at least one crosslinkable polymer having hydroxyl groups and/or ethylenically unsaturated groups and optionally at least one hydrophobic vinylic monomer selected from the group consisting of methoxyethyl (meth)acrylate, ethoxyethyl (meth)acrylate, methyl (meth)acrylate, and combination thereof, wherein if said at least one crosslinkable polymer is free of any ethylenical unsaturated group, the hydrogel-forming composition comprises additionally at least one hydroxyl-containing vinylic monomer and at least one compound having two or more isocyanato groups, wherein all polymerizable components in the hydrogel-forming composition are free of any first reactive functional groups and any thermally-crosslinkable groups which are azetidinium groups and/or epoxy groups.
8. The method of any one of embodiments 2 to 7, wherein the step of heating is performed by autoclaving the preformed contact lens or the contact lens precursor immersed in a packaging solution (i.e., a buffered aqueous solution) in a sealed lens package at a temperature of from about 115° C. to about 125° C. for approximately 20-90 minutes.
9. The method of any one of embodiments 2 to 8, wherein said at least one water-soluble and thermally crosslinkable hydrophilic polymeric material comprises azetidinium groups, epoxy groups, or combinations thereof.
10. The method of embodiment 9, wherein said at least one water-soluble and thermally crosslinkable hydrophilic polymeric material is a three-dimensional network and thermally-crosslinkable groups within the network or being attached to the network.
11. The method of embodiment 9, wherein said at least one water-soluble and thermally crosslinkable hydrophilic polymeric material is: one or more multi-armed polyethylene glycols each having terminal epoxy groups; a mixture of a multi-armed polyethylene glycol having terminal epoxy group and one or more polyethylene glycol each having terminal functional groups selected from the group consisting of primary amine groups, secondary amine groups, carboxyl groups, thiol groups, and combinations thereof; a partial reaction product of a multi-armed polyethylene having terminal epoxy groups and a hydrophilicity-enhancing agent having at least one reactive functional group selected from the group consisting of amino group, carboxyl group, thiol group; or combinations thereof.
12. The method of embodiment 9, wherein said at least one water-soluble and thermally crosslinkable hydrophilic polymeric material comprises azetidinium groups and is a partial reaction product of an azetidinium-containing polymer and a hydrophilicity-enhancing agent having at least one reactive functional group selected from the group consisting of a primary amine group, a secondary amine group, a carboxyl group, a thiol group, and combinations thereof.
13. The method of embodiment 12, wherein the azetidinium-containing polymer is a poly(2-oxazoline-co-ethyleneimine)-epichlorohydrin copolymer, a polyamidoamine-epichlorohydrin, a copolymer of an azetidinium-containing vinylic monomer with one or more hydrophilic vinylic monomers, or combinations thereof.
14. The method of embodiment 12 or 13, wherein the hydrophilicity-enhancing agent is: a primary amino-, secondary amino-, carboxyl- or thiol-containing monosaccharide; a primary amino-, secondary amino-, carboxyl- or thiol-containing disaccharide; a primary amino-, secondary amino-, carboxyl- or thiol-containing oligosaccharide; or combinations thereof.
15. The method of embodiment 12 or 13, wherein the hydrophilicity-enhancing agent is a hydrophilic polymer having one or more primary or secondary amino groups, one or more carboxyl groups, one or more thiol groups, or combinations thereof.
16. The method of embodiment 15, wherein the hydrophilicity-enhancing agent is a polysaccharide having primary amine groups, secondary amine groups, carboxyl groups, or combinations thereof.
17. The method of embodiment 15, wherein the hydrophilicity-enhancing agent is:
   a poly(ethylene glycol) having one sole functional group of —NH₂, —SH or —COOH; a poly(ethylene glycol) having two terminal functional groups selected from the group consisting of —NH₂, —COOH, —SH, and combinations thereof;
   a multi-arm poly(ethylene glycol) having one or more functional groups selected from the group consisting of —NH₂, —COOH, —SH, and combinations thereof;
   a monoamino-, monocarboxyl-, diamino- or dicarboxyl-terminated homo- or copolymer of a non-reactive hydrophilic vinylic monomer;
   a copolymer which is a polymerization product of a composition comprising (1) from about 0.1% to about 30% (preferably from about 0.5% to about 20%, more preferably from about 1% to about 15%) of a reactive vinylic monomer and (2) at least one non-reactive hydrophilic vinylic monomer,
   wherein the reactive vinylic monomer is a vinylic monomer having a functional group selected from the group consisting of carboxyl group, a primary amine group, and a secondary amine group,
   wherein the non-reactive hydrophilic monomer is a hydrophilic vinylic monomer free of any free of any carboxyl group, primary amine group, secondary amine group, epoxide group, isocyanate group, azlactone group, or aziridine group.
18. The method of embodiment 17, wherein the reactive vinylic monomer is acrylic acid, methacrylic acid, ethylacrylic acid, 2-(meth)acrylamidoglycolic acid, N-2-aminoethyl (meth)acrylamide, N-2-methylaminoethyl (meth)acrylamide, N-2-ethylaminoethyl (meth)acrylamide, N-3-aminopropyl (meth)acrylamide, N-3-methylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-amino-2-hydroxypropyl (meth)acrylate, or a combination thereof.
19. The method of embodiments 17 or 18, wherein the non reactive hydrophilic vinylic monomer is selected from the group consisting of acryamide, N,N-dimethylacrylamide, N-vinylpyrrolidone, (meth)acryloyloxyethyl phosphorylcholine, N-vinyl-N-methyl acetamide, glycerol(meth)acrylate, hydroxyethyl (meth)acrylate, N-hydroxyethyl (meth)acrylamide, C₁-C₄-alkoxy polyethylene glycol (meth)acrylate having a weight average molecular weight of up to 400 Daltons, vinyl alcohol, and combination thereof, wherein the non-reactive hydrophilic vinylic monomer selected from the group consisting of selected from the group consisting of (meth)acryloyloxyethyl phosphorylcholine, (meth)acryloyloxypropyl phosphorylcholine, 4 ((meth)acryloyloxy)butyl-2′-(trimethylammonio)ethylphosphate, 2-[(meth)acryloylamino]ethyl-2′-(trimethylammonio)ethylphosphate. 3-[(meth)acryloylamino]propyl-2′-(trimethylammonio)ethylphosphate. 4-[(meth)acryloylamino]butyl-2′-(trimethylammonio)ethylphosphate. (meth)acrylamide, dimethyl (meth)acrylamide, N-2-hydroxylethyl (meth)acrylamide, N,N-bis(hydroxyethyl)(meth)acrylamide, N-2,3-dihydroxypropyl (meth)acrylamide, N-tris(hydroxymethyl)methyl (meth)acrylamide, 2-hydroxyethyl (meth)acrylate, glycerol methacrylate (GMA), tetra(ethylene glycol)(meth)acrylate, poly(ethylene glycol)ethyl (meth)acrylamide having a number average molecular weight of up to 1500, poly(ethylene glycol)(meth)acrylate having a number average molecular weight of up to 1500, N-vinylpyrrolidone, N-vinyl-N-methyl acetamide, N-vinyl formamide, N-vinyl acetamide, 1-methyl-3-methylene-2-pyrrolidone, 1-methyl-5-methylene-2-pyrrolidone, 5-methyl-3-methylene-2-pyrrolidone, tetra(ethylene glycol)methyl ether(meth)acrylate, methoxypoly(ethylene glycol)ethyl (meth)acrylamide having a number average molecular weight of up to 1500, C₁-C₄-alkoxy polyethylene glycol (meth)acrylate having a weight average molecular weight of up to 1500, tetra(ethylene glycol) monovinyl ether, poly(ethylene glycol) monovinyl ether, tetra(ethylene glycol)methyl vinyl ether, poly(ethylene glycol)methyl vinyl ether, tetra(ethylene glycol) monoallyl ether, poly(ethylene glycol) monoallyl ether, tetra(ethylene glycol)methyl allyl ether, poly(ethylene glycol)methyl allyl ether, vinyl alcohol, allyl alcohol, and combinations thereof.
20. The method of any one of embodiments 2 to 19, wherein the aqueous solution has a pH of from about 7.0 to about 8.2, wherein the aqueous solution comprises from about 0.01% to about 2% (preferably from about 0.05% to about 1.5%, more preferably from about 0.1% to about 1%, even more preferably from about 0.2% to about 0.5%) by weight of said at least one water-soluble thermally-crosslinkable hydrophilic polymeric material.
21. The method of any one of embodiments 2 to 20, wherein the aqueous solution comprises a mixture of a monobasic dihydrogen phosphate and dibasic monohydrogen phosphate for maintaining the pH of the aqueous solution, wherein the total concentration of the monobasic dihydrogen phosphate and the dibasic monohydrogen phosphate is at least 30 mM.
22. The method of embodiment 21, wherein the total concentration of the monobasic dihydrogen phosphate and the dibasic monohydrogen phosphate is at least 35 mM.
23. The method of embodiment 21, wherein the total concentration of the monobasic dihydrogen phosphate and the dibasic monohydrogen phosphate is at least 40 mM.
24. The method of embodiment 21, wherein the total concentration of the monobasic dihydrogen phosphate and the dibasic monohydrogen phosphate is at least 45 mM.
25. The method of any one of embodiments 2 to 24, wherein the tonicity of the aqueous solution is adjusted to be about 200 to about 450 milliosmol (mOsm), wherein the aqueous solution comprises one or more organic tonicity agents selected from the group consisting of glycerol, propylene glycol, polyethylene glycol having a number average molecular weigh of from 200 to 800 daltons, mannitols, sorbitol, xylitol, and mixtures thereof, wherein the total concentration of said one or more organic tonicity agents is at least 70 mM.
26. The method of embodiment 25, wherein the total concentration of said one or more organic tonicity agents is at least 90 mM.
27. The method of embodiment 25, wherein the total concentration of said one or more organic tonicity agents is at least 110 mM.
28. The method of embodiment 25, wherein the total concentration of said one or more organic tonicity agents is at least 130 mM.
29. The coated contact lens of embodiment 1 or the method of any one of embodiments 2 to 28, wherein the anterior surface of the coated contact lens has a friction rating which is at least 0.25 larger than the friction rating of the posterior surface, evaluated by using a finger-felt lubricity test.
30. The coated contact lens of embodiment 1 or the method of any one of embodiments 2 to 28, wherein the anterior surface of the coated contact lens has a friction rating which is at least 0.50 larger than the friction rating of the posterior surface, evaluated by using a finger-felt lubricity test.
31. The coated contact lens of embodiment 1 or the method of any one of embodiments 2 to 28, wherein the anterior surface of the coated contact lens has a friction rating which is at least 0.75 larger than the friction rating of the posterior surface, evaluated by using a finger-felt lubricity test.
32. The coated contact lens of any one of embodiments 1 and 29 to 31 or the method of any one of embodiments 2 to 31, wherein the coated contact lens in fully hydrated state has a water-break-up time of at least about 15 seconds as measured on the anterior and posterior surfaces of the coated contact lens.
33. The coated contact lens of any one of embodiments 1 and 29 to 31 or the method of any one of embodiments 2 to 31, wherein the coated contact lens in fully hydrated state has a water-break-up time of at least about 20 seconds, as measured on the anterior and posterior surfaces of the coated contact lens.
34. The coated contact lens of any one of embodiments 1 and 29 to 31 or the method of any one of embodiments 2 to 31, wherein the coated contact lens in fully hydrated state has a water-break-up time of at least about 25 seconds, as measured on the anterior and posterior surfaces of the coated contact lens.
35. The coated contact lens of any one of embodiments 1 and 29 to 31 or the method of any one of embodiments 2 to 31, wherein the coated contact lens in fully hydrated state has a water-break-up time of at least about 30 seconds as measured on the anterior and posterior surfaces of the coated contact lens.
36. The coated contact lens of any one of embodiments 1 and 29 to 35 or the method of any one of embodiments 2 to 35, wherein the imperfections comprise: (1) detaches that in top view have a ring shape, a curved line shape, and/or a straight line shape; (2) gaps that in top view have a circular shape, a triangular shape, a square shape, a rectangular shape, a hexagonal shape, a polygonal shape, and/or a star shape.
37. The coated contact lens or the method of embodiment 36, wherein one of the two dimensions of each of the imperfections in top view is about 0.40 mm or less.
38. The coated contact lens or the method of embodiment 36, wherein one of the two dimensions of each of the imperfections in top view is about 0.30 mm or less.
39. The coated contact lens or the method of embodiment 36, wherein one of the two dimensions of each of the imperfections in top view is about 0.25 mm or less.
40. The coated contact lens or the method of embodiment 36, wherein one of the two dimensions of each of the imperfections in top view is from about 0.05 mm to about 0.20 mm.
41. The coated contact lens of any one of embodiments 1 and 29 to 40 or the method of any one of embodiments 2 to 40, wherein the imperfections on the anterior surface of the coated contact lens are arranged in a rotationally symmetric pattern with respect to the central axis of the coated contact lens.
42. The coated contact lens of any one of embodiments 1 and 29 to 40 or the method of any one of embodiments 2 to 40, wherein the imperfections on the anterior surface of the coated contact lens are located in an annular zone having an inner diameter of from about 6.0 mm to about 9.0 mm and an outer diameter of from about 11.5 mm to about 14.5 mm and being concentric with respect to the central axis of the coated contact lens.
43. The coated contact lens of any one of embodiments 1 and 29 to 42 or the method of any one of embodiments 2 to 42, wherein the imperfections comprise at least three ditches in ring-shape in top view.
44. The coated contact lens of any one of embodiments 1 and 29 to 43 or the method of any one of embodiments 2 to 43, wherein the imperfections comprise at least eight ditches in curved-line shape or shape of straight lines radiating outward from a circle having a diameter of from about 6.0 mm to about 9.0 mm and being concentric with respect to the central axis of the coated contact lens.
45. The coated contact lens of any one of embodiments 1 and 29 to 44 or the method of any one of embodiments 2 to 44, wherein the imperfections comprise gaps in circular shape in top view.
46. The coated contact lens or the method of embodiment 45, wherein the gaps in circular shape in top view each have a diameter of about 0.25 mm or less.
47. The coated contact lens or the method of embodiment 45, wherein the gaps in circular shape in top view each have a diameter of from about 0.05 mm to about 0.20 mm.
48. The coated contact lens or the method of any one of embodiments 45 to 47, wherein the gaps in circular shape in top view each are arranged in a rotationally symmetric pattern on the anterior surface of the coated contact lens.
49. The coated contact lens or the method of embodiment 48, wherein the gaps in circular shape in top view are arranged in a pattern of annular rings concentric with the central axis of the coated contact lens.
50. The coated contact lens of any one of embodiments 1 and 29 to 44 or the method of any one of embodiments 2 to 49, wherein the first non-silicone hydrogel material is a crosslinked polymeric material which comprises at least 35% by mole of repeating monomeric units of at least one hydrophilic vinylic monomer selected from the group consisting of (meth)acrylamide, dimethyl (meth)acrylamide, N-2-hydroxylethyl (meth)acrylamide, N,N-bis(hydroxyethyl)(meth)acrylamide, N-2,3-dihydroxypropyl (meth)acrylamide, N-tris(hydroxymethyl)methyl (meth)acrylamide, N-2-dimethylaminoethyl (meth)acrylamide, dimethylaminoethyl (meth)acrylate, 2-hydroxyethyl (meth)acrylate, glycerol methacrylate (GMA), tetra(ethylene glycol)(meth)acrylate, poly(ethylene glycol)ethyl (meth)acrylamide having a number average molecular weight of up to 1500, poly(ethylene glycol)(meth)acrylate having a number average molecular weight of up to 1500, N-vinylpyrrolidone, N-vinyl-N-methyl acetamide, N-vinyl formamide, N-vinyl acetamide, 1-methyl-3-methylene-2-pyrrolidone, 1-methyl-5-methylene-2-pyrrolidone, 5-methyl-3-methylene-2-pyrrolidone, tetra(ethylene glycol)methyl ether(meth)acrylate, methoxypoly(ethylene glycol)ethyl (meth)acrylamide having a number average molecular weight of up to 1500, C₁-C₄-alkoxy polyethylene glycol (meth)acrylate having a weight average molecular weight of up to 1500, tetra(ethylene glycol) monovinyl ether, poly(ethylene glycol) monovinyl ether, tetra(ethylene glycol)methyl vinyl ether, poly(ethylene glycol)methyl vinyl ether, tetra(ethylene glycol) monoallyl ether, poly(ethylene glycol) monoallyl ether, tetra(ethylene glycol)methyl allyl ether, poly(ethylene glycol)methyl allyl ether, vinyl alcohol, allyl alcohol, and combinations thereof.
51. The coated contact lens of any one of embodiments 1 and 29 to 44 or the method of any one of embodiments 2 to 49, wherein the first non-silicone hydrogel material is a crosslinked polymeric material which comprises at least 45% by mole of repeating monomeric units of at least one hydrophilic vinylic monomer selected from the group consisting of (meth)acrylamide, dimethyl (meth)acrylamide, N-2-hydroxylethyl (meth)acrylamide, N,N-bis(hydroxyethyl)(meth)acrylamide, N-2,3-dihydroxypropyl (meth)acrylamide, N-tris(hydroxymethyl)methyl (meth)acrylamide, 2-hydroxyethyl (meth)acrylate, glycerol methacrylate, poly(ethylene glycol)ethyl (meth)acrylamide having a number average molecular weight of up to 1500, poly(ethylene glycol)(meth)acrylate having a number average molecular weight of up to 1500, N-vinylpyrrolidone, N-vinyl-N-methyl acetamide, methoxypoly(ethylene glycol)ethyl (meth)acrylamide having a number average molecular weight of up to 1500, methoxy polyethylene glycol (meth)acrylate having a weight average molecular weight of up to 1500, poly(ethylene glycol) monovinyl ether, poly(ethylene glycol)methyl vinyl ether, poly(ethylene glycol) monoallyl ether, poly(ethylene glycol)methyl allyl ether, vinyl alcohol, allyl alcohol, and combinations thereof.
52. The coated contact lens of any one of embodiments 1 and 29 to 44 or the method of any one of embodiments 2 to 49, wherein the first non-silicone hydrogel material is a crosslinked polymeric material which comprises at least 55% by mole of repeating monomeric units of at least one hydrophilic vinylic monomer selected from the group consisting of (meth)acrylamide, dimethyl (meth)acrylamide, N-2-hydroxylethyl (meth)acrylamide, N,N-bis(hydroxyethyl)(meth)acrylamide, N-2,3-dihydroxypropyl (meth)acrylamide, N-tris(hydroxymethyl)methyl (meth)acrylamide, poly(ethylene glycol)ethyl (meth)acrylamide having a number average molecular weight of up to 1500, poly(ethylene glycol)(meth)acrylate having a number average molecular weight of up to 1500, N-vinylpyrrolidone, N-vinyl-N-methyl acetamide, methoxypoly(ethylene glycol)ethyl (meth)acrylamide having a number average molecular weight of up to 1500, methoxy polyethylene glycol (meth)acrylate having a weight average molecular weight of up to 1500, and combinations thereof.
53. The coated contact lens of any one of embodiments 1 and 29 to 44 or the method of any one of embodiments 2 to 49, wherein the first non-silicone hydrogel material is a crosslinked polymeric material which comprises at least 25% by mole of repeating monomeric units of at least one phosphorylcholine-containing vinylic monomer.
54. The coated contact lens of any one of embodiments 1 and 29 to 44 or the method of any one of embodiments 2 to 49, wherein the first non-silicone hydrogel material is a crosslinked polymeric material which comprises at least 35% by mole of repeating monomeric units of at least one phosphorylcholine-containing vinylic monomer.
55. The coated contact lens of any one of embodiments 1 and 29 to 44 or the method of any one of embodiments 2 to 49, wherein the first non-silicone hydrogel material is a crosslinked polymeric material which comprises at least 45% by mole of repeating monomeric units of at least one phosphorylcholine-containing vinylic monomer.
56. The coated contact lens of any one of embodiments 1 and 29 to 44 or the method of any one of embodiments 2 to 49, wherein the first non-silicone hydrogel material is a crosslinked polymeric material which comprises at least 55% by mole of repeating monomeric units of at least one phosphorylcholine-containing vinylic monomer.
57. The coated contact lens or the method of any one of embodiments 53 to 56, wherein said at least one phosphorylcholine-containing vinylic monomer is selected from the group consisting of (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]-ethyl-2′-(trimethylammonio)ethylphosphate, 3-[(meth)acryloylamino]propyl-2′-(trimethylammonio)-ethylphosphate, 4-[(meth)acryloylamino]butyl-2′-(trimethylammonio)ethylphosphate, and combinations thereof.
58. The coated contact lens of any one of embodiments 1 and 29 to 44 or the method of any one of embodiments 2 to 49, wherein the first non-silicone hydrogel material is a crosslinked polymeric material which comprises poly(ethylene glycol) chains, preferably derived directly from (a) a pol(ethylene glycol) having one sole functional group of —NH₂, —SH or —COOH, (b) a pol(ethylene glycol) having two terminal functional groups selected from the group consisting of —NH₂, —COOH, —SH, and combinations thereof, (c) a multi-arm poly(ethylene glycol) having one or more functional groups selected from the group consisting of —NH₂, —COOH, —SH, and combinations thereof, and (d) combinations thereof.
59. The coated contact lens of any one of embodiments 1 and 29 to 58 or the method of any one of embodiments 2 to 58, wherein the lens bulk material is a hard plastic material (preferably a crosslinked polymethacrylate).
60. The coated contact lens of any one of embodiments 1 and 29 to 58 or the method of any one of embodiments 2 to 58, wherein the lens bulk material is a rigid gas permeable material.
61. The coated contact lens of any one of embodiments 1 and 29 to 58 or the method of any one of embodiments 2 to 58, wherein the lens bulk material consists essentially of a central optical zone that is made of a gas permeable lens material and a peripheral zone that is made of a silicone hydrogel or a third non-silicone hydrogel lens material and extends outwardly from and surrounds the central optical zone.
62. The coated contact lens of any one of embodiments 1 and 29 to 58 or the method of any one of embodiments 2 to 58, wherein the lens bulk material is a third non-silicone hydrogel material having a water content of from about 10% to about 70% by weight or less in fully hydrated state.
63. The coated contact lens of any one of embodiments 1 and 29 to 58 or the method of any one of embodiments 2 to 58, wherein the lens bulk material is a third non-silicone hydrogel material which a water content of from about 10% to about 70% by weight or less in fully hydrated state and comprises at least 50% by mole of repeating units of at least one hydroxyl-containing vinylic monomer, preferably selected from the group consisting of hydroxyethyl (meth)acrylate, glycerol(meth)acrylate, 3-hydroxypropyl (meth)acrylate, 2-hydroxypropyl (meth)acrylate, 3-amino-2-hydroxypropyl (meth)acrylate, N-2-hydroxyethyl (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, vinyl alcohol, allyl alcohol, and combinations thereof, more preferably selected from the group consisting of hydroxyethyl (meth)acrylate, glycerol(meth)acrylate, and vinyl alcohol.
64. The coated contact lens of any one of embodiments 1 and 29 to 58 or the method of any one of embodiments 2 to 58, wherein the lens bulk material is a silicone hydrogel material that in fully hydrated has a water content of from about 10% to about 70% by weight or less and an oxygen permeability of at least about 50 barrers.
65. The coated contact lens or the method of embodiment 64, wherein the coated contact lens has: a water content of from about 20% to about 70% (preferably from about 25% to about 65%, more preferably from about 30% to about 60%) by weight, an elastic modulus of from about 0.2 MPa to about 2.0 MPa (preferably from about 0.25 MPa to about 1.5 MPa, more preferably from about 0.3 MPa to about 1.2 MPa, even more preferably from about 0.35 MPa to about 1.0 MPa), an oxygen transmissibility of at least 60 barrers/mm (preferably at least 70 barrers/mm, more preferably at least 80 barrers/mm, even more preferably at least 100 barrers/mm), and an averaged water contact angle of less than 90 degrees (preferably less than 80 degrees, more preferably less than 70 degrees, even more preferably less than 60 degrees).
66. The method of any one of embodiments 2 to 65, wherein the multiple zones have circular shapes, triangular shapes, square shapes, rectangular shapes, hexagonal shapes, polygonal shapes, star shapers, annular ring shapes, curved line shapes, straight line shapes, or combinations thereof.
67. The method of any one of embodiments 2 to 66, wherein one of the two dimensions of the multiple zones is about 0.40 mm or less.
68. The method of any one of embodiments 2 to 66, wherein one of the two dimensions of the multiple zones is about 0.30 mm or less.
69. The method of any one of embodiments 2 to 66, wherein one of the two dimensions of the multiple zones is about 0.25 mm or less.
70. The method of any one of embodiments 2 to 66, wherein one of the two dimensions of the multiple zones is from about 0.05 mm to about 0.20 mm.
71. The method of any one of embodiments 2 to 70, wherein the multiple zones are arranged in a rotationally symmetric pattern with respect to the central axis of the preformed contact lens or the female mold half.
72. The method of any one of embodiments 2 to 71, wherein the multiple zones are located in an annular zone having an inner diameter of from about 6.0 mm to about 9.0 mm and an outer diameter of from about 11.5 mm to about 14.5 mm and being concentric with respect to the central axis of the preformed contact lens or the female mold half.
73. The method of any one of embodiments 2 to 72, wherein the multiple zones comprise at least three annular rings.
74. The method of any one of embodiments 2 to 73, wherein the multiple zones comprise at least eight curved or straight lines radiating outward from a circle having a diameter of from about 6.0 mm to about 9.0 mm and being concentric with respect to the central axis of the preformed contact lens or the female mold half.
75. The method of any one of embodiments 2 to 74, wherein the multiple zones comprise circular dots having a diameter of about 0.25 mm or less.
76. The method of any one of embodiments 2 to 74, wherein the multiple zones comprise circular dots having a diameter of from about 0.05 mm to about 0.20 mm.
77. The method of embodiment 75 or 76, wherein the circular dots are arranged in a rotationally symmetric pattern on the convex surface of the preformed contact lens or the molding surface of the female mold half with respect to the central axis of the preformed contact lens or the female mold half.
78. The method of any one of embodiments 75 to 77, wherein the circular dots are arranged in annular rings concentric with the central axis of the preformed contact lens or the female mold half.

The previous disclosure will enable one having ordinary skill in the art to practice the invention. Various modifications, variations, and combinations can be made to the various embodiment described herein. In order to better enable the reader to understand specific embodiments and the advantages thereof, reference to the following examples is suggested. It is intended that the specification and examples be considered as exemplary.

### Example 1

### Oxygen Permeability Measurements

Unless specified, the oxygen transmissibility (Dk/t), the intrinsic (or edge-corrected) oxygen permeability (Dkᵢ or Dk_{c}) of a lens and a lens material are determined according to procedures described in ISO 18369-4.

### Water Break-Up Time (WBUT) Tests

The surface hydrophilicity of lenses is assessed by determining the time required for the water film to start breaking on the lens surface using the interfacial dewetting and drainage optical platform (iDDroP) as described by Bhamla et al. in their article entitled Influence of Lipid Coatings on Surface Wettability Characteristics of Silicone Hydrogels published in Langmuir. 2015, 31:3820-3828. During the IDDrop test, the lens is placed on a stage and submerged in PBS. Then, a small surface of the lens is exposed to air. A motorized linear stage and motion controller are used in order to expose the contact lens at specified depths. Video of the water break-up is captured in order to evaluate water break-up time as well as the pattern in which the water film breaks up.

### Equilibrium Water Content

The equilibrium water content (EWC) of contact lenses (i.e., water content of a contact lens in fully hydrated state) are determined according to the procedures described in Example 1 of U.S. Pat. Appl. Pub. No. 20210181379 A1.

### Elastic Modulus

The elastic modulus of a contact lens is determined according to the procedures described in Example 1 of U.S. Pat. Appl. Pub. No. 20210181379 A1.

### Light Transmissibility

Contact lenses are manually placed into a specially fabricated sample holder or the like which can maintain the shape of the lens as it would be when placing onto eye. This holder is then submerged into a 1 cm path-length quartz cell containing phosphate buffered saline (PBS, PH˜7.0-7.4) as the reference. A UV/visible spectrophotometer, such as, Varian Cary 3E UV-Visible Spectrophotometer with a LabSphere DRA-CA-302 beam splitter or the like, can be used in this measurement. Percent transmission spectra are collected at a wavelength range of 250-800 nm with % T values collected at 0.5 nm intervals. The light transmissibility of a contact lens is the average % transmission between 400 nm and 700 nm.

Water Contact Angle (WCA) Measurements. Water contact angle (WCA) measurements are performed by the sessile drop method with a DSA 10 drop shape analysis system from Krüss GmbH, Germany with pure water (Fluka, surface tension 72.5 mN/m at 20° C.). For measurement purposes a contact lens is taken off the storage solution with tweezers and excess storage solution is removed by gentle shaking. The contact lens are placed on the male part of a lens mold and gently blotted with a dry and clean cloth. A water droplet (approximately 1 μl) is then dosed on the lens apex, and the change of the contact angle over time of this water droplet (WCA(t), circle fitting mode) is monitored. The WCA is calculated by the extrapolation of the graph WCA(t) to t=0.

### Lubricity Evaluation.

The lubricity of a contact lens is evaluated by using a finger-felt lubricity test which characterizes qualitatively the slipperiness of a lens surface on a friction rating scale of from 0 to 4. The higher the friction rating is, the lower the slipperiness (or lubricity). During this test, a lens is felt between the thumb and forefinger, and is qualitatively given a rating from 0-4 based on the perceived levels of friction by a tester. The rating given is in comparison to 5 commercial lenses that serve as standards for this test, corresponding to the 5 levels of lubricity.

The levels and standards are as follows: the DAILIES® TOTAL1® lens (Alcon) is a standard for a 0 rating on the scale, the ACUVUE® OASYS™ lens (Johnson & Johnson) is a standard rating of 1, the ULTRA® lens (Bausch & Lamb) is a standard rating of 2, the DAILIES® Aqua Comfort Plus® lens (Alcon) is a standard rating of 3, and the AIR OPTIX® Aqua lens is a standard rating of 4.

The samples are placed in PBS for at least two rinses of 30 minutes each and then transferred to fresh PBS before the evaluation. Before the evaluation, hands are rinsed with a soap solution, extensively rinsed with DI water and then dried with KimWipe® towels. When evaluating the lubricity of the anterior surface, the lens is placed on a forefinger with its posterior surface facing the forefinger and the thumb moves against the anterior surface to feel the slipperiness (or lubricity) of the anterior surface. When evaluating the lubricity of the posterior surface, the lens is first inverted and then placed on a forefinger with the inverted anterior surface facing the forefinger, and then the thumb moves against the inverted posterior surface to feel the slipperiness (or lubricity) of the posterior surface.

Each samples are assigned a friction rating relative to the above standard lenses described above. The value of a friction rating is one obtained by averaging the results of at least two friction ratings of a contact lens by two or more persons and/or by averaging the friction ratings of two or more contact lenses (from the identical batch of lens production) by one person.

The finger lubricities (i.e., friction ratings) of a contact lens can be determined directly out-of-pack (OOP) but after ≥30 min soaking in PBS according to the procedures described above.

### Lens Removability Evaluation

Overall removability of each lens group is measured using a 3-D printed eye model including a soft cornea, orbital bone, and nasal bone. The inclusion of these details allowed for interference that would be biologically accurate during the wear and removal of a contact lens. A blind test is conducted in which two testers determined the number of attempts to remove lenses under test. An ‘attempt’ for removal is defined as a shear plucking motion across the surface of the model eye, with the contact lens placed on the ocular zone of the eye. This is performed with minimal downward force applied to the surface of the model eye, in order to simulate an actual lens removal motion. A drop of artificial tear solution is also applied to the eye after the contact is placed on the eye, to simulate the hydrating effect of a blink.

### Chemicals

The following abbreviations are used in the following examples: HEMA represents hydroxyethyl methacrylate; EOEMA represents ethoxyethyl methacrylate; MAA represents methacrylic acid; AA represents acrylic acid; PEG-DA represents poly(ethylene glycol) diacrylate (Mn˜800 g/mol); PG represents propylene glycol; Vazo 64 represents azobisisobutyronitrile; Vazo 67 represents 2,2′-azodi(2-methylbutyronicnitrile); AIBN represents azobis(isobutyronitrile); Perkadox 16 is Di(4-tert-butylcyclohexyl) peroxydicarbonate; MPC represents 2-Methacryloyloxyethyl phosphorylcholine; EGMA is 2-methoxyethyl methacrylate; AMA is allyl methacrylate; TEGDVE is tri(ethylene glycol) divinyl ether; Nobloc is 2-[3-(2H-Benzotriazol-2-yl)-5-hydroxyphenyl]ethyl methacrylate; RB247 is Reactive Blue 247; HDI represents hexamethylene diisocyanate; ELA represents ethyl lactate; ME represents 2-mercapto ethanol; PBS represents a phosphate-buffered saline which has a pH of 7.2±0.2 at 25° C. and contains about 0.044 wt. % NaH₂PO₄—H₂O, about 0.388 wt. % Na₂HPO₄·2H₂O, and about 0.79 wt. % NaCl and; wt. % represents weight percent; “G2” macromer represents a di-methacryloyloxypropyl-terminated polysiloxane (Mn˜8K g/mol, OH content ˜3.5 meq/g) of formula (A).

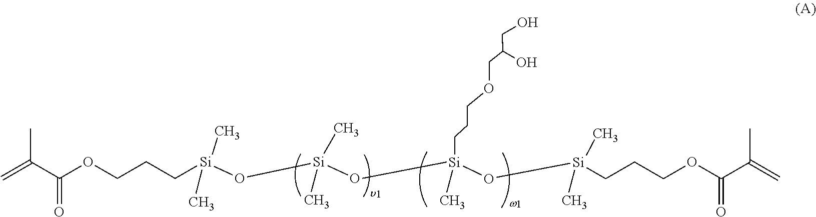

### Example 2

### Preparation of Polymerizable Compositions

Polymerizable compositions (SiHy lens formulations) are prepared to have compositions as shown in Table 1.

TABLE 1

| | SiHy lens formulation (unit part by weight) | | |
|---|---|---|---|
| Component | 11-1 | 11-2 | 11-3 |
| HEMA | 5 | 5 | 5 |
| EOEMA | 45 | 45 | 45 |
| G2 | 45 | 45 | 45 |
| TEGDMA | 0.2 | 0.2 | 0.2 |
| Vazo 67 | 0.5 | 0.5 | 0.5 |
| PG | 20 | 20 | 20 |
| AA | 4.2 | 4.4 | 4.6 |
| Norbloc | 1.5 | 1.5 | 1.5 |
| RB247 | 0.01 | 0.01 | 0.01 |

The formulations are prepared by adding listed components in their targeted amounts into a clean bottle, with a stir bar to mix at 600 rpm for 30 minutes at room temperature. After all the solid is dissolved, a filtration of the formulation is carried out by using 2.7 μm glass-microfiber-filter (GMF).

### Cast-Molded Silicone Hydrogel Contact Lenses

A lens formulation is purged with nitrogen at room temperature for 30 to 35 minutes. The N₂-purged lens formulation is introduced into polypropylene molds and thermally cured in an oven under nitrogen under the following curing conditions: ramp from room temperature to 55° C. at a ramp rate of about 7ºC/minute; holding at 55° C. for about 30 minutes; ramp from 55° C. to 80° C. at a ramp rate of about 7ºC/minute; holding at 80° C. for about 30 minutes; ramp from 80° C. to 100° C. at a ramp rate of about 7ºC/minute; and holding at 100° C. for about 30 minutes. The molds are opened, and the molded lenses are adhered on male mold halves.

### Example 3

### Phosphate Buffered Saline (PBS)

A phosphate buffered saline is prepared by dissolving NaH₂PO₄·H₂O, Na₂HPO₄·2H₂O, and NaCl in a given volume of purified water (distilled or deionized) to have the following composition: ca. 0.044 w/w % NaH₂PO₄·H₂O, ca. 0.388 w/w/% Na₂HPO_{4·2}H₂O, and ca. 0.79 w/w % NaCl.

### Preparation of In-Package-Coating Saline—IPC-1

IPC saline (IPC-1) is prepared by mixing appropriate amount of Poly(AAm-co-AA) with PAE in phosphate buffered saline and pre-treated at certain temperature for a desired time. Poly(AAm-co-AA)(90/10) partial sodium salt, poly(AAm-co-AA) 90/10, Mw 200,000) is made in house. Kymene or PAE solutions of different solid contents is purchased from Solenis as an aqueous solution and used as received. ˜0.05% by weight of PAE; 0.035% by weigh of Poly(AAm-co-AA)(90/10), 0.776% by weight of Na₂HPO₄·2H₂O, 0.044% by weight of NaH₂PO₄·H₂O, 0.160% by weight of NaCl; and QS to 100% by water. The prepared aqueous solution is pre-treated at 60° C. for about 1 hour. After the heat pre-treatment, the IPC saline is filtered using a 0.22 micron membrane filter and cooled down back to room temperature. 5 ppm hydrogen peroxide may be added to the final IPC saline to prevent bioburden growth and the IPC saline is filtered using a 0.22 micron membrane filter.

### Preparation of A Hydrogel-Forming Composition

A crosslinkable polymer having hydroxyl groups is prepared by polymerizing of a composition comprising of 38.33% HEMA, 4.20% EOEMA, 0.32% ME, 0.21% AIBN, and 56.93% cyclopentanone, according to a procedure described in U.S. Pat. No. 4,668,240.

A hydrogel-forming composition is prepared to having a composition: 49.7 wt of a crosslinkable polymer prepared above; 16 wt. % of HEMA; 1.8 wt. % of EOEMA; 3.2 wt. % of HDI; 0.1 wt. % of Vazo 64; 29.2 wt. % of ELA.

### Preparation of Cliché

Image patterns of varied dot diameters and densities are engraved in printing plates to obtain metal clichés, polymer clichés or ceramic clichés to be used in a pad printing instrument. All patterns are 15 microns in depth.

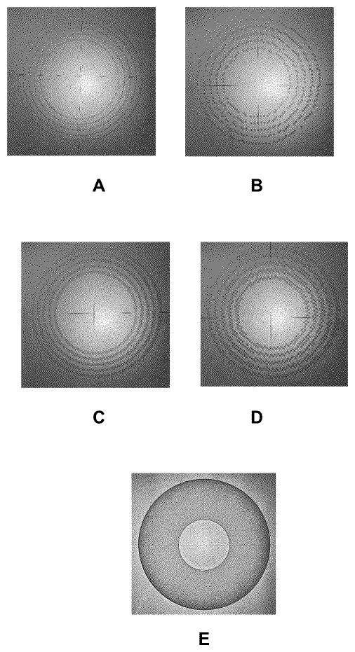

FIG. 1A shows 0.25 pt. printing pattern (5 rings) of dots each having a diameter of 90 μm. The inner diameter of the smallest ring is 7.5 mm.

FIG. 1B shows 0.50 pt. printing pattern (5 rings) of dots each having a diameter of 170 μm. The inner diameter of the smallest ring is 6.4 mm.

FIG. 1C shows 0.75 pt. printing pattern (5 rings) of dots each having a diameter of 90 μm. The inner diameter of the smallest ring is 7.5 mm.

FIG. 1D shows 1.0 pt. printing pattern (5 rings) of dots each having a diameter of 170 μm. The inner diameter of the smallest ring is 6.4 mm.

FIG. 1E shows donut-ring pt. printing pattern having an inner diameter of 4.4 mm and an outer diameter of 11.1 mm.

### Production of Water Gradient Contact Lenses

The hydrogel-forming composition prepared above is applied onto the anterior surface (convex surface) of preformed SiHy contact lenses (dry lenses adhered on male mold halves) prepared in Example 2 in a printing pattern described above, according to the pad-printing procedures as described in Example 4 of US2020/0376787 A1. Lenses can receive one single print (1 layer) or two prints (2 layers) of the hydrogel-forming composition. After pad printing, the lens undergoes a second thermal curing step. This step adheres the printed hydrogel to the lens in order to achieve differential surface properties on the lens. The lens is removed from the mold (delensing), packaged and hydrated in IPC saline for 30 minutes, and then autoclaved at 121° C. for 45 minutes.

Control lenses are not subjected to printing of the hydrogel-formulation but are packaged and autoclave in the same IPC saline.

The resultant water gradient contact lenses in fully-hydrated state have a water content of about 47%, an oxygen permeability (Dkc) of about 65 barrers, and an elastic modulus of about 0.7 MPa.

### Lubricity Evaluation

Finger-felt lubricity tests are conducted with water gradient contact lenses prepared above according to the procedures described in Example 1. Lenses with friction ratings between 0 and 1 are designated 0.5, and lenses with friction ratings slightly greater than 0 are designated 0.25. The results are reported in Table 2.

TABLE 2

Friction Rating (0-4)

| Lens Group | Posterior Surface | Anterior Surface |
|---|---|---|
| Control (no print) | 0 | 0 |
| 0.25 pt. - 1 layer | 0 | 0.25 |
| 0.25 pt. - 2 layers | 0 | 0.5 |
| 0.50 pt. - 1 layer | 0.25 | 0.5 |
| 0.50 pt. - 2 layers | 0 | 1 |
| 0.75 pt. - 1 layer | 0.25 | 0.5 |
| 0.75 pt. - 2 layers | 0.25 | 0.5 |
| 1.0 pt. - 1 layer | 0.25 | 0.5 |
| 1.0 pt. - 2 layers | 0.25 | 1 |

### Water-Break-Up-Time by IDDrop

Water-break-up times of water gradient contact lenses prepared above are determined by using IDDrop according to the procedures described in Example 1. The results are reported in Table 3.

TABLE 3

Water Break-up Time (s)

| Lens Group | Posterior Surface | Anterior Surface |
|---|---|---|
| Control | 33 | 30 |
| 0.25 pt. - 1 layer | 30 | 30 |
| 0.25 pt. - 2 layers | 29 | 38 |
| 0.50 pt. - 1 layer | 29 | 28 |
| 0.50 pt. - 2 layers | 22 | 15 |
| 0.75 pt. - 1 layer | 38 | 35 |
| 0.75 pt. - 2 layers | 30 | 29 |
| 1.0 pt. - 1 layer | 34 | 25 |
| 1.0 pt. - 2 layers | 30 | 33 |

During the IDDrop tests, it is observed that the break-up pattern on a non-printed lens is a rather uniform propagation. Water break-up on printed lenses, especially groups with 2 layers of larger dot size prints, is less uniform as water tends to pool around the printed areas.

### Lens Removability Evaluation

Lens Removability of the water gradient contact lenses prepared above are evaluated according to the procedures described in Example 1. The results are reported in Table 4.

TABLE 4

| | Tester 1 # of Attempts | | | | Tester 2 # of Attempts | | | |
|---|---|---|---|---|---|---|---|---|
| Lens Group | Trial 1 | Trial 2 | Trial 3 | Avg. | Trial 1 | Trial 2 | Trial 3 | Avg. |
| Control | 3 | 4 | 4 | 3.67 | 1 | 7 | 9 | 5.67 |
| 0.25 pt. - 1 layer | 3 | 3 | 2 | 2.67 | 4 | 5 | 2 | 3.67 |
| 0.25 pt. - 2 layers | 2 | 3 | 3 | 2.67 | 4 | 1 | 2 | 2.33 |
| 0.50 pt. - 1 layer | 3 | 2 | 3 | 2.67 | 3 | 1 | 2 | 2 |
| 0.50 pt. - 2 layers | 2 | 4 | 2 | 2.67 | 1 | 4 | 1 | 2 |
| 0.75 pt. - 1 layer | 3 | 4 | 2 | 3 | 3 | 1 | 2 | 2 |
| 0.75 pt. - 2 layers | 3 | 3 | 4 | 3.33 | 2 | 6 | 1 | 3 |
| 1.0 pt. - 1 layer | 4 | 3 | 4 | 3.67 | 2 | 2 | 3 | 2.33 |
| 1.0 pt. - 2 layers | 1 | 3 | 2 | 2 | 3 | 3 | 4 | 3.33 |
| Ring pt. - 1 layer | 2 | 1 | 2 | 1.67 | 2 | 3 | 5 | 3.33 |
| Ring pt. - 2 layers | 1 | 1 | 2 | 1.33 | 1 | 1 | 2 | 1.33 |

All the publications, patents, and patent application publications, which have been cited herein above in this application, are hereby incorporated by reference in their entireties.

What is claimed is:

1. A coated contact lens comprising:
an anterior surface and an opposite posterior surface; and
a layered structural configuration which comprises, in a direction from the anterior surface to the posterior surface, an anterior outer hydrogel layer, an inner layer, and a posterior outer hydrogel layer,
wherein the inner layer is a lens bulk material, wherein the posterior outer hydrogel layer is a layer of a first non-silicone hydrogel material, wherein the anterior outer hydrogel layer is a layer of the first non-silicone hydrogel material with imperfections distributed therein so that the posterior outer hydrogel layer has a surface lubricity higher than the surface lubricity of the anterior outer hydrogel layer, wherein the coated contact lens in fully-hydrated state has a water-break-up time of at least about 10 seconds as measured on the anterior and posterior surfaces of the coated contact lens.

2. The coated contact lens of claim 1, wherein the imperfections comprise: (1) detaches that in top view have a ring shape, a curved line shape, and/or a straight line shape; (2) gaps that in top view have a circular shape, a triangular shape, a square shape, a rectangular shape, a hexagonal shape, a polygonal shape, and/or a star shape.

3. The coated contact lens of claim 2, wherein the imperfections on the anterior surface of the coated contact lens are arranged in a rotationally symmetric pattern with respect to the central axis of the coated contact lens.

4. The coated contact lens of claim 2, wherein the imperfections on the anterior surface of the coated contact lens are located in an annular zone having an inner diameter of from about 6.0 mm to about 9.0 mm and an outer diameter of from about 11.5 mm to about 14.5 mm and being concentric with respect to the central axis of the coated contact lens.

5. The coated contact lens of claim 2, wherein the imperfections comprise at least three ditches in ring-shape in top view.

6. The coated contact lens of claim 2, wherein the imperfections comprise at least eight ditches in curved-line shape or shape of straight lines radiating outward from a circle having a diameter of from about 6.0 mm to about 9.0 mm and being concentric with respect to the central axis of the coated contact lens.

7. The coated contact lens of claim 2, wherein the imperfections comprise gaps in circular shape in top view.

8. The coated contact lens of claim 7, wherein the gaps in circular shape in top view each are arranged in a rotationally symmetric pattern on the anterior surface of the coated contact lens.

9. The coated contact lens of claim 8, wherein the gaps in circular shape in top view are arranged in a pattern of annular rings concentric with the central axis of the coated contact lens.

10. The coated contact lens of claim 2, wherein the first non-silicone hydrogel materials is:
(1) a crosslinked polymeric material which comprises at least 25% by mole of repeating monomeric units of at least one hydrophilic vinylic monomer selected from the group consisting of (meth)acrylamide, N,N-dimethyl (meth)acrylamide, N-ethyl (meth)acrylamide, N,N-diethyl(meth)acrylamide, N-propyl (meth)acrylamide, N-isopropyl (meth)acrylamide, N-3-methoxypropyl (meth)acrylamide), N-2-dimethylaminoethyl (meth)acrylamide, dimethylaminoethyl (meth)acrylate, N-2-hydroxylethyl (meth)acrylamide, N,N-bis(hydroxyethyl)(meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol)(meth)acrylate, tri(ethylene glycol)(meth)acrylate, tetra(ethylene glycol)(meth)acrylate, poly(ethylene glycol)(meth)acrylate having a number average molecular weight of up to 1500, poly(ethylene glycol)ethyl (meth)acrylamide having a number average molecular weight of up to 1500, N-vinyl pyrrolidone, N-vinyl-N-methyl acetamide, N-vinyl formamide, N-vinyl acetamide, N-vinyl isopropylamide, N-vinyl-N-ethyl acetamide, N-vinyl-N-ethyl formamide, 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, ethylene glycol methyl ether(meth)acrylate, di(ethylene glycol)methyl ether(meth)acrylate, tri(ethylene glycol)methyl ether(meth)acrylate, tetra(ethylene glycol)methyl ether(meth)acrylate, C₁-C₄-alkoxy poly(ethylene glycol)(meth)acrylate having a weight average molecular weight of up to 1500, methoxy-poly(ethylene glycol)ethyl (meth)acrylamide having a number average molecular weight of up to 1500, allyl alcohol, ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol)methyl allyl ether, tri(ethylene glycol)methyl allyl ether, tetra(ethylene glycol)methyl allyl ether, poly(ethylene glycol)methyl allyl ether, ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol)methyl vinyl ether, tri(ethylene glycol)methyl vinyl ether, tetra(ethylene glycol)methyl vinyl ether, poly(ethylene glycol)methyl vinyl ether, and combinations thereof;
(2) a crosslinked polymeric material which comprises at least 25% by mole of repeating monomeric units of at least one phosphorylcholine-containing vinylic monomer;
(3) a crosslinked polymeric material which comprises poly(ethylene glycol) chains, derived directly from (a) a pol(ethylene glycol) having one sole functional group of —NH₂, —SH or —COOH, (b) a pol(ethylene glycol) having two terminal functional groups selected from the group consisting of —NH₂, —COOH, —SH, and combinations thereof, (c) a multi-arm poly(ethylene glycol) having one or more functional groups selected from the group consisting of —NH₂, —COOH, —SH, and combinations thereof, and (d) combinations thereof; or
(4) combinations thereof.

11. The coated contact lens of claim 10, wherein the lens bulk material is a silicone hydrogel material that in fully hydrated has a water content of from about 10% to about 70% by weight or less, an oxygen permeability of at least about 50 barrers, and an elastic modulus of from about 0.25 MPa to about 1.5 MPa.

12. A method for producing coated contact lenses, comprising the steps of:
(1) obtaining a preformed contact lens having a convex surface and an opposite concave surface, wherein the preformed contact lens is composed of a lens bulk material and comprises first reactive functional groups on and near the convex and concave surfaces of the preformed contact lens, wherein each of the first reactive functional groups is capable of reacting with a thermally-crosslinkable group at a temperature from about 60° C. to about 140° C. and are selected from the group consisting of carboxylic acid groups, primary amino groups, secondary amino groups, thiol groups, and combinations thereof;
(2) covering multiple zones on the convex surface with a first non-silicone hydrogel material to prevent first reactive functional groups behind the multiple zones from reacting with thermally-crosslinkable groups, wherein the first non-silicone hydrogel material is free of any first reactive functional group and free of any thermally-crosslinkable group;
(3) heating the preformed contact lens obtained in step (2) directly in an aqueous solution having a pH from about 6.5 to about 9.5 and including at least one water-soluble, thermally-crosslinkable hydrophilic polymeric material at a temperature from about 60° C. to about 140° C. to graft a second non-silicone hydrogel material onto each of the anterior and posterior surfaces of the preformed contact lens obtained in step (2) to form a coated contact lens that has an anterior surface, an opposite posterior surface, an anterior outer hydrogel layer, and a posterior outer hydrogel layer, wherein said at least one water-soluble, thermally-crosslinkable hydrophilic polymeric material comprises second reactive functional groups and third reactive functional groups, wherein the second reactive functional groups are thermally-crosslinkable groups selected from the group consisting of azetidinium groups, epoxy groups, and combinations thereof, wherein each of the second reactive functional group is capable of reacting with one first or third reactive functional group to form a crosslinkage, wherein the third reactive functional groups are selected from the group consisting of carboxylic acid groups, primary amino groups, secondary amino groups, thiol groups, and combinations thereof, wherein the second non-silicone hydrogel material is a crosslinked product of said at least one thermally-crosslinkable hydrophilic polymeric material,
wherein the anterior outer hydrogel layer has imperfections distributed therein so that the posterior surface of the coated contact lens has a surface lubricity higher than the surface lubricity of the anterior surface, wherein the coated contact lens in fully-hydrated state has a water-break-up time of at least about 10 seconds as measured on the anterior and posterior surfaces of the coated contact lens.

13. The method of claim 12, wherein the step (2) is performed by applying a hydrogel-forming composition onto multiple zones on the convex surface of the preformed contact lens, and then curing thermally or actinically the hydrogel-forming composition to form the first non-silicone hydrogel material to cover the multiple zones.

14. The method of claim 13, wherein the hydrogel-forming composition comprises at least one crosslinkable polymer having hydroxyl groups and/or ethylenically unsaturated groups and optionally at least one hydrophobic vinylic monomer selected from the group consisting of methoxyethyl (meth)acrylate, ethoxyethyl (meth)acrylate, methyl (meth)acrylate, and combination thereof, wherein if said at least one crosslinkable polymer is free of any ethylenical unsaturated group, the hydrogel-forming composition comprises additionally at least one hydroxyl-containing vinylic monomer and at least one compound having two or more isocyanato groups, wherein all polymerizable components in the hydrogel-forming composition are free of any first reactive functional groups and any thermally-crosslinkable groups which are azetidinium groups and/or epoxy groups.

15. The method of claim 14, wherein the step of heating is performed by autoclaving the preformed contact lens or the contact lens precursor immersed in a packaging solution (i.e., a buffered aqueous solution) in a sealed lens package at a temperature of from about 115° C. to about 125° C. for approximately 20-90 minutes.

16. The method of claim 15, wherein said at least one water-soluble and thermally crosslinkable hydrophilic polymeric material comprises azetidinium groups, epoxy groups, or combinations thereof.

17. The method of claim 16, wherein said at least one water-soluble and thermally crosslinkable hydrophilic polymeric material is a three-dimensional network and thermally-crosslinkable groups within the network or being attached to the network.

18. A method for producing coated contact lenses, comprising the steps of:
(1) obtaining a female mold half and a male mold half, wherein the female mold half has a first molding surface defining the anterior surface of a contact lens to be molded, wherein the male mold half has a second molding surface defining the posterior surface of the contact lens to be molded, wherein the male mold half and the female mold half are configured to receive each other such that a lens-molding cavity is formed between the first and second molding surfaces when the female mold half is closed with the male mold half;
(2) applying a hydrogel-forming composition to multiple zones on the first molding surface, wherein the hydrogel-forming composition comprises at least one crosslinkable polymer having hydroxyl groups and/or ethylenically unsaturated groups and optionally at least one hydrophobic vinylic monomer selected from the group consisting of methoxyethyl (meth)acrylate, ethoxyethyl (meth)acrylate, methyl (meth)acrylate, and combination thereof, wherein if said at least one crosslinkable polymer is free of any ethylenical unsaturated group, the hydrogel-forming composition comprises additionally at least one hydroxyl-containing vinylic monomer and at least one compound having two or more isocyanato groups, wherein all polymerizable components in the hydrogel-forming composition are free of reactive functional groups selected from the group consisting of a carboxylic acid group, a primary amino group, a secondary amino group, an azetidinium group, an epoxy group, and combinations thereof;
(3) optionally, curing partially the hydrogel-forming composition on the first molding surface;
(4) introducing a polymerizable composition into the female mold half obtained in step (2) or (3), wherein the polymerizable composition comprises from about 1.0% to about 10% by weight of at least one reactive vinylic monomer having at least one first reactive functional group selected from the group consisting of a carboxylic acid group, a primary amino group, a secondary amino group, and combinations thereon, relative to the total amount of all polymerizable components;
(5) closing the female mold half obtained in step (4) with the male mold half to form a molding assemble including the polymerizable composition within the lens-forming cavity;
(6) curing thermally or actinically the polymerizable composition in the molding assembly to form a contact lens precursor having a convex surface and an opposite concave surface and comprising a lens bulk material having first reactive functional groups, wherein the convex surface of the contact lens precursor is partially covered with a first hydrogel material formed from the hydrogel-forming composition in the multiple zones on the convex surface so as to prevent the first reactive functional groups behind the multiple zones from reacting with thermally-crosslinkable groups which are azetidinium groups and/or epoxy groups at a temperature from about 60° C. to about 140° C., wherein the first non-silicone hydrogel material is free of any first reactive functional groups and thermally-crosslinkable groups;
(7) optionally hydrating the contact lens precursor obtained in step (6) in water or an aqueous solution; and
(8) heating the contact lens precursor obtained in step (6) or step (7) directly in an aqueous solution having a pH from about 6.5 to about 9.5 and including at least one water-soluble, thermally-crosslinkable hydrophilic polymeric material at a temperature from about 60° C. to about 140° C. to graft a second non-silicone hydrogel material onto each of the convex and concave surfaces of the contact lens precursor obtained in step (6) or the hydrated contact lens precursor obtained in step (7) to form a coated contact lens that has an anterior surface, an opposite posterior surface, an anterior outer hydrogel layer, and a posterior outer hydrogel layer, wherein said at least one water-soluble, thermally-crosslinkable hydrophilic polymeric material comprises second reactive functional groups and third reactive functional groups, wherein the second reactive functional groups are thermally-crosslinkable groups selected from the group consisting of azetidinium groups, epoxy groups, and combinations thereof, wherein each of the second reactive functional group is capable of reacting with one first or third reactive functional group to form a crosslinkage, wherein the third reactive functional groups are selected from the group consisting of carboxylic acid groups, primary amino groups, secondary amino groups, thiol groups, and combinations thereof,
wherein the anterior outer hydrogel layer has imperfections (ditches and/or gaps) distributed therein so that the posterior surface of the coated contact lens has a surface lubricity higher than the surface lubricity of the anterior surface, wherein the coated contact lens has a water-break-up time of at least about 10 seconds as measured on the anterior and posterior surfaces of the coated contact lens.

19. The method of claim 18, wherein the hydrogel-forming composition comprises at least one crosslinkable polymer having hydroxyl groups and/or ethylenically unsaturated groups and optionally at least one hydrophobic vinylic monomer selected from the group consisting of methoxyethyl (meth)acrylate, ethoxyethyl (meth)acrylate, methyl (meth)acrylate, and combination thereof, wherein if said at least one crosslinkable polymer is free of any ethylenical unsaturated group, the hydrogel-forming composition comprises additionally at least one hydroxyl-containing vinylic monomer and at least one compound having two or more isocyanato groups, wherein all polymerizable components in the hydrogel-forming composition are free of any first reactive functional groups and any thermally-crosslinkable groups which are azetidinium groups and/or epoxy groups.

20. The method of claim 19, wherein the step of heating is performed by autoclaving the preformed contact lens or the contact lens precursor immersed in a packaging solution (i.e., a buffered aqueous solution) in a sealed lens package at a temperature of from about 115° C. to about 125° C. for approximately 20-90 minutes.

21. The method of claim 20, wherein said at least one water-soluble and thermally crosslinkable hydrophilic polymeric material comprises azetidinium groups, epoxy groups, or combinations thereof.

22. The method of claim 21, wherein said at least one water-soluble and thermally crosslinkable hydrophilic polymeric material is a three-dimensional network and thermally-crosslinkable groups within the network or being attached to the network.
